(19) United States
(12) Patent Application Publication
(10) Pub. No.: US 2014/0235689 A1
(43) Pub. Date: Aug. 21, 2014

(54) FUNGICIDAL PYRAZOLES

(71) Applicant: E I DU PONT DE NEMOURS AND COMPANY, Wilmington, DE (US)

(72) Inventor: MOUMITA KAR, HYDERABAD (IN)

(73) Assignee: E I DU PONT DE NEMOURS AND COMPANY, Wilmington, DE (US)

(21) Appl. No.: 14/183,621

(22) Filed: Feb. 19, 2014

Related U.S. Application Data
(60) Provisional application No. 61/766,834, filed on Feb. 20, 2013.

(51) Int. Cl. A01N 43/56

(52) U.S. Cl. CPC A01N 43/56
USPC 514/406; 548/375.1; 548/376.1

(57) ABSTRACT

Disclosed are compounds of Formula 1, including all stereoisomers, N-oxides, and salts thereof,

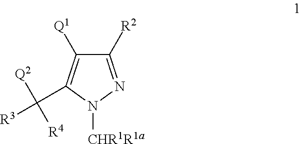

wherein
R¹, R^{1a}, R², R³, R⁴, Q¹ and Q² are as defined in the disclosure.

Also disclosed are compositions containing the compounds of Formula 1 and methods for controlling plant disease caused by a fungal pathogen comprising applying an effective amount of a compound or a composition of the invention.

### FIELD OF THE INVENTION

This invention relates to certain pyrazoles, their N-oxides, salts and compositions, and methods of their use as fungicides.

### BACKGROUND OF THE INVENTION

The control of plant diseases caused by fungal plant pathogens is extremely important in achieving high crop efficiency. Plant disease damage to ornamental, vegetable, field, cereal, and fruit crops can cause significant reduction in productivity and thereby result in increased costs to the consumer. Many products are commercially available for these purposes, but the need continues for new compounds which are more effective, less costly, less toxic, environmentally safer or have different sites of action.

PCT Patent Publications WO 2009/137538, WO 2009/137651, WO 2010/101973, WO 2012/023143 and WO 2012/031061 disclose pyrazole derivatives and their use as fungicides.

### SUMMARY OF THE INVENTION

This invention is directed to compounds of Formula 1 (including all stereoisomers), N-oxides, and salts thereof, agricultural compositions containing them and their use as fungicides:

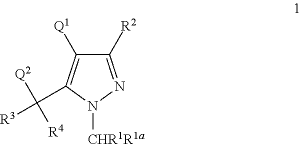

wherein
Q¹ is C₃-C₆ cycloalkyl or C₃-C₆ cycloalkenyl, wherein up to 3 carbon atoms are independently selected from C(═O), each optionally substituted with up to 2 substituents independently selected from halogen, cyano, nitro, hydroxy, C₁-C₃ alkyl, C₁-C₃ haloalkyl, C₁-C₃ alkoxy and C₁-C₃ haloalkoxy; or a phenyl ring or a naphthalenyl ring system, each ring or ring system optionally substituted with up to 5 substituents independently selected from R⁵; or a 4- to 7-membered heterocyclic ring or an 8- to 10-membered heteroaromatic bicyclic ring system, each ring or ring system containing ring members selected from carbon atoms and 1 to 4 heteroatoms independently selected from up to 2 O, up to 2 S and up to 4 N atoms, wherein up to 3 carbon ring members are independently selected from C(═O) and C(═S), and the sulfur atom ring members are independently selected from S(═O)ᵤ(═NR¹⁶)ᵥ, each ring or ring system optionally substituted with up to 5 substituents independently selected from R⁵ on carbon atom ring members and selected from cyano, C₁-C₃ alkyl, C₂-C₃ alkenyl, C₂-C₃ alkynyl, C₃ cycloalkyl, C₂-C₃ alkoxyalkyl, C₁-C₃ alkoxy, C₂-C₃ alkylcarbonyl, C₂-C₃ alkoxycarbonyl, C₂-C₃ alkylaminoalkyl and C₃ dialkylaminoalkyl on nitrogen atom ring members;
Q² is C₃-C₆ cycloalkyl or C₃-C₆ cycloalkenyl, wherein up to 3 carbon atoms are independently selected from C(═O), each optionally substituted with up to 2 substituents independently selected from halogen, cyano, nitro, hydroxy, C₁-C₃ alkyl, C₁-C₃ haloalkyl, C₁-C₃ alkoxy and C₁-C₃ haloalkoxy; or a phenyl ring or a naphthalenyl ring system, each ring or ring system optionally substituted with up to 5 substituents independently selected from R⁵; or a 4- to 7-membered heterocyclic ring or an 8- to 10-membered heteroaromatic bicyclic ring system, each ring or ring system containing ring members selected from carbon atoms and 1 to 4 heteroatoms independently selected from up to 2 O, up to 2 S and up to 4 N atoms, wherein up to 3 carbon ring members are independently selected from C(═O) and C(═S), and the sulfur atom ring members are independently selected from S(═O)ᵤ(═NR¹⁶)ᵥ, each ring or ring system optionally substituted with up to 5 substituents independently selected from R⁵ on carbon atom ring members and selected from cyano, C₁-C₃ alkyl, C₂-C₃ alkenyl, C₂-C₃ alkynyl, C₃ cycloalkyl, C₂-C₃ alkoxyalkyl, C₁-C₃ alkoxy, C₂-C₃ alkylcarbonyl, C₂-C₃ alkoxycarbonyl, C₂-C₃ alkylaminoalkyl and C₃ dialkylaminoalkyl on nitrogen atom ring members;
R¹ is H, cyano, halogen, C₁-C₃ alkyl, C₁-C₃ haloalkyl, C₂-C₃ alkenyl, C₂-C₃ alkynyl or cycloalkyl;
R^{1a} is H; or
R^{1a} and R¹ are taken together with the carbon atom to which they are attached to form a cyclopropyl ring optionally substituted with up to 2 substituents independently selected from halogen and methyl;
R² is H, cyano, halogen, C₁-C₃ alkyl, C₂-C₃ alkenyl, C₂-C₃ alkynyl, C₁-C₃ haloalkyl, C₂-C₃ haloalkenyl, C₁-C₃ cyanoalkyl, C₁-C₃ hydroxyalkyl, C₁-C₃ alkoxy or C₁-C₃ alkylthio; or cyclopropyl optionally substituted with up to 2 substituents independently selected from halogen and methyl;
R³ is H or C₁-C₆ alkyl;
R⁴ is —NR^{6a}R^{6b} or —S(═O)ₙR⁷;
each R⁵ is independently amino, cyano, halogen, hydroxy, nitro, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₆ cycloalkyl, C₃-C₆ halocycloalkyl, C₄-C₆ cycloalkylalkyl, C₄-C₆ alkylcycloalkyl, C₅-C₈ cycloalkylalkenyl, C₅-C₈ cycloalkylalkynyl, C₁-C₆ nitroalkyl, C₁-C₆ nitroalkenyl, C₁-C₆ alkylthio, C₁-C₆ haloalkylthio, C₁-C₆ alkylsulfinyl, C₁-C₆ haloalkylsulfinyl, C₁-C₆ alkylsulfonyl, C₁-C₆ haloalkylsulfonyl, C₁-C₆ alkoxy, C₁-C₆ haloalkoxy, C₂-C₆ alkenyloxy, C₂-C₆ haloalkenyloxy, C₃-C₆ alkynyloxy, C₃-C₆ haloalkynyloxy, C₂-C₆ alkylcarbonyloxy, C₃-C₆ cycloalkoxy, C₄-C₈ cycloalkylalkoxy, C₁-C₆ alkylsulfonyloxy, C₁-C₆ haloalkylsulfonyloxy, C₄-C₉ trialkylsilylalkoxy, C₂-C₆ alkylcarbonyl, C₁-C₆ alkylamino, C₂-C₆ dialkylamino, C₂-C₆ alkylcarbonylamino, C₃-C₉ trialkylsilyl, C₄-C₉ trialkylsilylalkyl, C(═S)NR^{8a}R^{8b}, —NH₂CH(═O), CR^{9a}═NOR^{9b}, CR^{9c}═NNR^{8a}R^{8b}, NR^{8a}N═CR^{10a}R^{10b}, —ON═CR^{10a}R^{10b}, —CH(═O), SF₅, SC≡N or —U—V-T;
R^{6a} and R^{6b} are each independently H, —CH(═O), C₁-C₄ alkyl, C₂-C₄ alkenyl, C₂-C₄ alkynyl, C₁-C₄ haloalkyl, C₂-C₄ haloalkenyl, C₂-C₄ haloalkynyl, C₂-C₄ alkoxyalkyl, C₂-C₄ alkylthioalkyl, C₂-C₄ alkylsulfinylalkyl, C₂-C₄ alkylsulfonylalkyl, C₂-C₄ alkylcarbonyl, C₂-C₄ haloalkylcarbonyl, C₂-C₅ alkoxycarbonyl, C₃-C₅ alkoxycarbonylalkyl, C₂-C₅ alkylaminocarbonyl, C₃-C₅ dialkylaminocarbonyl, C₁-C₄ alkylsulfonyl or C₁-C₄ haloalkylsulfonyl;
R⁷ is H, C₁-C₃ alkyl, C₁-C₃ haloalkyl, C₂-C₃ alkenyl or C₂-C₃ alkynyl;
each R^{8a} and R^{8b} is independently H or methyl;
each R^{9a} is independently H, C₁-C₃ alkyl or C₁-C₃ haloalkyl;
each R^{9b} and R^{9c} is independently H, C₁-C₃ alkyl, C₂-C₄ alkenyl, C₂-C₄ alkynyl, C₁-C₃ haloalkyl, C₂-C₄ haloalkenyl, C₃-C₄ cycloalkyl or C₃-C₄ halocycloalkyl;
each R^{10a} and R^{10b} is independently H, C₁-C₃ alkyl or C₁-C₃ haloalkyl;
each U is independently O, S(═O)ₙ, NR¹¹ or a direct bond;
each V is independently C₁-C₆ alkylene, C₂-C₆ alkenylene, C₃-C₆ alkynylene, C₃-C₆ cycloalkylene or C₃-C₆ cycloalkenylene, wherein up to 3 carbon atoms are C(═O), each optionally substituted with up to 5 substituents independently selected from halogen, cyano, nitro, hydroxy, C₁-C₆ alkyl, C₁-C₆ haloalkyl, C₁-C₆ alkoxy and C₁-C₆ haloalkoxy;
each T is independently cyano, NR^{12a}R^{12b}, OR¹³ or S(═O)ₙR¹⁴;
each R¹¹ is independently H, C₁-C₆ alkyl, C₁-C₆ haloalkyl, C₂-C₆ alkylcarbonyl, C₂-C₆ alkoxycarbonyl, C₂-C₆ (alkylthio)carbonyl, C₂-C₆ alkoxy(thiocarbonyl), C₄-C₈ cycloalkylcarbonyl, C₄-C₈ cycloalkoxycarbonyl, C₄-C₈ (cycloalkylthio)carbonyl or C₄-C₈ cycloalkoxy(thiocarbonyl);
each R^{12a} and R^{12b} is independently H, C₁-C₆ alkyl, C₁-C₆ haloalkyl, C₂-C₆ alkenyl, C₃-C₆ alkynyl, C₃-C₆ cycloalkyl, C₃-C₆ halocycloalkyl, C₂-C₆ alkylcarbonyl, C₂-C₆ alkoxycarbonyl, C₂-C₆ (alkylthio)carbonyl, C₂-C₆ alkoxy(thiocarbonyl), C₄-C₈ cycloalkylcarbonyl, C₄-C₈ cycloalkoxycarbonyl, C₄-C₈ (cycloalkylthio)carbonyl or C₄-C₈ cycloalkoxy(thiocarbonyl); or
a pair of R^{12a} and R^{12b} attached to the same nitrogen atom are taken together with the nitrogen atom to form a 3- to 6-membered heterocyclic ring, the ring optionally substituted with up to 5 substituents independently selected from R¹⁵;
each R¹³ and R¹⁴ is independently H, C₁-C₆ alkyl, C₁-C₆ haloalkyl, C₂-C₆ alkenyl, C₃-C₆ alkynyl, C₃-C₆ cycloalkyl, C₃-C₆ halocycloalkyl, C₂-C₆ alkylcarbonyl, C₂-C₆ alkoxycarbonyl, C₂-C₆ (alkylthio)carbonyl, C₄-C₈ cycloalkylcarbonyl, C₄-C₈ cycloalkoxycarbonyl, C₄-C₈ (cycloalkylthio)carbonyl, C₂-C₆ alkoxy(thiocarbonyl) or C₄-C₈ cycloalkoxy(thiocarbonyl);
each R¹⁵ is independently halogen, C₁-C₆ alkyl, C₁-C₆ haloalkyl or C₁-C₆ alkoxy;
each R¹⁶ is independently H, cyano, C₁-C₃ alkyl or C₁-C₃ haloalkyl;
each n is independently 0, 1 or 2; and
each u and v are independently 0, 1 or 2 in each instance of S(═O)ᵤ(═NR¹⁶)ᵥ;
   provided that:
   (a) the sum of u and v is 0, 1 or 2;
   (b) when Q¹ and Q² are each an optionally substituted phenyl ring, then at least one of Q¹ or Q² is substituted with at least one R⁵ substituent; and
   (c) at least one of Q¹ or Q² is an aromatic ring.

More particularly, this invention pertains to a compound of Formula 1 (including all stereoisomers), an N-oxide or a salt thereof.

This invention also relates to a fungicidal composition comprising (a) a compound of the invention (i.e. in a fungicidally effective amount); and (b) at least one additional component selected from the group consisting of surfactants, solid diluents and liquid diluents.

This invention also relates to a fungicidal composition comprising (a) a compound of the invention; and (b) at least one other fungicide (e.g., at least one other fungicide having a different site of action).

This invention further relates to a method for controlling plant diseases caused by fungal plant pathogens comprising applying to the plant or portion thereof, or to the plant seed, a fungicidally effective amount of a compound of the invention (e.g., as a composition described herein).

### DETAILS OF THE INVENTION

As used herein, the terms “comprises,” “comprising,” “includes,” “including,” “has,” “having,” “contains,” “containing,” “characterized by” or any other variation thereof, are intended to cover a non-exclusive inclusion, subject to any limitation explicitly indicated. For example, a composition, mixture, process, method, article, or apparatus that comprises a list of elements is not necessarily limited to only those elements but may include other elements not expressly listed or inherent to such composition, mixture, process, method, article, or apparatus.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition, method or apparatus that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where applicants have defined an invention or a portion thereof with an open-ended term such as “comprising,” it should be readily understood that (unless otherwise stated) the description should be interpreted to also describe such an invention using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As referred to in the present disclosure and claims, “plant” includes members of Kingdom Plantae, particularly seed plants (Spermatopsida), at all life stages, including young plants (e.g., germinating seeds developing into seedlings) and mature, reproductive stages (e.g., plants producing flowers and seeds). Portions of plants include geotropic members typically growing beneath the surface of the growing medium (e.g., soil), such as roots, tubers, bulbs and corms, and also members growing above the growing medium, such as foliage (including stems and leaves), flowers, fruits and seeds.

As referred to herein, the term “seedling”, used either alone or in a combination of words means a young plant developing from the embryo of a seed.

In the above recitations, the term “alkyl”, used either alone or in compound words such as “alkylthio” or “haloalkyl” includes straight-chain or branched alkyl such as methyl, ethyl, n-propyl, i-propyl, or the different butyl, pentyl or hexyl isomers. “Alkenyl” includes straight-chain or branched alkenes such as ethenyl, 1-propenyl, 2-propenyl, and the different butenyl, pentenyl and hexenyl isomers. “Alkenyl” also includes polyenes such as 1,2-propadienyl and 2,4-hexadienyl. “Alkynyl” includes straight-chain or branched alkynes such as ethynyl, 1-propynyl, 2-propynyl and the different butynyl, pentynyl and hexynyl isomers. “Alkynyl” also includes moieties comprised of multiple triple bonds such as 2,5-hexadiynyl. “Alkylene” denotes a straight-chain or branched alkanediyl. Examples of “alkylene” include CH₂, CH₂CH₂, CH(CH₃), CH₂CH₂CH₂, CH₂CH(CH₃), and the different butylene isomers. “Alkenylene” denotes a straight-chain or branched alkenediyl containing one olefinic bond. Examples of “alkenylene” include CH═CH, CH₂CH═CH, CH═C(CH₃) and the different butenylene isomers. “Alkynylene” denotes a straight-chain or branched alkynediyl containing one triple bond. Examples of “alkynylene” include CC, CH₂C≡C, C≡CCH₂, and the different butynylene isomers.

“Alkylamino” includes an NH radical substituted with straight-chain or branched alkyl. Examples of “alkylamino” include CH₃CH₂NH, CH₃CH₂CH₂NH and (CH₃)₂CHNH. Examples of “dialkylamino” include (CH₃)₂N, (CH₃CH₂)₂N and CH₃CH₂(CH₃)N. “Alkylaminoalkyl” denotes alkylamino substitution on alkyl. Examples of “alkylaminoalkyl” include CH₃NHCH₂, CH₃NHCH₂CH₂ and CH₃CH₂NHCH₂. Examples of “dialkylaminoalkyl” include (CH₃)₂NCH₂, CH₃CH₂(CH₃)NCH₂ and (CH₃)₂NCH₂CH₂.

“Alkoxy” includes, for example, methoxy, ethoxy, n-propyloxy, isopropyloxy and the different butoxy, pentoxy and hexyloxy isomers. “Alkoxyalkyl” denotes alkoxy substitution on alkyl. Examples of “alkoxyalkyl” include CH₃OCH₂, CH₃OCH₂CH₂, CH₃CH₂OCH₂, CH₃CH₂CH₂CH₂OCH₂ and CH₃CH₂OCH₂CH₂. “Alkenyloxy” includes straight-chain or branched alkenyloxy moieties. Examples of “alkenyloxy” include H₂C═CHCH₂O, (CH₃)₂C═CHCH₂O, (CH₃)CH═CHCH₂O, (CH₃)CH═C(CH₃)CH₂O and CH₂═CHCH₂CH₂O. “Alkynyloxy” includes straight-chain or branched alkynyloxy moieties. Examples of “alkynyloxy” include HC≡CCH₂O, CH₃C≡CCH₂O and CH₃C≡CCH₂CH₂O.

“Alkylthio” includes branched or straight-chain alkylthio moieties such as methylthio, ethylthio, and the different propylthio, butylthio, pentylthio and hexylthio isomers. “Alkylsulfinyl” includes both enantiomers of an alkylsulfinyl group. Examples of “alkylsulfinyl” include CH₃S(═O), CH₃CH₂S(═O), CH₃CH₂CH₂S(═O), (CH₃)₂CHS(═O) and the different butylsulfinyl, pentylsulfinyl and hexylsulfinyl isomers. Examples of “alkylsulfonyl” include CH₃S(═O)₂, CH₃CH₂S(═O)₂, CH₃CH₂CH₂S(═O)₂, (CH₃)₂CHS(═O)₂, and the different butylsulfonyl, pentylsulfonyl and hexylsulfonyl isomers. “Alkylthioalkyl” denotes alkylthio substitution on alkyl. Examples of “alkylthioalkyl” include CH₃SCH₂, CH₃SCH₂CH₂, CH₃CH₂SCH₂, CH₃CH₂CH₂CH₂SCH₂ and CH₃CH₂SCH₂CH₂. The term “alkylsulfonyloxy” denotes alkylsulfonyl attached to and linked through an oxygen atom. Examples of “alkylsulfonyloxy” include CH₃S(═O)₂O, CH₃CH₂S(═O)₂O, CH₃CH₂CH₂S(═O)₂O and (CH₃)₂CHS(═O)₂O.

“Alkylcarbonyl” denotes a straight-chain or branched alkyl group bonded to a C(═O) moiety. Examples of “alkylcarbonyl” include CH₃C(═O), CH₃CH₂CH₂C(═O) and (CH₃)₂CHC(═O). Examples of “alkoxycarbonyl” include CH₃C(═O), CH₃CH₂OC(═O), CH₃CH₂CH₂C(═O), (CH₃)₂CHOC(═O) and the different pentoxy- or hexoxycarbonyl isomers. The term “alkylcarbonyloxy” denotes straight-chain or branched alkyl bonded to a C(═O)O moiety. Examples of “alkylcarbonyloxy” include CH₃CH₂C(═O)O and (CH₃)₂CHC(═O)O. “(Alkylthio)carbonyl” denotes a straight-chain or branched alkylthio group bonded to a C(═O) moiety. Examples of “(alkylthio)carbonyl” include CH₃SC(═O), CH₃CH₂CH₂SC(═O) and (CH₃)₂CHSC(═O). “Alkoxy(thiocarbonyl)” denotes a straight-chain or branched alkoxy group bonded to a C(═S) moiety. Examples of “alkoxy(thiocarbonyl)” include CH₃C(═S), CH₃CH₂CH₂C(═S) and (CH₃)₂CHOC(═S). The term “alkylcarbonylamino” denotes alkyl bonded to a C(═O)NH moiety. Examples of “alkylcarbonylamino” include CH₃C(═O)NH and CH₃CH₂C(═O)NH.

“Cycloalkyl” includes, for example, cyclopropyl, cyclobutyl, cyclopentyl and cyclohexyl. The term “alkylcycloalkyl” denotes alkyl substitution on a cycloalkyl moiety and includes, for example, ethylcyclopropyl, i-propylcyclobutyl, 3-methylcyclopentyl and 4-methylcyclohexyl. The term “cycloalkylalkyl” denotes cycloalkyl substitution on an alkyl moiety. Examples of “cycloalkylalkyl” include cyclopropylmethyl, cyclopentylethyl, and other cycloalkyl moieties bonded to straight-chain or branched alkyl groups. The term “cycloalkoxy” denotes cycloalkyl linked through an oxygen atom such as cyclopentyloxy and cyclohexyloxy. “Cycloalkylalkoxy” denotes cycloalkylalkyl linked through an oxygen atom attached to the alkyl chain. Examples of “cycloalkylalkoxy” include cyclopropylmethoxy, cyclopentylethoxy, and other cycloalkyl moieties bonded to straight-chain or branched alkoxy groups. “Cycloalkenyl” includes groups such as cyclopentenyl and cyclohexenyl as well as groups with more than one double bond such as 1,3- and 1,4-cyclohexadienyl. “Cycloalkylcarbonyl” denotes cycloalkyl bonded to a C(═O) group including, for example, cyclopropylcarbonyl and cyclopentylcarbonyl. The term “cycloalkoxycarbonyl” means cycloalkoxy bonded to a C(═O) group, for example, cyclopropyloxycarbonyl and cyclopentyloxycarbonyl. The term “cycloalkylene” denotes a cycloalkanediyl ring. Examples of “cycloalkylene” include cyclopropylene, cyclobutylene, cyclopentylene and cyclohexylene. The term “cycloalkenylene” denotes a cycloalkenediyl ring containing one olefinic bond. Examples of “cycloalkenylene” include cyclopropenylene and cyclopentenylene.

“Cyanoalkyl” denotes an alkyl group substituted with one cyano group. Examples of “cyanoalkyl” include NCCH₂, NCCH₂CH₂ and CH₃CH(CN)CH₂. “Hydroxyalkyl” denotes an alkyl group substituted with one hydroxy group. Examples of “hydroxyalkyl” include HOCH₂, HOCH₂CH₂ and CH₃CH₂(OH)CH. “Nitroalkyl” denotes an alkyl group substituted with one nitro group. Examples of “nitroalkyl” include NO₂CH₂ and NO₂CH₂CH₂.

“Trialkylsilyl” includes 3 branched and/or straight-chain alkyl radicals attached to and linked through a silicon atom, such as trimethylsilyl, triethylsilyl and tert-butyldimethylsilyl.

The term “halogen”, either alone or in compound words such as “haloalkyl”, or when used in descriptions such as “alkyl substituted with halogen” includes fluorine, chlorine, bromine or iodine. Further, when used in compound words such as “haloalkyl”, or when used in descriptions such as “alkyl substituted with halogen” said alkyl may be partially or fully substituted with halogen atoms which may be the same or different. Examples of “haloalkyl” or “alkyl substituted with halogen” include F₃C, ClCH₂, CF₃CH₂ and CF₃CCl₂. The terms “halocycloalkyl”, “haloalkoxy”, “haloalkylthio”, “haloalkenyl”, “haloalkynyl”, and the like, are defined analogously to the term “haloalkyl”. Examples of “haloalkoxy” include CF₃O, CCl₃CH₂O, HCF₂CH₂CH₂O and CF₃CH₂O. Examples of “haloalkylthio” include CCl₃S, CF₃S, CCl₃CH₂S and ClCH₂CH₂CH₂S. Examples of “haloalkylsulfinyl” include CF₃S(O), CCl₃S(O), CF₃CH₂S(O) and CF₃CF₂S(O). Examples of “haloalkylsulfonyl” include CF₃S(O)₂, CCl₃S(O)₂, CF₃CH₂S(O)₂ and CF₃CF₂S(O)₂. Examples of “haloalkenyl” include (Cl)₂C═CHCH₂ and CF₃CH₂CH═CHCH₂. Examples of “haloalkynyl” include HC≡CCHCl—, CF₃C≡C, CCl₃C≡C and FCH₂C≡CCH₂ as well as branched alkyl derivatives.

As used herein, the following definitions shall apply unless otherwise indicated. The term “optionally substituted” is used interchangeably with the phrase “substituted or unsubstituted” or with the term “(un)substituted.” Unless otherwise indicated, an optionally substituted group may have a substituent at each substitutable position of the group, and each substitution is independent of the other.

The term “unsubstituted” in connection with a group such as a ring or ring system means the group does not have any substituents other than its one or more attachments to the remainder of Formula 1. The term “optionally substituted” means that the number of substituents can be zero. Unless otherwise indicated, optionally substituted groups may be substituted with as many optional substituents as can be accommodated by replacing a hydrogen atom with a non-hydrogen substituent on any available carbon or nitrogen atom. The number of optional substituents may be restricted by an expressed limitation. For example, the phrase “optionally substituted with up to 5 substituents selected from R⁵ on carbon ring members” means that 0, 1, 2, 3, 4 or 5 substituents can be present (if the number of potential connection points allows). When a range specified for the number of substituents (e.g., r being an integer from 0 to 5 for 5- and 6-membered heterocyclic rings in Exhibit 4) exceeds the number of positions available for substituents on a ring (e.g., 2 positions available for (R^{a})ᵣ on U-27 in Exhibit 4), the actual higher end of the range is recognized to be the number of available positions.

The total number of carbon atoms in a substituent group is indicated by the “Cᵢ-Cⱼ” prefix where i and j are numbers from 1 to 9. For example, C₁-C₄ alkylsulfonyl designates methylsulfonyl through butylsulfonyl; C₂ alkoxyalkyl designates CH₃OCH₂; C₃ alkoxyalkyl designates, for example, CH₃CH(OCH₃), CH₃OCH₂CH₂ or CH₃CH₂OCH₂; and C₄ alkoxyalkyl designates the various isomers of an alkyl group substituted with an alkoxy group containing a total of four carbon atoms, examples including CH₃CH₂CH₂OCH₂ and CH₃CH₂OCH₂CH₂.

When a compound is substituted with a substituent bearing a subscript that indicates the number of said substituents can exceed 1, said substituents (when they exceed 1) are independently selected from the group of defined substituents, e.g., (R⁵)ₚ in Table 1 where p is 0, 1, 2, 3, 4 or 5. When a group contains a substituent which can be hydrogen, for example R¹, R^{1a}, R² or R³, then when this substituent is taken as hydrogen, it is recognized that this is equivalent to said group being unsubstituted. When a variable group is shown to be optionally attached to a position, for example (R^{a})ᵣ in H-23 of Exhibit 1, wherein r may be 0, then hydrogen may be at the position even if not recited in the variable group definition. When one or more positions on a group are said to be “not substituted” or “unsubstituted”, then hydrogen atoms are attached to take up any free valency.

Generally when a molecular fragment (i.e. radical) is denoted by a series of atom symbols (e.g., C, H, N, O, S) the implicit point or points of attachment will be easily recognized by those skilled in the art. In some instances herein, particularly when alternative points of attachment are possible, the point or points of attachment may be explicitly indicated by a hyphen (“-”).

Unless otherwise indicated, a “ring” or “ring system” as a component of Formula 1 is carbocyclic or heterocyclic. The term “ring system” denotes two or more fused rings. The terms “bicyclic ring system” and “fused bicyclic ring system” denote a ring system consisting of two fused rings, in which either ring can be saturated, partially unsaturated, or fully unsaturated unless otherwise indicated. The term “ring member” refers to an atom or other moiety (e.g., C(═O), C(═S), S(O) or S(O)₂) forming the backbone of a ring or ring system.

The terms “carbocyclic ring”, “carbocycle” or “carbocyclic ring system” denote a ring or ring system wherein the atoms forming the ring backbone are selected only from carbon.

Unless otherwise indicated, a carbocyclic ring can be a saturated, partially unsaturated, or fully unsaturated ring. When a fully unsaturated carbocyclic ring satisfies Hückel's rule, then said ring is also called an “aromatic ring”. “Saturated carbocyclic” refers to a ring having a backbone consisting of carbon atoms linked to one another by single bonds; unless otherwise specified, the remaining carbon valences are occupied by hydrogen atoms.

The terms “heterocyclic ring”, “heterocycle” or “heterocyclic ring system” denote a ring or ring system in which at least one atom forming the ring backbone is not carbon, e.g., nitrogen, oxygen or sulfur. Typically a heterocyclic ring contains no more than 4 nitrogens, no more than 2 oxygens and no more than 2 sulfurs. Unless otherwise indicated, a heterocyclic ring can be a saturated, partially unsaturated, or fully unsaturated ring. When a fully unsaturated heterocyclic ring satisfies Hückel's rule, then said ring is also called a “heteroaromatic ring” or “aromatic heterocyclic ring”. Unless otherwise indicated, heterocyclic rings and ring systems can be attached through any available carbon or nitrogen by replacement of a hydrogen on said carbon or nitrogen.

“Aromatic” indicates that each of the ring atoms is essentially in the same plane and has a p-orbital perpendicular to the ring plane, and that (4n+2) π electrons, where n is a positive integer, are associated with the ring to comply with Hückel's rule. The term “aromatic ring system” denotes a carbocyclic or heterocyclic ring system in which at least one ring of the ring system is aromatic. The term “aromatic carbocyclic ring system” denotes a carbocyclic ring system in which at least one ring of the ring system is aromatic. The term “aromatic heterocyclic ring system” or “heteroaromatic bicyclic ring system” denotes a heterocyclic ring system in which at least one ring of the ring system is aromatic. The term “nonaromatic ring system” denotes a carbocyclic or heterocyclic ring system that may be fully saturated, as well as partially or fully unsaturated, provided that none of the rings in the ring system are aromatic.

In the context of the present invention when an instance of Q¹ and Q² comprises a phenyl or 6-membered heterocyclic ring (e.g., pyridinyl), the ortho, meta and para positions of each ring are relative to the connection of the ring to the remainder of Formula 1.

As noted above, Wand Q² can be (among others) phenyl optionally substituted with one or more substituents selected from a group of substituents as defined in the Summary of the Invention. An example of phenyl optionally substituted with one to five substituents is the ring illustrated as U-57 in Exhibit 4, wherein R^{a} is as defined in the Summary of the Invention for R⁵ and r is an integer from 0 to 5.

As noted above, Wand Q² can be (among others) a 4- to 7-membered heterocyclic ring or an 8- to 10-membered heteroaromatic bicyclic ring system, each ring or ring system containing ring members selected from carbon atoms and 1 to 4 heteroatoms independently selected from up to 2 O, up to 2 S and up to 4 N atoms, wherein up to 3 carbon atom ring members are independently selected from C(═O) and C(═S), the sulfur atom ring members are independently selected from S(═O)ᵤ(═NR¹⁶)ᵥ, each ring or ring system optionally substituted with up to 5 substituents independently selected from R⁵ on carbon ring members and selected from cyano, C₁-C₃ alkyl, C₂-C₃ alkenyl, C₂-C₃ alkynyl, C₃ cycloalkyl, C₁-C₃ alkoxy, C₂-C₃ alkoxyalkyl, C₂-C₃ alkylcarbonyl, C₂-C₃ alkoxycarbonyl, C₂-C₃ alkylaminoalkyl and C₃ dialkylaminoalkyl on nitrogen atom ring members. As the substituents on the ring or ring system of Q¹ or Q² are optional, 0 to 5 substituents may be present, limited only by the number of available points of attachment. In these definitions of heterocyclic ring and heteroaromatic ring system, the ring members selected from up to 2 O, up to 2 S and up to 4 N atoms are optional, provided at least one ring member is not carbon (e.g., N, O or S). The definition of S(═O)ᵤ(═NR¹⁶)ᵥ allows the up to 2 sulfur ring members, to be oxidized sulfur moieties (e.g., S(═O) or S(═O)₂) or unoxidized sulfur atoms (i.e. when u and v are both zero). The nitrogen atom ring members may be oxidized as N-oxides, because compounds relating to Formula 1 also include N-oxide derivatives. The up to 3 carbon atom ring members selected from C(═O) and C(═S) are in addition to the up to 4 heteroatoms selected from up to 2 O, up to 2 S and up to 4 N atoms.

The ring or ring system of Q¹ or Q² may be attached to the remainder of Formula 1 through any available carbon or nitrogen ring atom, unless otherwise described.

Examples of a 5- to 6-membered fully unsaturated heterocyclic ring include the rings H-1 through H-39 illustrated in Exhibit 1, and examples of an 8- to 10-membered heteroaromatic bicyclic ring system include the ring systems B-1 through B-39 illustrated in Exhibit 2. In Exhibits 1 and 2 the variable R^{a} is any substituent as defined in the Summary of the Invention for Q¹ or Q² (e.g., a Q¹ ring or ring system is optionally substituted with R⁵ on carbon ring members and cyano, C₁-C₃ alkyl, C₂-C₃ alkenyl, C₂-C₃ alkynyl, C₃ cycloalkyl, C₁-C₃ alkoxy, C₂-C₃ alkoxyalkyl, C₂-C₃ alkylcarbonyl, C₂-C₃ alkoxycarbonyl, C₂-C₃ alkylaminoalkyl and C₃ dialkylaminoalkyl on nitrogen atom ring members) and r is an integer from 0 to 5 for Q¹ and Q², limited by the number of available positions on each depicted ring or ring system.

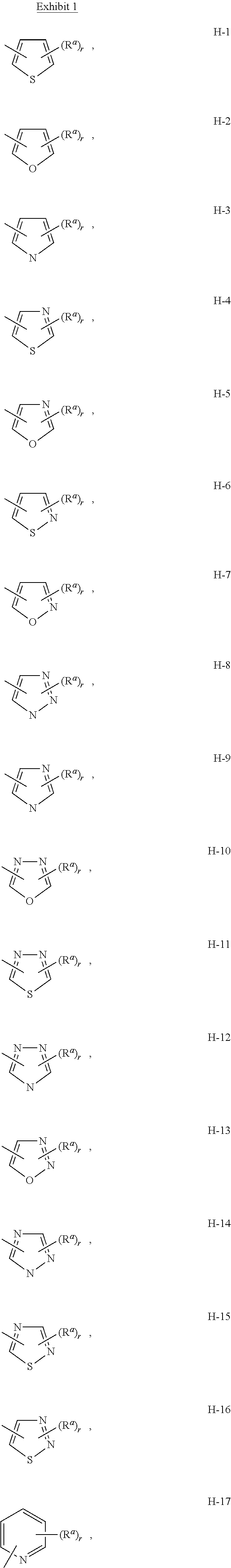

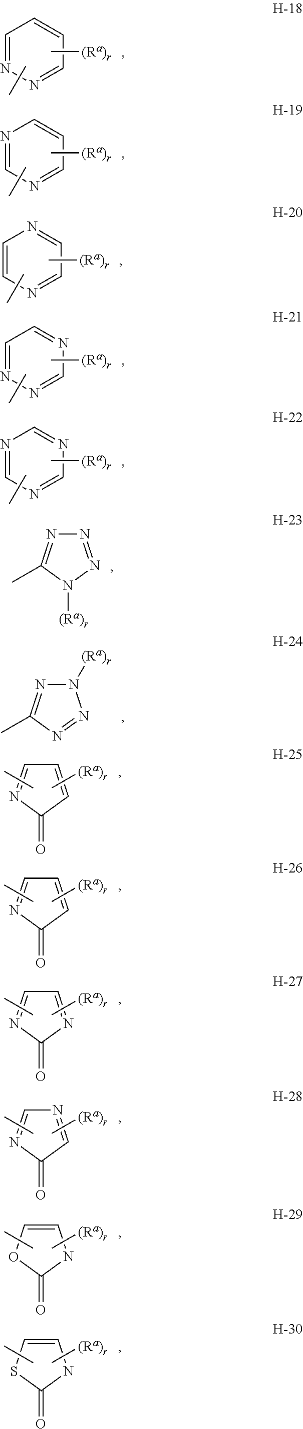

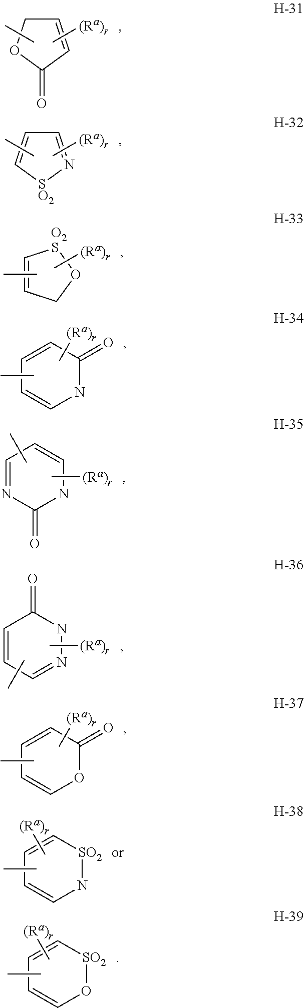

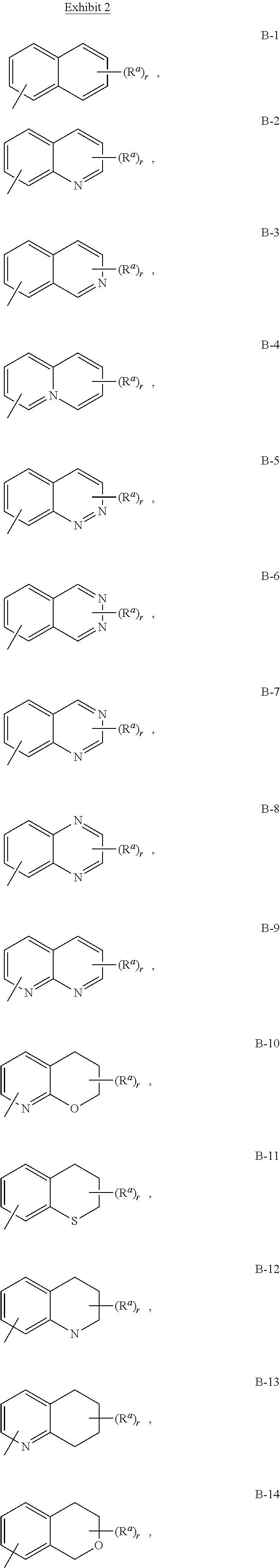

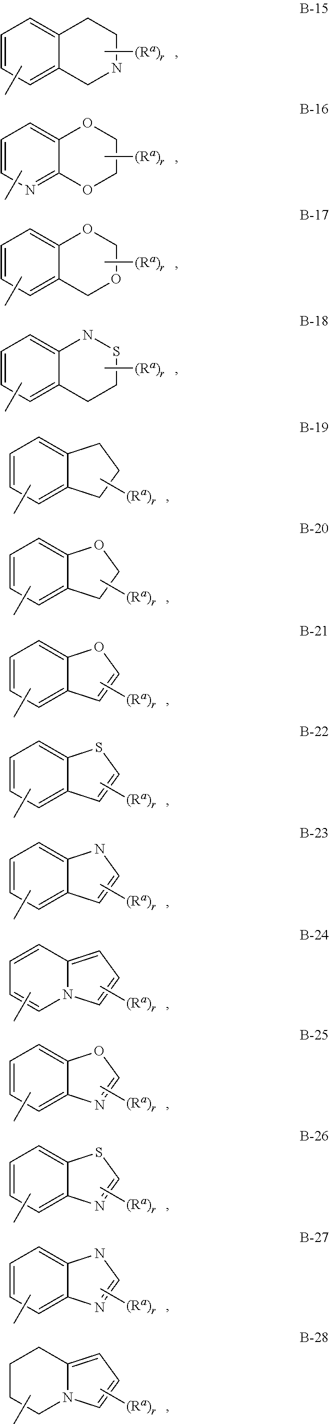

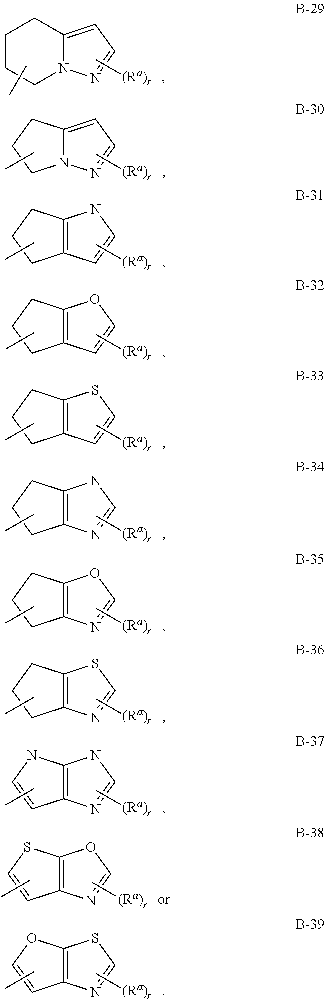

Examples of a saturated or partially unsaturated 5- to 7-membered heterocyclic ring include the rings P-1 through P-40 illustrated in Exhibit 3. In Exhibit 3 the variable R^{a} is any substituent as defined in the Summary of the Invention for Q¹ or Q² (e.g., a Q¹ ring or ring system is optionally substituted with R⁵ on carbon ring members and cyano, C₁-C₃ alkyl, C₂-C₃ alkenyl, C₂-C₃ alkynyl, C₃ cycloalkyl, C₁-C₃ alkoxy, C₂-C₃ alkoxyalkyl, C₂-C₃ alkylcarbonyl, C₂-C₃ alkoxycarbonyl, C₂-C₃ alkylaminoalkyl and C₃ dialkylaminoalkyl on nitrogen atom ring members) and r is an integer from 0 to 5, limited by the number of available positions on each depicted ring or ring system.

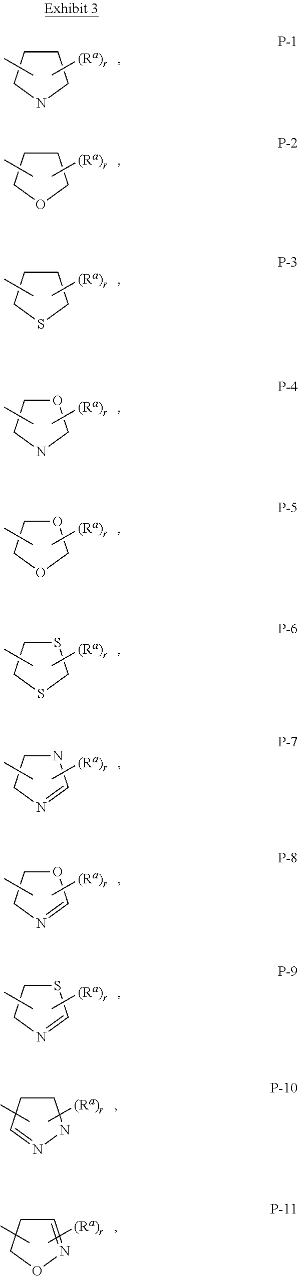

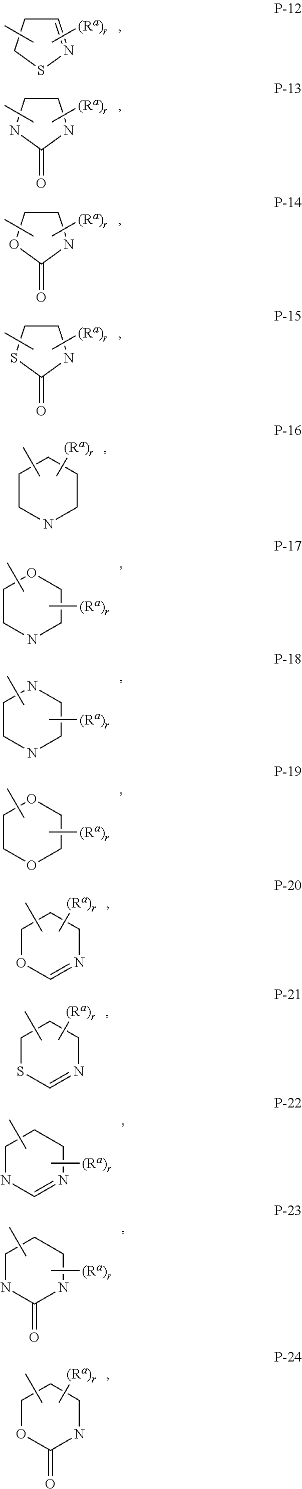

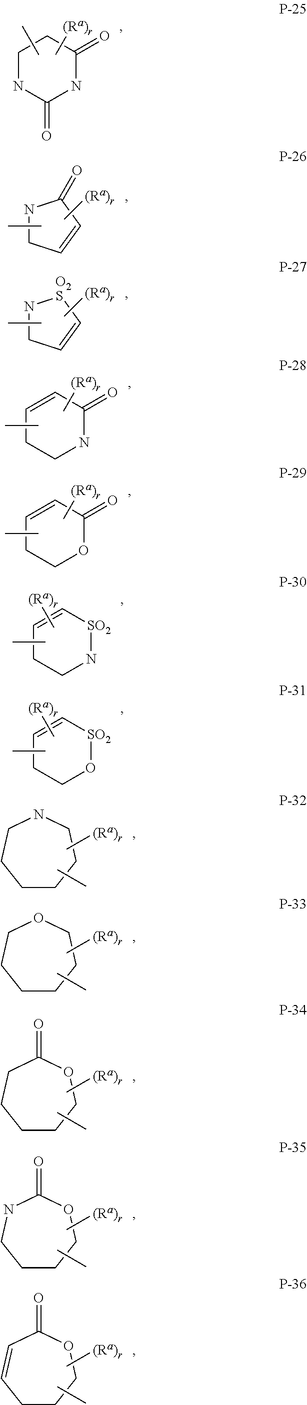

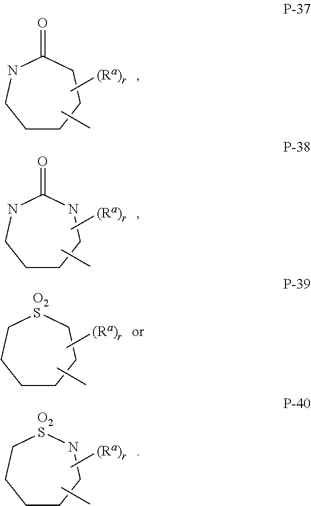

Examples of a 5- or 6-membered heterocycle rings optionally substituted with from one or more substituents of particular note for Q¹ or Q² include the rings U-1 through U-56 illustrated in Exhibit 4 wherein R^{a} is any substituent as defined in the Summary of the Invention for Q¹ or Q² (e.g., a Q¹ ring or ring system is optionally substituted with R⁵ on carbon ring members and cyano, C₁-C₃ alkyl, C₂-C₃ alkenyl, C₂-C₃ alkynyl, C₃ cycloalkyl, C₁-C₃ alkoxy, C₂-C₃ alkoxyalkyl, C₂-C₃ alkylcarbonyl, C₂-C₃ alkoxycarbonyl, C₂-C₃ alkylaminoalkyl and C₃ dialkylaminoalkyl on nitrogen atom ring members) and r is an integer from 0 to 5, limited by the number of available positions on each U group. Note that some U groups can only be substituted with less than 4 R^{a} groups (e.g., U-4 through U-43 and U-47 through U-56). As U-24, U-25, U-31, U-32, U-33, U-34, U-35, U-36, U-37 and U-38 have only one available position, for these U groups, r is limited to the integers 0 or 1, and r being 0 means that the U group is unsubstituted and a hydrogen is present at the position indicated by (R^{a})ᵣ.

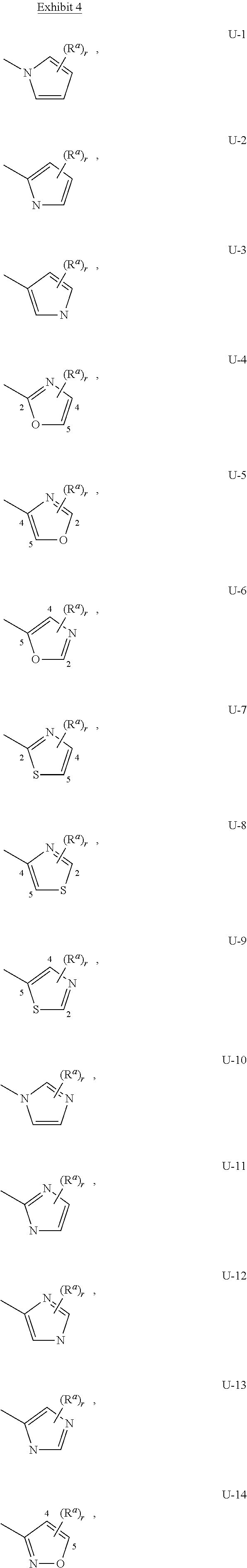

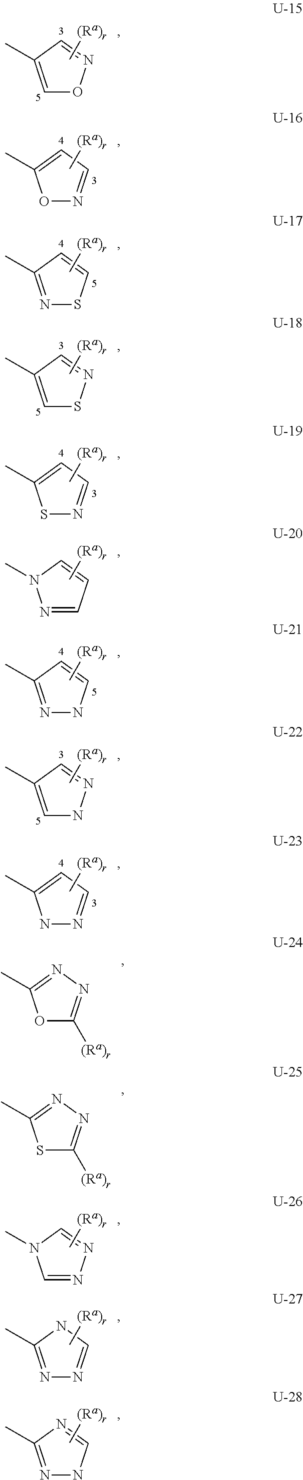

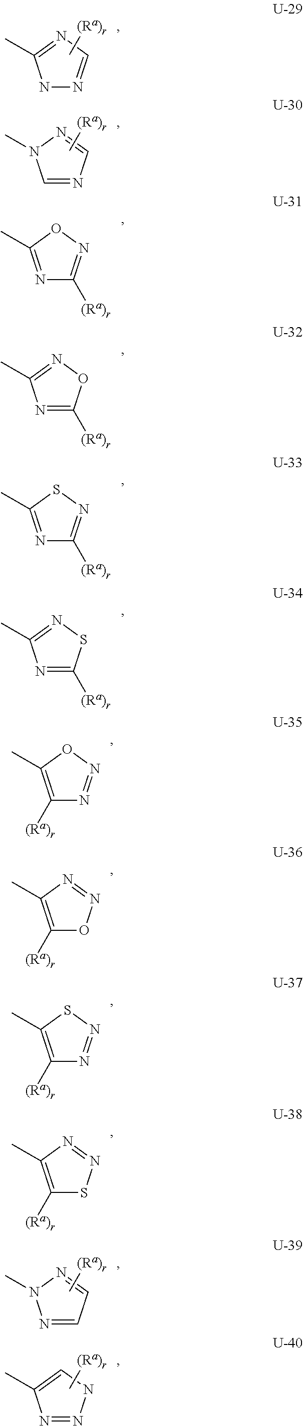

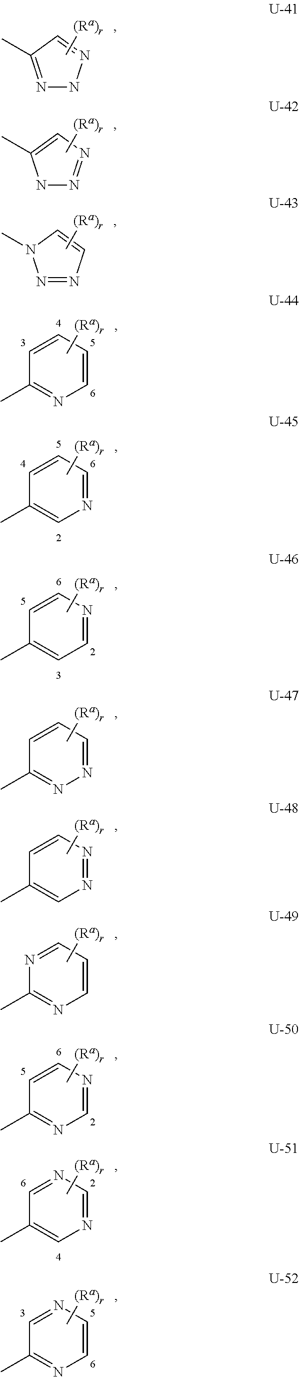

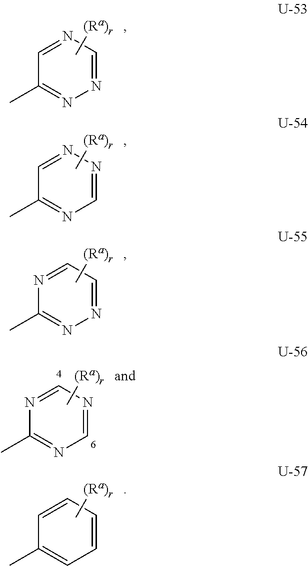

Although R^{a} groups are shown in the structures H-1 through H-39, B-1 through B-39, P-1 through P-40, and U-1 through U-57 in Exhibits 1 through 3 and Exhibit 4, it is noted that they do not need to be present since they are optional substituents. The nitrogen atoms that require substitution to fill their valence are substituted with H or R^{a}. Note that when the attachment point between (R^{a})ᵣ and the H, B, P or U group in Exhibits 1 through 3 and Exhibit 4 is illustrated as floating, (R^{a})ᵣ can be attached to any available carbon atom or nitrogen atom of the H, B, P or U group. Note that when the attachment point on the H, B or P group in Exhibits 1 through 3 is illustrated as floating, the H, B or P group can be attached to the remainder of Formula 1 through any available carbon or nitrogen of the H, B or P group by replacement of a hydrogen atom.

A wide variety of synthetic methods are known in the art to enable preparation of aromatic and nonaromatic heterocyclic rings and ring systems; for extensive reviews see the eight volume set of Comprehensive Heterocyclic Chemistry, A. R. Katritzky and C. W. Rees editors-in-chief, Pergamon Press, Oxford, 1984 and the twelve volume set of Comprehensive Heterocyclic Chemistry II, A. R. Katritzky, C. W. Rees and E. F. V. Scriven editors-in-chief, Pergamon Press, Oxford, 1996.

Compounds of this invention can exist as one or more stereoisomers. The various stereoisomers include enantiomers, diastereomers, atropisomers and geometric isomers. One skilled in the art will appreciate that one stereoisomer may be more active and/or may exhibit beneficial effects when enriched relative to the other stereoisomer(s) or when separated from the other stereoisomer(s). Additionally, the skilled artisan knows how to separate, enrich, and/or to selectively prepare said stereoisomers. The compounds of the invention may be present as a mixture of stereoisomers, individual stereoisomers or as an optically active form

One skilled in the art will appreciate that not all nitrogen containing heterocycles can form N-oxides since the nitrogen requires an available lone pair for oxidation to the oxide; one skilled in the art will recognize those nitrogen-containing heterocycles which can form N-oxides. One skilled in the art will also recognize that tertiary amines can form N-oxides. Synthetic methods for the preparation of N-oxides of heterocycles and tertiary amines are very well known by one skilled in the art including the oxidation of heterocycles and tertiary amines with peroxy acids such as peracetic and m-chloroperbenzoic acid (MCPBA), hydrogen peroxide, alkyl hydroperoxides such as t-butyl hydroperoxide, sodium perborate, and dioxiranes such as dimethyldioxirane. These methods for the preparation of N-oxides have been extensively described and reviewed in the literature, see for example: T. L. Gilchrist in Comprehensive Organic Synthesis, vol. 7, pp 748-750, S. V. Ley, Ed., Pergamon Press; M. Tisler and B. Stanovnik in Comprehensive Heterocyclic Chemistry, vol. 3, pp 18-20, A. J. Boulton and A. McKillop, Eds., Pergamon Press; M. R. Grimmett and B. R. T. Keene in Advances in Heterocyclic Chemistry, vol. 43, pp 149-161, A. R. Katritzky, Ed., Academic Press; M. Tisler and B. Stanovnik in Advances in Heterocyclic Chemistry, vol. 9, pp 285-291, A. R. Katritzky and A. J. Boulton, Eds., Academic Press; and G. W. H. Cheeseman and E. S. G. Werstiuk in Advances in Heterocyclic Chemistry, vol. 22, pp 390-392, A. R. Katritzky and A. J. Boulton, Eds., Academic Press.

One skilled in the art recognizes that some of the compounds disclosed herein can exist in equilibrium with one or more of their respective tautomeric counterparts. Unless otherwise indicated, reference to a compound by one tautomer description is to be considered to include all tautomers. For example, reference to the tautomeric form depicted by Formula 22¹ also includes the tautomic form depicted by Formula 22².

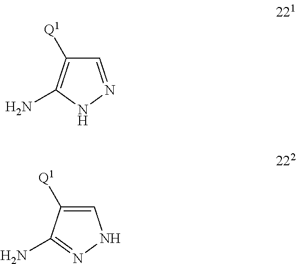

One skilled in the art recognizes that because in the environment and under physiological conditions salts of chemical compounds are in equilibrium with their corresponding nonsalt forms, salts share the biological utility of the nonsalt forms. Thus a wide variety of salts of the compounds of Formula 1 are useful for control of plant diseases caused by fungal plant pathogens (i.e. are agriculturally suitable). The salts of the compounds of Formula 1 include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids. When a compound of Formula 1 contains an acidic moiety such as a carboxylic acid or phenol, salts also include those formed with organic or inorganic bases such as pyridine, triethylamine or ammonia, or amides, hydrides, hydroxides or carbonates of sodium, potassium, lithium, calcium, magnesium or barium. Accordingly, the present invention comprises compounds selected from Formula 1, N-oxides and agriculturally suitable salts thereof.

Compounds selected from Formula 1, stereoisomers, tautomers, N-oxides, and salts thereof, typically exist in more than one form, and Formula 1 thus includes all crystalline and non-crystalline forms of the compounds that Formula 1 represents. Non-crystalline forms include embodiments which are solids such as waxes and gums as well as embodiments which are liquids such as solutions and melts. Crystalline forms include embodiments which represent essentially a single crystal type and embodiments which represent a mixture of polymorphs (i.e. different crystalline types). The term “polymorph” refers to a particular crystalline form of a chemical compound that can crystallize in different crystalline forms, these forms having different arrangements and/or conformations of the molecules in the crystal lattice. Although polymorphs can have the same chemical composition, they can also differ in composition due to the presence or absence of co-crystallized water or other molecules, which can be weakly or strongly bound in the lattice. Polymorphs can differ in such chemical, physical and biological properties as crystal shape, density, hardness, color, chemical stability, melting point, hygroscopicity, suspensibility, dissolution rate and biological availability. One skilled in the art will appreciate that a polymorph of a compound represented by Formula 1 can exhibit beneficial effects (e.g., suitability for preparation of useful formulations, improved biological performance) relative to another polymorph or a mixture of polymorphs of the same compound represented by Formula 1. Preparation and isolation of a particular polymorph of a compound represented by Formula 1 can be achieved by methods known to those skilled in the art including, for example, crystallization using selected solvents and temperatures.

Embodiments of the present invention as described in the Summary of the Invention include those described below. In the following Embodiments, Formula 1 includes stereoisomers, N-oxides and salts thereof, and reference to “a compound of Formula 1” includes the definitions of substituents specified in the Summary of the Invention unless further defined in the Embodiments.

### Embodiment 1

A compound of Formula 1 wherein Q¹ is a phenyl, pyridinyl, pyrimidinyl, pyrazinyl or pyridazinyl ring, each ring optionally substituted with up to 3 substituents independently selected from R⁵.

### Embodiment 2

A compound of Embodiment 1 wherein Q¹ is a phenyl ring optionally substituted with up to 3 substituents independently selected from R⁵.

### Embodiment 3

A compound of Embodiment 2 wherein Q¹ is a phenyl ring optionally substituted with up to 2 substituents independently selected from R⁵.

### Embodiment 4

A compound of Embodiment 3 wherein Q¹ is a phenyl ring optionally substituted with up to 1 substituent selected from R⁵.

### Embodiment 5

A compound of Formula 1 or any one of Embodiments 1 through 4 wherein Q¹ is a phenyl ring substituted with 1 to 3 substituents independently selected from R⁵.

### Embodiment 6

A compound of Embodiment 5 wherein Q¹ is a phenyl ring substituted with 1 to 2 substituents independently selected from R⁵.

### Embodiment 7

A compound of Embodiment 6 wherein Q¹ is a phenyl ring substituted with 2 substituents independently selected from R⁵.

### Embodiment 8

A compound of Embodiment 7 wherein Q¹ is a phenyl ring substituted with 1 substituent selected from R⁵.

### Embodiment 9

A compound of Formula 1 or any one of Embodiments 1 through 8 wherein Q¹ is a phenyl ring substituted with at least one R⁵ substituent attached at an ortho position (relative to the connection of the Q¹ ring to the remainder of Formula 1).

### Embodiment 10

A compound of Formula 1 or any one of Embodiments 1 through 9 wherein Q¹ is a phenyl ring substituted with at least one R⁵ substituent attached at the para position (relative to the connection of the Q¹ ring to the remainder of Formula 1).

### Embodiment 11

A compound of Formula 1 or any one of Embodiments 1 through 10 wherein Q² is a phenyl, pyridinyl, pyrimidinyl, pyrazinyl or pyridazinyl ring, each ring optionally substituted with up to 3 substituents independently selected from R⁵.

### Embodiment 12

A compound of Embodiment 11 wherein Q² is a phenyl ring optionally substituted with up to 3 substituents independently selected from R⁵.

### Embodiment 13

A compound of Embodiment 12 wherein Q² is a phenyl ring optionally substituted with up to 2 substituents independently selected from R⁵.

### Embodiment 14

A compound of Embodiment 13 wherein Q² is a phenyl ring optionally substituted with up to 1 substituent selected from R⁵.

### Embodiment 15

A compound of Formula 1 or any one of Embodiments 1 through 14 wherein Q² is a phenyl ring substituted with 1 to 3 substituents independently selected from R⁵.

### Embodiment 16

A compound of Embodiment 15 wherein Q² is a phenyl ring substituted with 1 to 2 substituents independently selected from R⁵.

### Embodiment 17

A compound of Embodiment 16 wherein Q² is a phenyl ring substituted with 2 substituents independently selected from R⁵.

### Embodiment 18

A compound of Embodiment 17 wherein Q² is a phenyl ring substituted with 1 substituent selected from R⁵.

### Embodiment 19

A compound of Formula 1 or any one of Embodiments 1 through 18 wherein Q² is a phenyl ring substituted with at least one R⁵ substituent attached at an ortho position (relative to the connection of the Q² ring to the remainder of Formula 1).

### Embodiment 20

A compound of Formula 1 or any one of Embodiments 1 through 19 wherein Q² is a phenyl ring substituted with at least one R⁵ substituent attached at the para position (relative to the connection of the Q² ring to the remainder of Formula 1).

### Embodiment 21

A compound of Formula 1 or any one of Embodiments 1 through 20 wherein when Q¹ and Q² are each a phenyl ring substituted with 1 to 3 substituents independently selected from R⁵, then one ring is substituted with 2 to 3 substituents and the other ring is substituted with 1 to 2 substituents.

### Embodiment 22

A compound of Formula 1 or any one of Embodiments 1 through 21 wherein when Q¹ and Q² are each a phenyl ring substituted with 1 to 3 substituents independently selected from R⁵, then one ring is substituted with 3 substituents and the other ring substituted with 2 substituents.

### Embodiment 23

A compound of Formula 1 or any one of Embodiments 1 through 22 wherein when Q¹ and Q² are each a phenyl ring substituted with 1 to 3 substituents independently selected from R⁵, then both rings are substituted with 2 substituents.

### Embodiment 24

A compound of Formula 1 or any one of Embodiments 1 through 22 wherein when Q¹ and Q² are each a phenyl ring substituted with 1 to 3 substituents independently selected from R⁵, then at least one of Q¹ and Q² is substituted with at least one R⁵ substituent attached at an ortho position (relative to the connection of the Q¹ and Q² rings to the remainder of Formula 1).

### Embodiment 25

A compound of Formula 1 or any one of Embodiments 1 through 24 wherein when R¹ is taken alone (i.e. not taken together with R^{1a}), then R¹ is H, cyano, halogen, C₁-C₂ alkyl, C₁-C₂ haloalkyl or cyclopropyl.

### Embodiment 25a

A compound of Embodiment 25 wherein R¹ is H, halogen, C₁-C₂ alkyl or C₁-C₂ haloalkyl.

### Embodiment 26

A compound of Embodiment 25a wherein R¹ is H, halogen, methyl or halomethyl.

### Embodiment 27

A compound of Embodiment 26 wherein R¹ is H, halogen or methyl.

### Embodiment 28

A compound of Embodiment 27 wherein R¹ is H or methyl.

### Embodiment 29

A compound of Embodiment 28 wherein R¹ is H.

### Embodiment 30

A compound of Formula 1 or any one of Embodiments 1 through 29 wherein R¹ is taken alone.

### Embodiment 31

A compound of Formula 1 or any one of Embodiments 1 through 30 wherein R^{1a} is H.

### Embodiment 32

A compound of Formula 1 or any one of Embodiments 1 through 31 wherein R^{1a} is taken alone.

### Embodiment 33

A compound of Formula 1 or any one of Embodiments 1 through 31 wherein when R^{1a} and R¹ are taken together with the carbon atom to which they are attached to form a ring, then said ring is cyclopropyl (i.e. unsubstituted).

### Embodiment 34

A compound of Formula 1 or any one of Embodiments 1 through 31 wherein R^{1a} and R¹ are taken together.

### Embodiment 35

A compound of Formula 1 or any one of Embodiments 1 through 34 wherein R² is cyano, halogen, C₁-C₂ alkyl, halomethyl, cyanomethyl, hydroxymethyl, methoxy or methylthio; or cyclopropyl optionally substituted with up to 2 substituents independently selected from halogen and methyl.

### Embodiment 36

A compound of Embodiment 35 wherein R² is Br, Cl, I or C₁-C₂ alkyl.

### Embodiment 37

A compound of Embodiment 36 wherein R² is Br, Cl or methyl.

### Embodiment 38

A compound of Embodiment 37 wherein R² is methyl.

### Embodiment 39

A compound of Formula 1 or any one of Embodiments 1 through 38 wherein R³ is H or C₁-C₃ alkyl.

### Embodiment 40

A compound of Embodiment 39 wherein R³ is H or methyl.

### Embodiment 41

A compound of Embodiment 40 wherein R³ is H.

### Embodiment 42

A compound of Formula 1 or any one of Embodiments 1 through 41 wherein R⁴ is —NR^{6a}R^{6b} or —SR⁷.

### Embodiment 43

A compound of Embodiment 42 wherein R⁴ is —NR^{6a}R^{6b}.

### Embodiment 44

A compound of Formula 1 or any one of Embodiments 1 through 43 wherein each R⁵ is independently cyano, halogen, C₁-C₄ alkyl, C₂-C₄ alkenyl, C₁-C₄ haloalkyl, C₂-C₄ haloalkenyl, C₃-C₆ cycloalkyl, C₄-C₆ cycloalkylalkyl, C₄-C₆ alkylcycloalkyl, C₅-C₈ cycloalkylalkenyl, C₁-C₄ alkylthio, C₁-C₄ alkylsulfinyl, C₁-C₄ alkylsulfonyl, C₁-C₄ alkoxy, C₁-C₄ haloalkoxy, C₂-C₄ alkenyloxy, C₂-C₄ haloalkenyloxy, C₃-C₄ alkynyloxy, C₃-C₄ haloalkynyloxy, C₂-C₄ alkylcarbonyloxy, C₃-C₆ cycloalkoxy, C₄-C₈ cycloalkylalkoxy, C₁-C₄ alkylsulfonyloxy, C₁-C₄ haloalkylsulfonyloxy, C₄-C₉ trialkylsilylalkoxy, C₂-C₄ alkylcarbonyl, C₁-C₄ alkylamino, C₂-C₄ dialkylamino, C₂-C₄ alkylcarbonylamino, C(═S)NR^{8a}R^{8b}, —NH₂CH(═O), CR^{9a}═NOR^{9b}, CR^{9c}═NNR^{8a}R^{8b}, NR^{8a}N═CR^{10a}R^{10b}, —ON═CR^{10a}R^{10b}, —CH(═O), SC≡N or —U—V-T.

### Embodiment 45

A compound of Embodiment 44 wherein each R⁵ is independently cyano, halogen, methyl, halomethyl, cyclopropyl, methylthio, methoxy, C₂-C₄ alkenyloxy, C₂-C₄ haloalkenyloxy, methylcarbonyloxy, methylsulfonyloxy, methylcarbonyl, C₄-C₈ cycloalkylalkoxy, C₃-C₄ alkylsulfonyloxy, C₃-C₄ haloalkylsulfonyloxy, C₄-C₉ trialkylsilylalkoxy, C(═S)NR^{8a}R^{8b}, CR^{9a}═NOR^{9b}, CR^{9c}═NNR^{8a}R^{8b}, NR^{8a}N═CR^{10a}R^{10b}, —ON═CR^{10a}R^{10b} or —U—V-T.

### Embodiment 46

A compound of Embodiment 45 wherein each R⁵ is independently cyano, halogen, methyl, halomethyl, cyclopropyl, methylthio, methoxy, C₂-C₄ alkenyloxy, C₂-C₄ haloalkenyloxy, methylcarbonyloxy, methylsulfonyloxy, methylcarbonyl, C₄-C₈ cycloalkylalkoxy, C₃-C₄ alkylsulfonyloxy, C₃-C₄ haloalkylsulfonyloxy, C₄-C₉ trialkylsilylalkoxy, C(═S)NR^{8a}R^{8b}, CR^{9a}═NOR^{9b}, CR^{9c}═NNR^{8a}R^{8b}, NR^{8a}N═CR^{10a}R^{10b} or —ON═CR^{10a}R^{10b}.

### Embodiment 47

A compound of Embodiment 46 wherein each R⁵ is independently halogen, cyano or methoxy.

### Embodiment 48

A compound of Embodiment 47 wherein each R⁵ is independently Br, Cl, F, cyano or methoxy.

### Embodiment 48a

A compound of Embodiment 47 wherein each R⁵ is independently Br, Cl or F.

### Embodiment 49

A compound of Embodiment 48a wherein each R⁵ is independently Cl or F.

### Embodiment 50

A compound of Formula 1 or any one of Embodiments 1 through 49 wherein R^{6a} and R^{6b} are each independently H, methyl, halomethyl, C₂-C₄ alkoxyalkyl, C₂-C₄ alkylcarbonyl, C₂-C₅ alkoxycarbonyl, C₃-C₅ alkoxycarbonylalkyl, C₂-C₅ alkylaminocarbonyl or C₃-C₅ dialkylaminocarbonyl.

### Embodiment 51

A compound of Embodiment 50 wherein R^{6a} and R^{6b} are each independently H, methyl, halomethyl, C₂-C₄ alkoxyalkyl, C₂-C₄ alkylcarbonyl or C₂-C₅ alkoxycarbonyl.

### Embodiment 52

A compound of Embodiment 51 wherein R^{6a} and R^{6b} are each independently H, methyl, halomethyl or C₂-C₄ alkoxyalkyl.

### Embodiment 53

A compound of Embodiment 52 wherein R^{6a} and R^{6b} are each independently H or methyl.

### Embodiment 54

A compound of Embodiment 53 wherein R^{6a} and R^{6b} are each H.

### Embodiment 55

A compound of Formula 1 or any one of Embodiments 1 through 54 wherein R⁷ is independently H or methyl.

### Embodiment 56

A compound of Formula 1 or any one of Embodiments 1 through 55 wherein each R^{9a} is independently H, methyl or halomethyl.

### Embodiment 57

A compound of Embodiment 56 wherein each R^{9a} is H.

### Embodiment 58

A compound of Formula 1 or any one of Embodiments 1 through 57 wherein each R^{9b} and R^{9c} is independently H, C₁-C₃ alkyl, C₁-C₃ haloalkyl, C₃-C₄ cycloalkyl or C₃-C₄ halocycloalkyl.

### Embodiment 59

A compound of Embodiment 58 wherein each R^{9b} and R^{9c} is independently H, methyl, halomethyl or cyclopropyl.

### Embodiment 60

A compound of Formula 1 or any one of Embodiments 1 through 59 wherein each U is independently O or NR¹¹.

### Embodiment 61

A compound of Embodiment 60 wherein each U is independently 0 or NH.

### Embodiment 62

A compound of Formula 1 or any one of Embodiments 1 through 61 wherein each V is independently C₁-C₃ alkylene, wherein up to 1 carbon atom is selected from C(═O).

### Embodiment 63

A compound of Embodiment 62 wherein each V is C₂-C₄ alkylene.

### Embodiment 64

A compound of Formula 1 or any one of Embodiments 1 through 63 wherein each T is independently NR^{12a}R^{12b} or OR¹³.

### Embodiment 65

A compound of Formula 1 or any one of Embodiments 1 through 64 wherein each R^{12a} and R^{12b} is independently H, C₁-C₆ alkyl or C₁-C₆ haloalkyl.

### Embodiment 66

A compound of Embodiment 65 wherein each R^{12b} and R^{12b} is independently H or methyl.

### Embodiment 67

A compound of Formula 1 or any one of Embodiments 1 through 66 wherein each R¹³ is independently H, methyl or halomethyl.

### Embodiment 68

A compound of Embodiment 67 wherein each R¹³ is methyl.

### Embodiment 69

A compound of Formula 1 or any one of Embodiments 1 through 68 wherein each n is 0.

### Embodiment 70

A compound of Formula 1 or any one of Embodiments 1 through 68 wherein each n is 2.

Embodiments of this invention, including Embodiments 1-70 above as well as any other embodiments described herein, can be combined in any manner, and the descriptions of variables in the embodiments pertain not only to the compounds of Formula 1 but also to the starting compounds and intermediate compounds useful for preparing the compounds of Formula 1. In addition, embodiments of this invention, including Embodiments 1-70 above as well as any other embodiments described herein, and any combination thereof, pertain to the compositions and methods of the present invention.

Combinations of Embodiments 1-70 are illustrated by:

### Embodiment A

A compound of Formula 1 wherein
Q¹ is a phenyl ring optionally substituted with up to 3 substituents independently selected from R⁵;
Q² is a phenyl ring optionally substituted with up to 3 substituents independently selected from R⁵;
R¹ is H, halogen or methyl;
R^{1a} is H;
R² is Br, Cl, I or C₁-C₂ alkyl;
R³ is H or C₁-C₃ alkyl;
R⁴ is —NR^{6a}R^{6b};
each R⁵ is independently cyano, halogen, methyl, halomethyl, cyclopropyl, methylthio, methoxy, C₂-C₄ alkenyloxy, C₂-C₄ haloalkenyloxy, methylcarbonyloxy, methylsulfonyloxy, methylcarbonyl, C₄-C₈ cycloalkylalkoxy, C₃-C₄ alkylsulfonyloxy, C₃-C₄ haloalkylsulfonyloxy, C₄-C₉ trialkylsilylalkoxy, C(═S)NR^{8a}R^{8b}, CR^{9a}═NOR^{9b}, CR^{9c}═NNR^{8a}R^{8b}, NR^{8a}N═CR^{10a}R^{10b}, —ON═CR^{10a}R^{10b} or —U—V-T;
R^{6a} and R^{6b} are each independently H, methyl, halomethyl or C₂-C₄ alkoxyalkyl; and
R^{9b} and R^{9c} is independently H, C₁-C₃ alkyl, C₁-C₃ haloalkyl, C₃-C₄ cycloalkyl or C₃-C₄ halocycloalkyl.

### Embodiment B

A compound of Embodiment A wherein
Q¹ is a phenyl ring substituted with 1 to 3 substituents independently selected from R⁵;
Q² is a phenyl ring substituted with 1 to 3 substituents independently selected from R⁵;
R¹ is H;
R² is Br, Cl or methyl;
R³ is H or methyl;
each R⁵ is independently cyano, halogen, methyl, halomethyl, cyclopropyl, methylthio, methoxy, C₂-C₄ alkenyloxy, C₂-C₄ haloalkenyloxy, methylcarbonyloxy, methylsulfonyloxy, methylcarbonyl, C₄-C₈ cycloalkylalkoxy, C₃-C₄ alkylsulfonyloxy, C₃-C₄ haloalkylsulfonyloxy, C₄-C₉ trialkylsilylalkoxy, C(═S)NR^{8a}R^{8b}, CR^{9a}═NOR^{9b}, CR^{9c}═NNR^{8a}R^{8b}, NR^{8a}N═CR^{10a}R^{10b} or —ON═CR^{10a}R^{10b};
each R^{9a} is independently H, methyl or halomethyl; and
R^{9b} and R^{9c} is independently H, methyl, halomethyl or cyclopropyl.

### Embodiment C

A compound of Embodiment B wherein
R³ is H;
each R⁵ is independently Br, Cl, F, cyano or methoxy; and
R^{6a} and R^{6b} are each independently H or methyl.

### Embodiment D

A compound of Embodiment C wherein
at least one of Q¹ and Q² is substituted with at least one R⁵ substituent attached at an ortho position;
each R⁵ is independently Br, Cl or F; and
R^{6a} and R^{6b} are each H.

Specific embodiments include compounds of Formula 1 selected from the group consisting of:
α-(2,4-difluorophenyl)-4-(2,6-difluorophenyl)-1,3-dimethyl-1H-pyrazol-5-methanamine;
α-(2,4-difluorophenyl)-4-(2,6-difluorophenyl)-N,1,3-trimethyl-1H-pyrazol-5-methanamine; and
4-(2,6-difluorophenyl)-5-[(2,4-difluorophenyl)(methylthio)methyl]-1,3-dimethyl-1H-pyrazole.

This invention provides a fungicidal composition comprising a compound of Formula 1 (including all stereoisomers, N-oxides, and salts thereof), and at least one other fungicide. Of note as embodiments of such compositions are compositions comprising a compound corresponding to any of the compound embodiments described above.

This invention provides a fungicidal composition comprising a compound of Formula 1 (including all stereoisomers, N-oxides, and salts thereof) (i.e. in a fungicidally effective amount), and at least one additional component selected from the group consisting of surfactants, solid diluents and liquid diluents. Of note as embodiments of such compositions are compositions comprising a compound corresponding to any of the compound embodiments described above.

This invention provides a method for controlling plant diseases caused by fungal plant pathogens comprising applying to the plant or portion thereof, or to the plant seed, a fungicidally effective amount of a compound of Formula 1 (including all stereoisomers, N-oxides, and salts thereof). Of note as embodiment of such methods are methods comprising applying a fungicidally effective amount of a compound corresponding to any of the compound embodiments describe above. Of particular note are embodiments where the compounds are applied as compositions of this invention.

One or more of the following methods and variations as described in Schemes 1-15 can be used to prepare the compounds of Formula 1. The definitions of Q¹, Q², R¹, R^{1a}, R², R³, R⁴ and R⁷ in the compounds of Formulae 1-23 below are as defined above in the Summary of the Invention unless otherwise noted. Compounds of Formulae 1a-1b are various subsets of the compounds of Formula 1, and all substituents for Formulae 1a-1b are as defined above for Formula 1. Compounds of Formulae 4a-4d are various subsets of the compounds of Formula 4, and all substituents for Formulae 4a-4d are as defined above for Formula 1.

As illustrated in Scheme 1, compounds of Formula 1 wherein R⁴ is amino, substituted amine or substituted sulfur can be prepared by reaction of halopyrazoles of Formula 2 with appropriate reagents of Formula 3. Reaction of compounds of Formula 2 with compounds of Formula 3, (for example, ammonia, methyl amine or methane thiol) in a solvent such as dichloromethane, N,N-dimethylformamide, diethyl ether or tetrahydrofuran at a temperature range of 0 to 100° C., preferably in a range of 25 to 60° C. for time periods in the range of 1 to 24 h, using procedures such as those described in Tetrahedron Letters 2005, 46, 1357-1360 and Canadian Journal of Chemistry 1987, 65, 88-93 provides compounds of Formula 1.

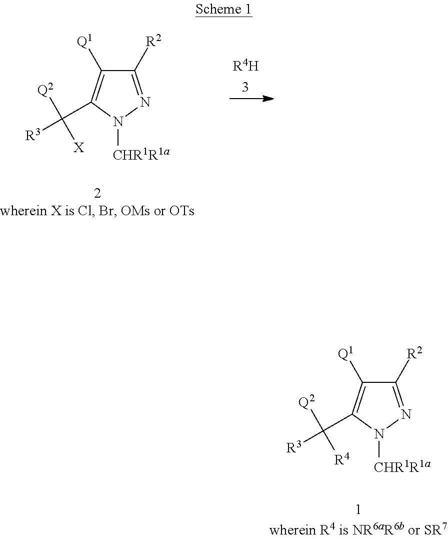

As illustrated in Scheme 2, sulfoxides and sulfones of Formula 1a (i.e. Formula 1 wherein R⁴ is S(O)ₙR⁷ and n is 1 or 2) can be made via oxidation of the sulfur atom on sulfides of Formula 1b (i.e. Formula 1 wherein R⁴ is S(O)ₙR⁷ and n is 0). In this method a compound of Formula 1a wherein n is 1 (i.e. sulfoxides) or n is 2 (i.e. sulfones) is prepared by oxidizing a corresponding sulfide of Formula 1b with a suitable oxidizing agent. In a typical procedure, an oxidizing agent in an amount from 1 to 4 equivalents depending on the oxidation state of the product desired is added to a solution of the compound of Formula 1b in a solvent. Useful oxidizing agents include Oxone® (potassium peroxymonosulfate), hydrogen peroxide, sodium periodate, peracetic acid and 3-chloroperbenzoic acid. The solvent is selected with regard to the oxidizing agent employed. Aqueous ethanol or aqueous acetone is preferably used with potassium peroxymonosulfate, and dichloromethane is generally preferable with 3-chloroperbenzoic acid. Useful reaction temperatures typically range from −78 to 90° C. Procedures useful for oxidizing sulfides to sulfoxides and sulfones are described in J. Agric. Food Chem. 1984, 32, 221-226; Tetrahedron Letters 2009, 50, 1180-1183 and Green Chemistry 2012, 14, 957-962.

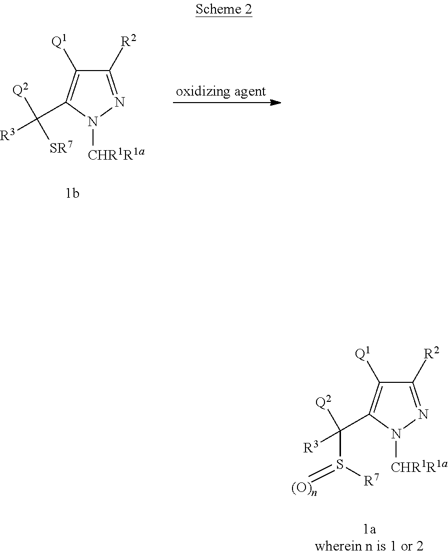

As illustrated in Scheme 3, compounds of Formula 2 can be prepared by from compounds of Formula 4. Compounds of Formula 4 treated with thionyl chloride, phosphorus pentachloride, phosphorous tribromide, methanesulfonyl (Ms) chloride or p-toluenesulfonyl (Ts) chloride in presence of a base such as triethylamine or pyridine in a solvent such as dichloromethane or tetrahydrofuran at 25 to 110° C. provide compounds of Formula 2 wherein X is Cl, Br, OMs or OTs. These general methods are described in J. Org. Chem 1982, 47, 5220-5222; Eur. J. Med. Chem. 2009, 44, 1223-1229 and Synlett 1999, 11, 1763-1765.

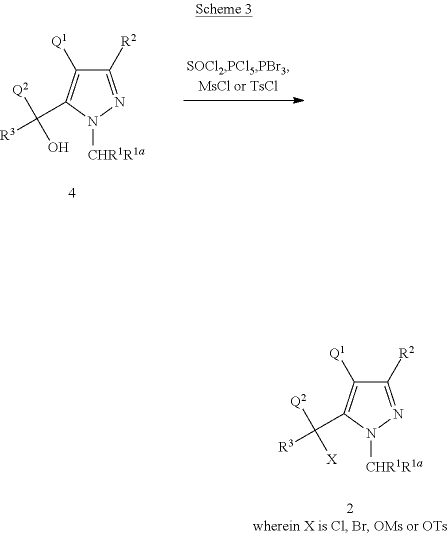

As shown in Scheme 4 compounds of Formula 4 can be prepared by treatment of compounds of Formula 5 with an organometallic reagent of Formula 6 such as an alkyllithium, preferably n-butyllithium, or an alkylmagnesium reagent, preferably isopropylmagnesium chloride (optionally complexed with lithium chloride) to form a metallated intermediate of Formula 7, followed by the addition of a aldehyde of Formula 8. Reaction temperatures in the range of −90° C. to the boiling point of the reaction solvent are useful with temperatures of −78° C. to ambient temperature typical and temperatures of −78 to −10° C. preferred when an alkyllithium reagent is used, and −20° C. to ambient temperature preferred with use of alkylmagnesium reagents. A variety of anhydrous solvents are useful, such as toluene, diethyl ether, tetrahydrofuran or dimethoxyethane. The Q²-containing aldehyde carbonyl intermediates of Formula 8 are commercially available or can be prepared by methods known in the art.

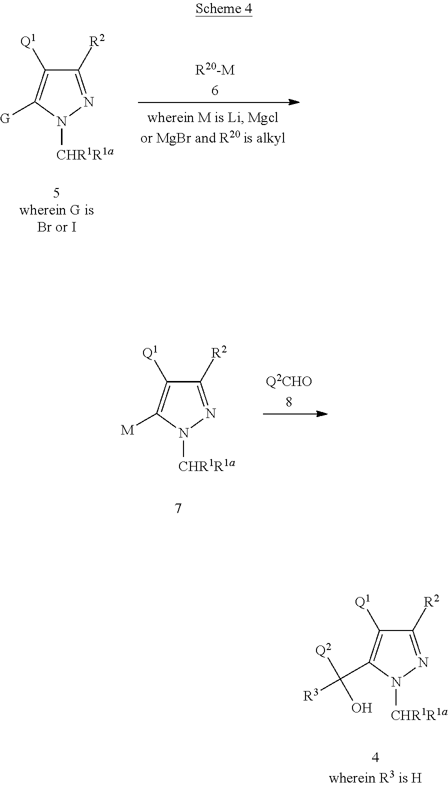

As shown in Scheme 5, compounds of Formula 5 wherein G is Br or I can be prepared by reaction of 5-aminopyrazoles of Formula 9 under diazotization conditions either in the presence of, or followed by, copper salts containing bromide or iodide. For example, addition of tert-butyl nitrite to a solution of a 5-aminopyrazole of Formula 9 in the presence of CuBr₂ in a solvent such as acetonitrile provides the corresponding 5-bromopyrazole of Formula 5. Likewise, a 5-aminopyrazole of Formula 9 can be converted to a diazonium salt and then to a corresponding 5-halopyrazole of Formula 5 by treatment with sodium nitrite in a solvent such as water, acetic acid or trifluoroacetic acid, in the presence of a mineral acid typically containing the same halide atom (such as aqueous HI solution for G being I), followed by treatment with the corresponding copper(I) or copper(II) salt according to general procedures well-known to those skilled in the art, such as described in Tetrahedron Lett. 2000, 41(24), 4713-4716.

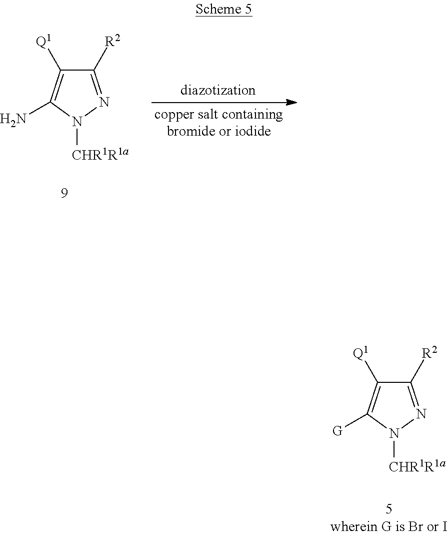

General methods useful for preparing 5-aminopyrazoles of Formula 9 are well known in the art; see, for example, Journal für Praktische Chemie (Liepzig) 1911, 83, 171 and J. Am. Chem. Soc. 1954, 76, 501-503. In one method, as shown in Scheme 6, compounds of Formula 9 are prepared by treating compounds of Formula 10 with alkyl hydrazines of Formula 11, optionally in presence of an acidic catalyst such as acetic acid.

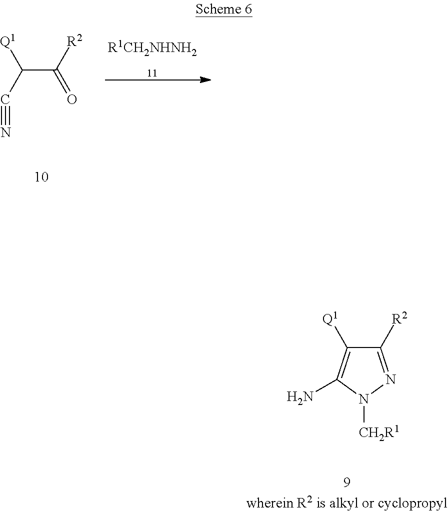

As illustrated in Scheme 7, compounds of Formula 10 can be prepared by reacting compounds of Formula 12 with optionally substituted alkanoic or cycloalkanoic acid ethyl esters of Formula 13, in presence of a base such as sodium ethoxide, potassium t-butoxide or sodium hydride. Reaction temperatures can range from ambient temperatures (e.g., about 18 to 30° C.) to 100° C., for time periods of 10 min to 5 h. Typical solvents used are tetrahydrofuran or ethanol. See, for example, Bioorganic & Medicinal Chemistry 2006, 14, 1785-1791, Organic Syntheses Coll. Vol. 2, p. 487-489, and Organic Reactions, John Wiley & Sons, Inc. 1984, Vol. 31, pp. 31 and 38, and references cited therein.

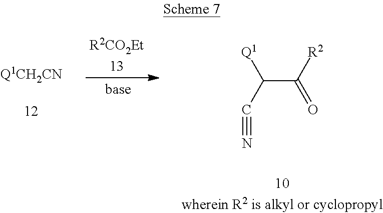

As shown in Scheme 8, compounds of Formula 4a (compounds of Formula 4 wherein R² is C₂-C₃ alkenyl or C₂-C₃ alkynyl) can be prepared by reacting compounds of Formula 4b with organometallics of Formula 14, in which M is, for example, B(OH)₂ or esters thereof, ZnCl, ZnBr, MgCl, MgBr, SnMe₃ or SnBu₃. Alternatively, compounds of Formula 4a wherein R² is alkenyl or alkynyl can be prepared by reacting compounds of Formula 4b with alkenes or alkynes of Formula 15 in the presence of a palladium catalyst such as tetrakis(triphenylphosphine)Pd(0), dichloro[1,1′-bis(diphenylphosphino)ferrocene]-palladium or Pd(OAc)₂, optionally with the addition of copper(I) salts such as cuprous iodide, and advantageously in the presence of a base such as triethylamine, sodium acetate, potassium carbonate or sodium tert-butoxide. Procedures of this type may be found in PCT Patent Publications WO 2010/093885 and WO 2011/076725.

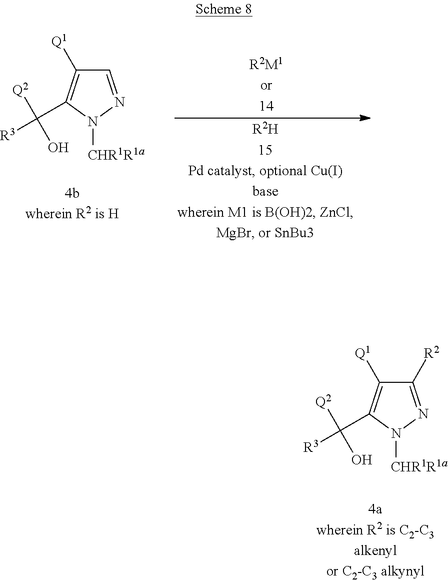

As illustrated in Scheme 9, compounds of Formula 4c (i.e. Formula 4 wherein R² is is chlorine, bromine or iodine) are prepared by treating compounds of Formula 4b with the corresponding N-halosuccinimide e.g. N-chlorosuccinimide (NCS), in presence of a suitable solvent such as N,N-dimethylformamide or tetrahydrofuran at 20 to 60° C. for a time period of 30 min to 15 h, according to general procedures known in the art such as described in Tetrahedron Lett. 2009, 50, 5762-5764.

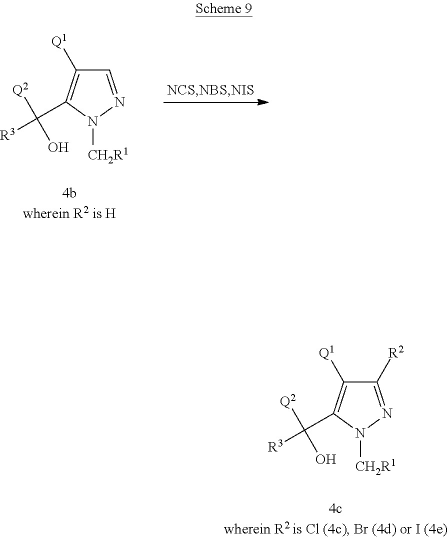

To prepare compounds Formula 4d (i.e. Formula 4 wherein R² is fluorine), compounds of Formula 4b are treated with N-fluorobis(phenylsulfonyl)amine as shown in Scheme 10. An example is described in PCT Patent Publications WO 2010/079239.

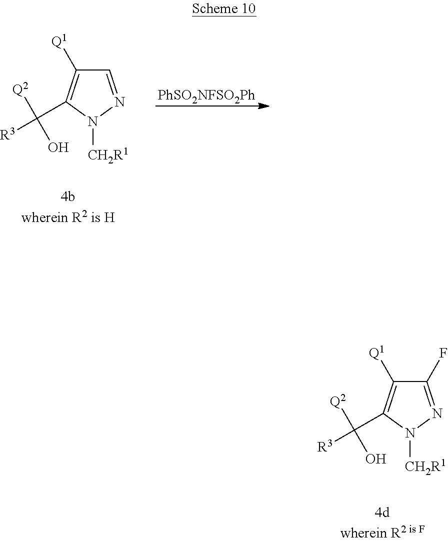

As shown in Scheme 11, compounds of Formula 4b can be prepared by reacting compounds of Formula 16 with compounds of Formula 17 to give intermediates of Formula 18 which are further reacted with compounds of Formula 19 under conditions similar to those employed for the method of Scheme 4.

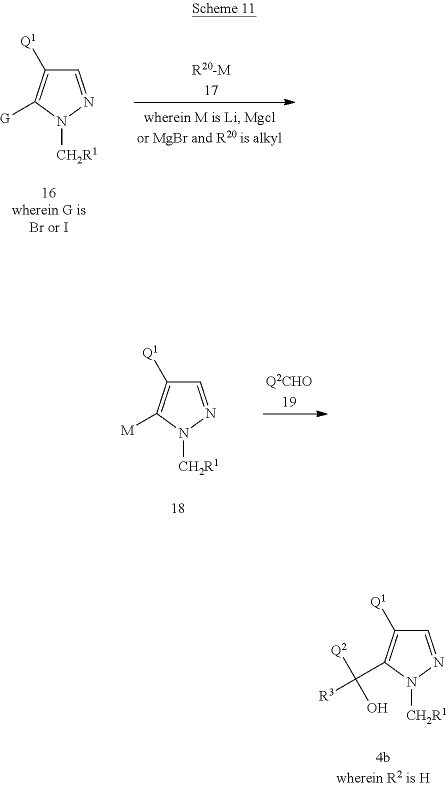

As shown in Scheme 12, compounds of Formula 16, can be prepared by treating compounds of Formula 20 with an alkyl iodide of Formula 21 in presence of a base such as sodium hydride or potassium carbonate in a solvent such as tetrahydrofuran or toluene at 0° C. to ambient temperatures, for time periods of 30 min to 15 h. See, for example, Synth. Commun. 2008, 38, 674-683, and PCT Patent Publication WO 2006/092510.

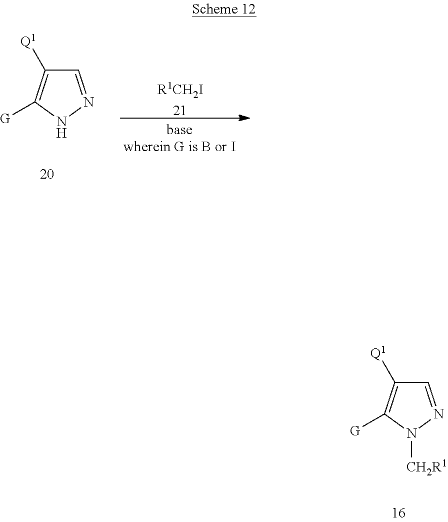

As illustrated in Scheme 13, compounds of Formula 20 are prepared from compounds of Formula 22 under conditions similar to those employed for the method of Scheme 5.

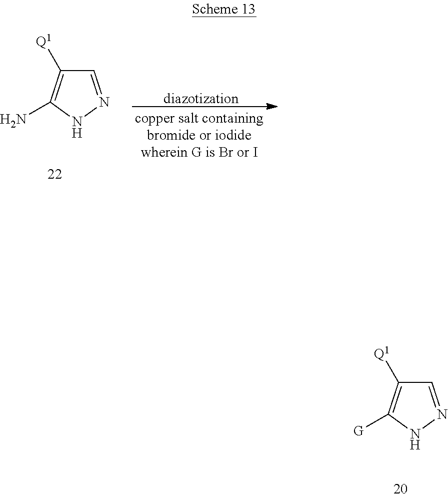

As illustrated in Scheme 14, compounds of Formula 22 can be prepared by treating compounds of Formula 23 with hydrazine hydrate in presence of an acid such as acetic acid in a suitable solvent such as toluene or N,N-dimethylformamide at temperatures ranging from ambient temperatures to 100° C. for time periods of 2 min to 16 h, such as described in J. Heterocyclic Chem. 2008, 45, 307-310, ARKIVOC 2006, (15), 133-141, and PCT Patent Publication 2007/147647.

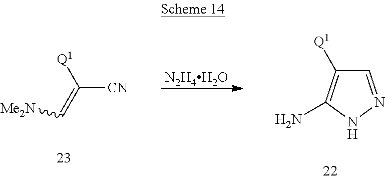

As shown in Scheme 15, compounds of Formula 23 can be prepared by reacting compounds of Formula 12 with dimethylformamide-dimethyl acetal in presence of a solvent such as toluene or xylene at temperatures ranging from ambient temperatures to 120° C. for time periods of 1 h to 3.5 h, such as described in J. Med. Chem. 2008, 51, 3777-3787, and PCT Patent Publication 2005/070431.

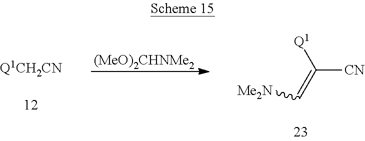

It is recognized by one skilled in the art that various functional groups can be converted into others to provide different compounds of Formula 1. For example, compounds of Formula 1 in which R² is methyl, ethyl or cyclopropyl can be modified by free-radical halogenation to form compounds of Formula 1 wherein R² is halomethyl, haloethyl or halocyclopropyl. The halomethyl compounds can be used as intermediates to prepare compounds of Formula 1 wherein R² is hydroxymethyl or cyanomethyl. Compounds of Formula 1 or intermediates for their preparation may contain aromatic nitro groups, which can be reduced to amino groups, and then be converted via reactions well known in the art such as the Sandmeyer reaction, to various halides, providing other compounds of Formula 1. By similar known reactions, aromatic amines (anilines) can be converted via diazonium salts to phenols, which can then be alkylated to prepare compounds of Formula 1 with alkoxy substituents. Likewise, aromatic halides such as bromides or iodides prepared via the Sandmeyer reaction can react with alcohols under copper-catalyzed conditions, such as the Ullmann reaction or known modifications thereof, to provide compounds of Formula 1 that contain alkoxy substituents. Additionally, some halogen groups, such as fluorine or chlorine, can be displaced with alcohols under basic conditions to provide compounds of Formula 1 containing the corresponding alkoxy substituents. The resultant alkoxy compounds can themselves be used in further reactions to prepare compounds of Formula 1 wherein R⁵ is —U—V-T (see, for example, PCT Publication WO 2007/149448 A2). Compounds of Formula 1 or precursors thereof in which R² or R³ is halide, preferably bromide or iodide, are particularly useful intermediates for transition metal-catalyzed cross-coupling reactions to prepare compounds of Formula 1. These types of reactions are well documented in the literature; see, for example, Tsuji in Transition Metal Reagents and Catalysts: Innovations in Organic Synthesis, John Wiley and Sons, Chichester, 2002; Tsuji in Palladium in Organic Synthesis, Springer, 2005; and Miyaura and Buchwald in Cross Coupling Reactions: A Practical Guide, 2002; and references cited therein.

Additional useful procedures for the preparation of the compounds of the current invention can be found in PCT Publications WO 2010/101973 and WO 2012/023143.

It is recognized that some reagents and reaction conditions described above for preparing compounds of Formula 1 may not be compatible with certain functionalities present in the intermediates. In these instances, the incorporation of protection/deprotection sequences or functional group interconversions into the synthesis will aid in obtaining the desired products. The use and choice of the protecting groups will be apparent to one skilled in chemical synthesis (see, for example, Greene, T. W.; Wuts, P. G. M. Protective Groups in Organic Synthesis, 2nd ed.; Wiley: New York, 1991). One skilled in the art will recognize that, in some cases, after the introduction of a given reagent as it is depicted in any individual scheme, it may be necessary to perform additional routine synthetic steps not described in detail to complete the synthesis of compounds of Formula 1. One skilled in the art will also recognize that it may be necessary to perform a combination of the steps illustrated in the above schemes in an order other than that implied by the particular sequence presented to prepare the compounds of Formula 1.

One skilled in the art will also recognize that compounds of Formula 1 and the intermediates described herein can be subjected to various electrophilic, nucleophilic, radical, organometallic, oxidation, and reduction reactions to add substituents or modify existing substituents.

Without further elaboration, it is believed that one skilled in the art using the preceding description can utilize the present invention to its fullest extent. The following Examples are, therefore, to be construed as merely illustrative, and not limiting of the disclosure in any way whatsoever. Steps in the following Examples illustrate a procedure for each step in an overall synthetic transformation, and the starting material for each step may not have necessarily been prepared by a particular preparative run whose procedure is described in other Examples or Steps. Percentages are by weight except for chromatographic solvent mixtures or where otherwise indicated. Parts and percentages for chromatographic solvent mixtures are by volume unless otherwise indicated. ¹H NMR spectra are reported in ppm downfield from tetramethylsilane; “s” means singlet, and “m” means multiplet.

### Synthesis Example 1

### Preparation of α-(2,4-difluorophenyl)-4-(2,6-difluorophenyl)-1,3-dimethyl-1H-pyrazol-5-methanamine (Compound 3)

### Step A: Preparation of α-acetyl-2,6-difluorobenzeneacetonitrile

Solid sodium ethoxide (4.4 g, 0.06 mol) was stirred in a mixture of xylene (15 mL) and ethanol (12 mL) and heated at 70° C. A solution of 2,6-difluorobenzeneacetonitrile (5.0 g, 0.03 mol) in ethyl acetate (12 mL) was added dropwise. The reaction mixture was heated at 70° C. for 4 h and then allowed to cool to ambient temperature. The reaction mixture was poured into water (50 mL) and extracted with ethyl acetate (15 mL). The aqueous phase was acidified with aqueous hydrochloric acid solution (3 N) to pH 4 and extracted with ethyl acetate (100 mL). The organic phase was washed with water (25 mL) and saturated aqueous NaCl solution (25 mL), then dried over MgSO₄, filtered and concentrated under reduced pressure to provide the title compound as a semisolid (1.9 g).

¹H NMR (CDCl₃) δ 7.40 (m, 1H), 7.02 (m, 2H), 4.95 (s, 1H), 2.44 (s, 3H).

MS: 196 amu (AP+).

### Step B: Preparation of 4-(2,6-difluorophenyl)-1,3-dimethyl-1H-pyrazol-5-amine

To a mixture of α-acetyl-2,6-difluorobenzeneacetonitrile (i.e. the product of Step A) (1.9 g, 0.009 mol) and sodium acetate (2.6 g, 0.019 mol) in ethanol (18 mL) was added methylhydrazine sulfate (2.1 g, 0.014 mol). The reaction mixture was heated at reflux for 16 h, cooled, and then poured into water (100 mL). The resulting mixture was extracted with ethyl acetate (100 mL). The organic phase was washed with saturated aqueous NaCl solution (50 mL), dried over MgSO₄, filtered and concentrated under reduced pressure to provide the title compound as a pale yellow solid (2.1 g).

¹H NMR (CDCl₃) δ 7.27 (m, 2H), 6.98 (m, 1H), 3.72 (s, 3H), 2.13 (s, 3H).

MS: 224 amu (AP⁺).

### Step C: Preparation of 5-bromo-4-(2,6-difluorophenyl)-1,3-dimethyl-1H-pyrazole

To a mixture of 4-(2,6-difluorophenyl)-1,3-dimethyl-1H-pyrazol-5-amine (i.e. product of Step B) (2.1 g, 0.009 mol) in acetonitrile (50 mL) was added copper(II) bromide (2.3 g, 0.10 mol). The reaction mixture was cooled in an ice-water bath while tert-butyl nitrite (90% technical grade, 1.9 mL, 0.016 mol) was added dropwise over 5 minutes. The reaction mixture was allowed to slowly warm to ambient temperature. Aqueous hydrochloric acid solution (6 N, 20 mL) was added, followed by ethyl acetate (20 mL). The resulting mixture was filtered through a bed of Celite® (diatomaceous filter aid), rinsing with ethyl acetate (20 mL). The phases were separated, and the organic phase was washed with aqueous hydrochloric acid solution (1 N) and saturated aqueous NaCl solution, dried over MgSO₄, filtered and concentrated under reduced pressure to provide the title compound as an orange-brown semisolid (1.3 g).

¹H NMR (CDCl₃) δ 7.32 (m, 1H), 6.98 (m, 2H), 3.90 (s, 3H), 2.17 (s, 3H).

MS: 288 amu (AP⁺).

### Step D: Preparation of α-(2,4-difluorophenyl)-4-(2,6-difluorophenyl)-1,3-dimethyl-1H-pyrazol-5-methanol

5-Bromo-4-(2,6-difluorophenyl)-1,3-dimethyl-1H-pyrazole (i.e. the product of Step C) (0.6 g, 2.09 mmol) was dissolved in anhydrous tetrahydrofuran (5 mL) and cooled in a dry ice/acetone bath under a nitrogen atmosphere. A solution of n-butyllithium (2.5 M in cyclohexane, 1 mL, 2.50 mmol) was added dropwise over 5 minutes. After 15 minutes, a solution of 2,4-difluorobenzaldehyde (445 mg, 3.13 mmol) in anhydrous tetrahydrofuran (2 mL) was added dropwise. After 45 minutes, the reaction mixture was quenched with saturated aqueous NH₄Cl solution (about 20 mL) and allowed to warm to ambient temperature. The resulting mixture was extracted with ethyl acetate, and the organic phase was washed with saturated aqueous NH₄Cl solution (25 mL) and with saturated aqueous NaCl solution, dried over Na₂SO₄, filtered and concentrated under reduced pressure to a viscous residue. The residue was purified by column chromatography on silica gel eluting with ethyl acetate in hexane (gradient of 7% to 10%) to give the title compound as a white semi-solid (400 mg).

¹H NMR (CDCl₃) δ 7.38 (m, 1H), 7.31 (m, 1H), 6.94 (m, 2H), 6.83 (m, 1H), 6.25 (m, 1H), 5.88 (m, 1H), 3.81 (s, 3H), 3.29 (s, 3H).

MS: 350 amu.

### Step E: Preparation of 5-[chloro(2,4-difluorophenyl)methyl]-4-(2,6-difluorophenyl)-1,3-dimethyl-1H-pyrazole

α-(2,6-Difluorophenyl)-4-(2,6-difluorophenyl)-1,3-dimethyl-1H-pyrazol-5-methanol (i.e. the product of Step D) (220 mg, 0.63 mmol) was dissolved in dichloromethane (4 mL), and triethylamine (0.01 ml, 0.098 mmol) was added dropwise, followed by addition of thionyl chloride (0.005 mL, 0.078 mmol). The reaction mixture was stirred at ambient temperature for 2 h, then concentrated and partitioned between dichloromethane (5 mL) and water (5 mL). The organic phase was washed with water (5 mL) and with saturated aqueous NaCl solution (5 mL), dried over Na₂SO₄, filtered and concentrated under reduced pressure to give a viscous residue. This residue was purified by column chromatography on silica gel eluting with ethyl acetate in hexane (10%) to give the title compound as a white viscous oil (200 mg).

MS: 369 amu (AP⁺).

### Step F: Preparation of α-(2,4-difluorophenyl)-4-(2,6-difluorophenyl)-1,3-dimethyl-1H-pyrazol-5-methanamine

5-[Chloro(2,4-difluorophenyl)methyl]-4-(2,6-difluorophenyl)-1,3-dimethyl-1H-pyrazole (i.e. the product of Step E) (250 mg, 0.714 mmol) was dissolved in dichloromethane (5 mL) and aqueous ammonia solution (8 mL) was added. The reaction mixture was stirred at ambient temperature for 12 h and then refluxed for 3-4 h. The reaction mixture was concentrated under reduced pressure and the resultant residue was purified by column chromatography on silica gel eluting with ethyl acetate in hexane (10%) to give the title compound, a compound of the present invention, as a white viscous oil (120 mg).

¹H NMR (CDCl₃) δ 7.44 (m, 1H), 7.30 (m, 1H), 6.99 (m, 1H), 6.91 (m, 2H), 6.79 (m, 1H), 5.29 (s, 1H), 3.82 (s, 3H), 2.48 (m, 3H).

MS: 350 amu (AP⁺).

### Synthesis Example 2

### Preparation of α-(2,4-difluorophenyl)-4-(2,6-difluorophenyl)-N,1,3-trimethyl-1H-pyrazol-5-methanamine (Compound 2)

5-[Chloro(2,4-difluorophenyl)methyl]-4-(2,6-difluorophenyl)-1,3-dimethyl-1H-pyrazole (i.e. the product of Synthesis Example 1, Step E) (260 mg, 0.706 mmol) was dissolved in a solution of methylamine and methanol (20%, 10 mL) and heated at 85° C. for 18 h. The reaction mixture was concentrated under reduced pressure and the resulting residue was purified by column chromatography on silica gel eluting with ethyl acetate in hexane (10%) to give the title compound, a compound of the present invention, as a viscous oil (120 mg).

¹H NMR (CDCl₃) δ 7.25 (m, 1H), 6.86 (m, 2H), 6.70 (m, 2H), 5.46 (s, 1H), 3.86 (s, 3H), 3.39 (s, 3H), 2.08 (s, 3H).

MS: 364 amu (AP⁺).

### Synthesis Example 3

### Preparation of 4-(2,6-difluorophenyl)-5-[(2,4-difluorophenyl)(methylthio)methyl]-1,3-dimethyl-1H-pyrazole (Compound 4)

To a mixture of 5-[chloro(2,4-difluorophenyl)methyl]-4-(2,6-difluorophenyl)-1,3-dimethyl-1H-pyrazole (i.e. the product of Synthesis Example 1, Step E) (86 mg, 0.23 mmol) in methanol (5 mL) was added sodium thiomethoxide (19.62 mg, 0.28 mmol). The reaction mixture was stirred at ambient temperature for 18 h. The reaction mixture was concentrated under reduced pressure and the resulting residue was purified by column chromatography on silica gel eluting with ethyl acetate in hexane (10%) to give the title compound, a compound of the present invention, as a viscous oil (43 mg).

¹H NMR (CDCl₃) δ 7.21 (m, 2H), 6.85 (m, 2H), 6.70 (m, 2H), 5.46 (s, 1H), 3.85 (s, 3H), 3.39 (s, 3H), 2.08 (s, 3H).

MS: 381 amu (AP⁺).

By the procedures described herein together with methods known in the art, the compounds disclosed in the Tables that follow can be prepared. The following abbreviations are used in the Table which follows: Me means methyl, Et means ethyl, MeO means methoxy, EtO means ethoxy, CN means cyano, Ph means phenyl, Py means pyridinyl and Th means thiophene.

TABLE 1 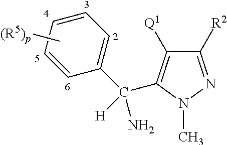
Q¹ is 2,6-di-F—Ph, and R² is Me.
(R⁵)ₚ
2-F
4-Cl
2,6-di-F
2-Cl-4-F
2-Br-4-F
2-Br-4-MeO
2,6-di-F-4-CN
4-Cl-2,5-di-F
2,6-di-Cl-4-F
2-F-4-Br
3-F
2-Br
2,4,6-tri-F
2-F-4-Cl
2-I-4-F
2,6-di-F-4-MeO
2-Cl-4,5-di-F
4-Cl-2,6-di-F
2,6-di-Cl-4-MeO
2-Cl-4-Br
4-F
3-Br
2,4,5-tri-F
2,4-di-Cl
2-Me-4-F
2-F-4-CN
2-Cl-4,6-di-F
4-Br-2,5-di-F
2-CF₃-4-F
2-Br-4-Cl
2-Cl
4-Br
2,3,5-tri-F
2,6-di-Cl
2-F-4-MeO
2-Cl-4-CN
2-Br-4,5-di-F
4-Br-2,6-di-F
4-Me
2-Br-4-F-6-Cl
3-Cl
2,4-di-F
2,3,6-tri-F
2,4,6-tri-Cl
2-Cl-4-MeO
2-Br-4-CN
2-Br-4,6-di-F
2,4-di-Cl-6-F
2,4-di-Me
2-Cl-4-Br-6-F

The present disclosure also includes Tables 2 through 96, each of which is constructed the same as Table 1 above, except that the row heading in Table 1 (i.e. “Q¹ is 2,6-di-F-Ph, and R² is Me”) is replaced with the respective row headings shown below. For example, in Table 2 the row heading is “Q¹ is 2,6-di-F-Ph, and R² is Cl” and (R⁵)ₚ is as defined in Table 1 above. Thus, the first entry in Table 2 specifically discloses 3-chloro-α-(2-fluorophenyl)-4-(2,6-difluorophenyl)-1-methyl-1H-pyrazol-5-methanamine. Tables 3 through 96 are constructed similarly.

| Table | Row Heading |
|---|---|
| 2 | Q¹ is 2,6-di-F—Ph, and R² is Cl. |
| 3 | Q¹ is 2,6-di-F—Ph, and R² is Br. |
| 4 | Q¹ is 2,4-di-F—Ph, and R² is Me. |
| 5 | Q¹ is 2,4-di-F—Ph, and R² is Cl. |
| 6 | Q¹ is 2,4-di-F—Ph, and R² is Br. |
| 7 | Q¹ is 2,4,6-tri-F—Ph, and R² is Me. |
| 8 | Q¹ is 2,4,6-tri-F—Ph, and R² is Cl. |
| 9 | Q¹ is 2,4,6-tri-F—Ph, and R² is Br. |
| 10 | Q¹ is 2,6-di-F-4-MeO—Ph, and R² is Me. |
| 11 | Q¹ is 2,6-di-F-4-MeO—Ph, and R² is Cl. |
| 12 | Q¹ is 2,6-di-F-4-MeO—Ph, and R² is Br. |
| 13 | Q¹ is 2,6-di-F-4-EtO—Ph, and R² is Me. |
| 14 | Q¹ is 2,6-di-F-4-EtO—Ph, and R² is Cl. |
| 15 | Q¹ is 2,6-di-F-4-EtO—Ph, and R² is Br. |
| 16 | Q¹ is 2,6-di-F-4-CN—Ph, and R² is Me. |
| 17 | Q¹ is 2,6-di-F-4-CN—Ph, and R² is Cl. |
| 18 | Q¹ is 2,6-di-F-4-CN—Ph, and R² is Br. |
| 19 | Q¹ is 2-Cl-4-F—Ph, and R² is Me. |
| 20 | Q¹ is 2-Cl-4-F—Ph, and R² is Cl. |
| 21 | Q¹ is 2-Cl-4-F—Ph, and R² is Br. |
| 22 | Q¹ is 2-Cl-6-F—Ph, and R² is Me. |
| 23 | Q¹ is 2-Cl-6-F—Ph, and R² is Cl. |
| 24 | Q¹ is 2-Cl-6-F—Ph, and R² is Br. |
| 25 | Q¹ is 2-Cl-4,6-di-F—Ph, and R² is Me. |
| 26 | Q¹ is 2-Cl-4,6-di-F—Ph, and R² is Cl. |
| 27 | Q¹ is 2-Cl-4,6-di-F—Ph, and R² is Br. |
| 28 | Q¹ is 4-Cl-2,6-di-F—Ph, and R² is Me. |
| 29 | Q¹ is 4-Cl-2,6-di-F—Ph, and R² is Cl. |
| 30 | Q¹ is 4-Cl-2,6-di-F—Ph, and R² is Br. |
| 31 | Q¹ is 2-Br-4-F—Ph, and R² is Me. |
| 32 | Q¹ is 2-Br-4-F—Ph, and R² is Cl. |
| 33 | Q¹ is 2-Br-4-F—Ph, and R² is Br. |
| 34 | Q¹ is 2-Br-6-F—Ph, and R² is Me. |
| 35 | Q¹ is 2-Br-6-F—Ph, and R² is Cl. |
| 36 | Q¹ is 2-Br-6-F—Ph, and R² is Br. |
| 37 | Q¹ is 2-Me-4-F—Ph, and R² is Me. |
| 38 | Q¹ is 2-Me-4-F—Ph, and R² is Cl. |
| 39 | Q¹ is 2-Me-4-F—Ph, and R² is Br. |
| 40 | Q¹ is 2-I-4-F—Ph, and R² is Me. |
| 41 | Q¹ is 2-I-4-F—Ph, and R² is Cl. |
| 42 | Q¹ is 2-I-4-F—Ph, and R² is Br. |
| 43 | Q¹ is 2-F—Ph, and R² is Me. |
| 44 | Q¹ is 2-F—Ph, and R² is Cl. |
| 45 | Q¹ is 2-F—Ph, and R² is Br. |
| 46 | Q¹ is 2-Cl—Ph, and R² is Me. |
| 47 | Q¹ is 2-Cl—Ph, and R² is Cl. |
| 48 | Q¹ is 2-Cl—Ph, and R² is Br. |
| 49 | Q¹ is 2-Br—Ph, and R² is Me. |
| 50 | Q¹ is 2-Br—Ph, and R² is Cl. |
| 51 | Q¹ is 2-Br—Ph, and R² is Br. |
| 52 | Q¹ is 2-F-4-Cl—Ph, and R² is Me. |
| 53 | Q¹ is 2-F-4-Cl—Ph, and R² is Cl. |
| 54 | Q¹ is 2-F-4-Cl—Ph, and R² is Br. |
| 55 | Q¹ is 2,4-di-Cl—Ph, and R² is Me. |
| 56 | Q¹ is 2,4-di-Cl—Ph, and R² is Cl. |
| 57 | Q¹ is 2,4-di-Cl—Ph, and R² is Br. |
| 58 | Q¹ is 2,6-di-Cl—Ph, and R² is Me. |
| 59 | Q¹ is 2,6-di-Cl—Ph, and R² is Cl. |
| 60 | Q¹ is 2,6-di-Cl—Ph, and R² is Br. |
| 61 | Q¹ is 2-F-4-MeO—Ph, and R² is Me. |
| 62 | Q¹ is 2-F-4-MeO—Ph, and R² is Cl. |
| 63 | Q¹ is 2-F-4-MeO—Ph, and R² is Br. |
| 64 | Q¹ is 2-F-4-EtO—Ph, and R² is Me. |
| 65 | Q¹ is 2-F-4-EtO—Ph, and R² is Cl. |
| 66 | Q¹ is 2-F-4-EtO—Ph, and R² is Br. |
| 67 | Q¹ is 2-Cl-4-MeO—Ph, and R² is Me. |
| 68 | Q¹ is 2-Cl-4-MeO—Ph, and R² is Cl. |
| 69 | Q¹ is 2-Cl-4-MeO—Ph, and R² is Br. |
| 70 | Q¹ is 2-Cl-4-EtO—Ph, and R² is Me. |
| 71 | Q¹ is 2-Cl-4-EtO—Ph, and R² is Cl. |
| 72 | Q¹ is 2-Cl-4-EtO—Ph, and R² is Br. |
| 73 | Q¹ is 2-Br-4-MeO—Ph, and R² is Me. |
| 74 | Q¹ is 2-Br-4-MeO—Ph, and R² is Cl. |
| 75 | Q¹ is 2-Br-4-MeO—Ph, and R² is Br. |
| 76 | Q¹ is 2-Br-4-EtO—Ph, and R² is Me. |
| 77 | Q¹ is 2-Br-4-EtO—Ph, and R² is Cl. |
| 78 | Q¹ is 2-Br-4-EtO—Ph, and R² is Br. |
| 79 | Q¹ is 2-F-4-CN—Ph, and R² is Me. |
| 80 | Q¹ is 2-F-4-CN—Ph, and R² is Cl. |
| 81 | Q¹ is 2-F-4-CN—Ph, and R² is Br. |
| 82 | Q¹ is 2-Cl-4-CN—Ph, and R² is Me. |
| 83 | Q¹ is 2-Cl-4-CN—Ph, and R² is Cl. |
| 84 | Q¹ is 2-Cl-4-CN—Ph, and R² is Br. |
| 85 | Q¹ is 2-Br-4-CN—Ph, and R² is Me. |
| 86 | Q¹ is 2-Br-4-CN—Ph, and R² is Cl. |
| 87 | Q¹ is 2-Br-4-CN—Ph, and R² is Br. |
| 88 | Q¹ is 2,5-di-Cl-3-Py, and R² is Me. |
| 89 | Q¹ is 2,5-di-Cl-3-Py, and R² is Cl. |
| 90 | Q¹ is 2,5-di-Cl-3-Py, and R² is Br. |
| 91 | Q¹ is 2-Cl-3-Th, and R² is Me. |
| 92 | Q¹ is 2-Cl-3-Th, and R² is Cl. |
| 93 | Q¹ is 2-Cl-3-Th, and R² is Br. |
| 94 | Q¹ is 2,5-di-Cl-3-Th, and R² is Me. |
| 95 | Q¹ is 2,5-di-Cl-3-Th, and R² is Cl. |
| 96 | Q¹ is 2,5-di-Cl-3-Th, and R² is Br. |

TABLE 97 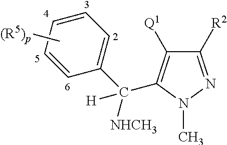
Q¹ is 2,6-di-F—Ph, and R² is Me.
(R⁵)ₚ
2-F
4-Cl
2,6-di-F
2-Cl-4-F
2-Br-4-F
2-Br-4-MeO
2,6-di-F-4-CN
4-Cl-2,5-di-F
2,6-di-Cl-4-F
2-F-4-Br
3-F
2-Br
2,4,6-tri-F
2-F-4-Cl
2-I-4-F
2,6-di-F-4-MeO
2-Cl-4,5-di-F
4-Cl-2,6-di-F
2,6-di-Cl-4-MeO
2-Cl-4-Br
4-F
3-Br
2,4,5-tri-F
2,4-di-Cl
2-Me-4-F
2-F-4-CN
2-Cl-4,6-di-F
4-Br-2,5-di-F
2-CF₃-4-F
2-Br-4-Cl
2-Cl
4-Br
2,3,5-tri-F
2,6-di-Cl
2-F-4-MeO
2-Cl-4-CN
2-Br-4,5-di-F
4-Br-2,6-di-F
4-Me
2-Br-4-F-6-Cl
3-Cl
2,4-di-F
2,3,6-tri-F
2,4,6-tri-Cl
2-Cl-4-MeO
2-Br-4-CN
2-Br-4,6-di-F
2,4-di-Me
2-Cl-4-Br-6-F

The present disclosure also includes Tables 98 through 192, each of which is constructed the same as Table 97 above, except that the row heading in Table 97 (i.e. “Q¹ is 2,6-di-F-Ph, and R² is Me”) is replaced with the respective row headings shown below. For example, in Table 98 the row heading is “Q¹ is 2,6-di-F-Ph, and R² is Cl”, and (R⁵)ₚ is as defined in Table 97 above. Thus, the first entry in Table 98 specifically discloses 3-chloro-α-(2,4-difluorophenyl)-4-(2,6-difluorophenyl)-N,1-dimethyl-1H-pyrazol-5-methanamine. Tables 99 through 192 are constructed similarly.

| Table | Row Heading |
|---|---|
| 98 | Q¹ is 2,6-di-F—Ph, and R² is Cl. |
| 99 | Q¹ is 2,6-di-F—Ph, and R² is Br. |
| 100 | Q¹ is 2,4-di-F—Ph, and R² is Me. |
| 101 | Q¹ is 2,4-di-F—Ph, and R² is Cl. |
| 102 | Q¹ is 2,4-di-F—Ph, and R² is Br. |
| 103 | Q¹ is 2,4,6-tri-F—Ph, and R² is Me. |
| 104 | Q¹ is 2,4,6-tri-F—Ph, and R² is Cl. |
| 105 | Q¹ is 2,4,6-tri-F—Ph, and R² is Br. |
| 106 | Q¹ is 2,6-di-F-4-MeO—Ph, and R² is Me. |
| 107 | Q¹ is 2,6-di-F-4-MeO—Ph, and R² is Cl. |
| 108 | Q¹ is 2,6-di-F-4-MeO—Ph, and R² is Br. |
| 109 | Q¹ is 2,6-di-F-4-EtO—Ph, and R² is Me. |
| 110 | Q¹ is 2,6-di-F-4-EtO—Ph, and R² is Cl. |
| 111 | Q¹ is 2,6-di-F-4-EtO—Ph, and R² is Br. |
| 112 | Q¹ is 2,6-di-F-4-CN—Ph, and R² is Me. |
| 113 | Q¹ is 2,6-di-F-4-CN—Ph, and R² is Cl. |
| 114 | Q¹ is 2,6-di-F-4-CN—Ph, and R² is Br. |
| 115 | Q¹ is 2-Cl-4-F—Ph, and R² is Me. |
| 116 | Q¹ is 2-Cl-4-F—Ph, and R² is Cl. |
| 117 | Q¹ is 2-Cl-4-F—Ph, and R² is Br. |
| 118 | Q¹ is 2-Cl-6-F—Ph, and R² is Me. |
| 119 | Q¹ is 2-Cl-6-F—Ph, and R² is Cl. |
| 120 | Q¹ is 2-Cl-6-F—Ph, and R² is Br. |
| 121 | Q¹ is 2-Cl-4,6-di-F—Ph, and R² is Me. |
| 122 | Q¹ is 2-Cl-4,6-di-F—Ph, and R² is Cl. |
| 123 | Q¹ is 2-Cl-4,6-di-F—Ph, and R² is Br. |
| 124 | Q¹ is 4-Cl-2,6-di-F—Ph, and R² is Me. |
| 125 | Q¹ is 4-Cl-2,6-di-F—Ph, and R² is Cl. |
| 126 | Q¹ is 4-Cl-2,6-di-F—Ph, and R² is Br. |
| 127 | Q¹ is 2-Br-4-F—Ph, and R² is Me. |
| 128 | Q¹ is 2-Br-4-F—Ph, and R² is Cl. |
| 129 | Q¹ is 2-Br-4-F—Ph, and R² is Br. |
| 130 | Q¹ is 2-Br-6-F—Ph, and R² is Me. |
| 131 | Q¹ is 2-Br-6-F—Ph, and R² is Cl. |
| 132 | Q¹ is 2-Br-6-F—Ph, and R² is Br. |
| 133 | Q¹ is 2-Me-4-F—Ph, and R² is Me. |
| 134 | Q¹ is 2-Me-4-F—Ph, and R² is Cl. |
| 135 | Q¹ is 2-Me-4-F—Ph, and R² is Br. |
| 136 | Q¹ is 2-I-4-F—Ph, and R² is Me. |
| 137 | Q¹ is 2-I-4-F—Ph, and R² is Cl. |
| 138 | Q¹ is 2-I-4-F—Ph, and R² is Br. |
| 139 | Q¹ is 2-F—Ph, and R² is Me. |
| 140 | Q¹ is 2-F—Ph, and R² is Cl. |
| 141 | Q¹ is 2-F—Ph, and R² is Br. |
| 142 | Q¹ is 2-Cl—Ph, and R² is Me. |
| 143 | Q¹ is 2-Cl—Ph, and R² is Cl. |
| 144 | Q¹ is 2-Cl—Ph, and R² is Br. |
| 145 | Q¹ is 2-Br—Ph, and R² is Me. |
| 146 | Q¹ is 2-Br—Ph, and R² is Cl. |
| 147 | Q¹ is 2-Br—Ph, and R² is Br. |
| 148 | Q¹ is 2-F-4-Cl—Ph, and R² is Me. |
| 149 | Q¹ is 2-F-4-Cl—Ph, and R² is Cl. |
| 150 | Q¹ is 2-F-4-Cl—Ph, and R² is Br. |
| 151 | Q¹ is 2,4-di-Cl—Ph, and R² is Me. |
| 152 | Q¹ is 2,4-di-Cl—Ph, and R² is Cl. |
| 153 | Q¹ is 2,4-di-Cl—Ph, and R² is Br. |
| 154 | Q¹ is 2,6-di-Cl—Ph, and R² is Me. |
| 155 | Q¹ is 2,6-di-Cl—Ph, and R² is Cl. |
| 156 | Q¹ is 2,6-di-Cl—Ph, and R² is Br. |
| 157 | Q¹ is 2-F-4-MeO—Ph, and R² is Me. |
| 158 | Q¹ is 2-F-4-MeO—Ph, and R² is Cl. |
| 159 | Q¹ is 2-F-4-MeO—Ph, and R² is Br. |
| 160 | Q¹ is 2-F-4-EtO—Ph, and R² is Me. |
| 161 | Q¹ is 2-F-4-EtO—Ph, and R² is Cl. |
| 162 | Q¹ is 2-F-4-EtO—Ph, and R² is Br. |
| 163 | Q¹ is 2-Cl-4-MeO—Ph, and R² is Me. |
| 164 | Q¹ is 2-Cl-4-MeO—Ph, and R² is Cl. |
| 165 | Q¹ is 2-Cl-4-MeO—Ph, and R² is Br. |
| 166 | Q¹ is 2-Cl-4-EtO—Ph, and R² is Me. |
| 167 | Q¹ is 2-Cl-4-EtO—Ph, and R² is Cl. |
| 168 | Q¹ is 2-Cl-4-EtO—Ph, and R² is Br. |
| 169 | Q¹ is 2-Br-4-MeO—Ph, and R² is Me. |
| 170 | Q¹ is 2-Br-4-MeO—Ph, and R² is Cl. |
| 171 | Q¹ is 2-Br-4-MeO—Ph, and R² is Br. |
| 172 | Q¹ is 2-Br-4-EtO—Ph, and R² is Me. |
| 173 | Q¹ is 2-Br-4-EtO—Ph, and R² is Cl. |
| 174 | Q¹ is 2-Br-4-EtO—Ph, and R² is Br. |
| 175 | Q¹ is 2-F-4-CN—Ph, and R² is Me. |
| 176 | Q¹ is 2-F-4-CN—Ph, and R² is Cl. |
| 177 | Q¹ is 2-F-4-CN—Ph, and R² is Br. |
| 178 | Q¹ is 2-Cl-4-CN—Ph, and R² is Me. |
| 179 | Q¹ is 2-Cl-4-CN—Ph, and R² is Cl. |
| 180 | Q¹ is 2-Cl-4-CN—Ph, and R² is Br. |
| 181 | Q¹ is 2-Br-4-CN—Ph, and R² is Me. |
| 182 | Q¹ is 2-Br-4-CN—Ph, and R² is Cl. |
| 183 | Q¹ is 2-Br-4-CN—Ph, and R² is Br. |
| 184 | Q¹ is 2,5-di-Cl-3-Py, and R² is Me. |
| 185 | Q¹ is 2,5-di-Cl-3-Py, and R² is Cl. |
| 186 | Q¹ is 2,5-di-Cl-3-Py, and R² is Br. |
| 187 | Q¹ is 2-Cl-3-Th, and R² is Me. |
| 188 | Q¹ is 2-Cl-3-Th, and R² is Cl. |
| 189 | Q¹ is 2-Cl-3-Th, and R² is Br. |
| 190 | Q¹ is 2,5-di-Cl-3-Th, and R² is Me. |
| 191 | Q¹ is 2,5-di-Cl-3-Th, and R² is Cl. |
| 192 | Q¹ is 2,5-di-Cl-3-Th, and R² is Br. |

TABLE 193 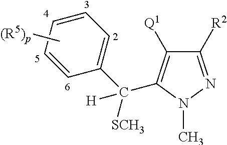
Q¹ is 2,6-di-F—Ph, and R² is Me.
(R⁵)ₚ
2-F
4-Cl
2,6-di-F
2-Cl-4-F
2-Br-4-F
2-Br-4-MeO
2,6-di-F-4-CN
4-Cl-2,5-di-F
2,6-di-Cl-4-F
2-F-4-Br
3-F
2-Br
2,4,6-tri-F
2-F-4-Cl
2-I-4-F
2,6-di-F-4-MeO
2-Cl-4,5-di-F
4-Cl-2,6-di-F
2,6-di-Cl-4-MeO
2-Cl-4-Br
4-F
3-Br
2,4,5-tri-F
2,4-di-Cl
2-Me-4-F
2-F-4-CN
2-Cl-4,6-di-F
4-Br-2,5-di-F
2-CF3-4-F
2-Br-4-Cl
2-Cl
4-Br
2,3,5-tri-F
2,6-di-Cl
2-F-4-MeO
2-Cl-4-CN
2-Br-4,5-di-F
4-Br-2,6-di-F
4-Me
2-Br-4-F-6-Cl
3-Cl
2,4-di-F
2,3,6-tri-F
2,4,6-tri-Cl
2-Cl-4-MeO
2-Br-4-CN
2-Br-4,6-di-F
2,4-di-Cl-6-F
2,4-di-Me
2-Cl-4-Br-6-F

The present disclosure also includes Tables 194 through 288, each of which is constructed the same as Table 193 above, except that the row heading in Table 193 (i.e. “Q¹ is 2,6-di-F-Ph, and R² is Me”) is replaced with the respective row heading shown below. For example, in Table 194 the row heading is “Q¹ is 2,6-di-F-Ph, and R² is Cl”, and (R⁵)ₚ is as defined in Table 193 above. Thus, the first entry in Table 194 specifically discloses 3-chloro-4-(2,6-difluorophenyl)-5-[(2-fluorophenyl)(methylthio)methyl]-1-methyl-1H-pyrazole. Tables 195 through 288 are constructed similarly.

| Table | Row Heading |
|---|---|
| 194 | Q¹ is 2,6-di-F—Ph, and R² is Cl. |
| 195 | Q¹ is 2,6-di-F—Ph, and R² is Br. |
| 196 | Q¹ is 2,4-di-F—Ph, and R² is Me. |
| 197 | Q¹ is 2,4-di-F—Ph, and R² is Cl. |
| 198 | Q¹ is 2,4-di-F—Ph, and R² is Br. |
| 199 | Q¹ is 2,4,6-tri-F—Ph, and R² is Me. |
| 200 | Q¹ is 2,4,6-tri-F—Ph, and R² is Cl. |
| 201 | Q¹ is 2,4,6-tri-F—Ph, and R² is Br. |
| 202 | Q¹ is 2,6-di-F-4-MeO—Ph, and R² is Me. |
| 203 | Q¹ is 2,6-di-F-4-MeO—Ph, and R² is Cl. |
| 204 | Q¹ is 2,6-di-F-4-MeO—Ph, and R² is Br. |
| 205 | Q¹ is 2,6-di-F-4-EtO—Ph, and R² is Me. |
| 206 | Q¹ is 2,6-di-F-4-EtO—Ph, and R² is Cl. |
| 207 | Q¹ is 2,6-di-F-4-EtO—Ph, and R² is Br. |
| 208 | Q¹ is 2,6-di-F-4-CN—Ph, and R² is Me. |
| 209 | Q¹ is 2,6-di-F-4-CN—Ph, and R² is Cl. |
| 210 | Q¹ is 2,6-di-F-4-CN—Ph, and R² is Br. |
| 211 | Q¹ is 2-Cl-4-F—Ph, and R² is Me. |
| 212 | Q¹ is 2-Cl-4-F—Ph, and R² is Cl. |
| 213 | Q¹ is 2-Cl-4-F—Ph, and R² is Br. |
| 214 | Q¹ is 2-Cl-6-F—Ph, and R² is Me. |
| 215 | Q¹ is 2-Cl-6-F—Ph, and R² is Cl. |
| 216 | Q¹ is 2-Cl-6-F—Ph, and R² is Br. |
| 217 | Q¹ is 2-Cl-4,6-di-F—Ph, and R² is Me. |
| 218 | Q¹ is 2-Cl-4,6-di-F—Ph, and R² is Cl. |
| 219 | Q¹ is 2-Cl-4,6-di-F—Ph, and R² is Br. |
| 220 | Q¹ is 4-Cl-2,6-di-F—Ph, and R² is Me. |
| 221 | Q¹ is 4-Cl-2,6-di-F—Ph, and R² is Cl. |
| 222 | Q¹ is 4-Cl-2,6-di-F—Ph, and R² is Br. |
| 223 | Q¹ is 2-Br-4-F—Ph, and R² is Me. |
| 224 | Q¹ is 2-Br-4-F—Ph, and R² is Cl. |
| 225 | Q¹ is 2-Br-4-F—Ph, and R² is Br. |
| 226 | Q¹ is 2-Br-6-F—Ph, and R² is Me. |
| 227 | Q¹ is 2-Br-6-F—Ph, and R² is Cl. |
| 228 | Q¹ is 2-Br-6-F—Ph, and R² is Br. |
| 229 | Q¹ is 2-Me-4-F—Ph, and R² is Me. |
| 230 | Q¹ is 2-Me-4-F—Ph, and R² is Cl. |
| 231 | Q¹ is 2-Me-4-F—Ph, and R² is Br. |
| 232 | Q¹ is 2-I-4-F—Ph, and R² is Me. |
| 233 | Q¹ is 2-I-4-F—Ph, and R² is Cl. |
| 234 | Q¹ is 2-I-4-F—Ph, and R² is Br. |
| 235 | Q¹ is 2-F—Ph, and R² is Me. |
| 236 | Q¹ is 2-F—Ph, and R² is Cl. |
| 237 | Q¹ is 2-F—Ph, and R² is Br. |
| 238 | Q¹ is 2-Cl—Ph, and R² is Me. |
| 239 | Q¹ is 2-Cl—Ph, and R² is Cl. |
| 240 | Q¹ is 2-Cl—Ph, and R² is Br. |
| 241 | Q¹ is 2-Br—Ph, and R² is Me. |
| 242 | Q¹ is 2-Br—Ph, and R² is Cl. |
| 243 | Q¹ is 2-Br—Ph, and R² is Br. |
| 244 | Q¹ is 2-F-4-Cl—Ph, and R² is Me. |
| 245 | Q¹ is 2-F-4-Cl—Ph, and R² is Cl. |
| 246 | Q¹ is 2-F-4-Cl—Ph, and R² is Br. |
| 247 | Q¹ is 2,4-di-Cl—Ph, and R² is Me. |
| 248 | Q¹ is 2,4-di-Cl—Ph, and R² is Cl. |
| 249 | Q¹ is 2,4-di-Cl—Ph, and R² is Br. |
| 250 | Q¹ is 2,6-di-Cl—Ph, and R² is Me. |
| 251 | Q¹ is 2,6-di-Cl—Ph, and R² is Cl. |
| 252 | Q¹ is 2,6-di-Cl—Ph, and R² is Br. |
| 253 | Q¹ is 2-F-4-MeO—Ph, and R² is Me. |
| 254 | Q¹ is 2-F-4-MeO—Ph, and R² is Cl. |
| 255 | Q¹ is 2-F-4-MeO—Ph, and R² is Br. |
| 256 | Q¹ is 2-F-4-EtO—Ph, and R² is Me. |
| 257 | Q¹ is 2-F-4-EtO—Ph, and R² is Cl. |
| 258 | Q¹ is 2-F-4-EtO—Ph, and R² is Br. |
| 259 | Q¹ is 2-Cl-4-MeO—Ph, and R² is Me. |
| 260 | Q¹ is 2-Cl-4-MeO—Ph, and R² is Cl. |
| 261 | Q¹ is 2-Cl-4-MeO—Ph, and R² is Br. |
| 262 | Q¹ is 2-Cl-4-EtO—Ph, and R² is Me. |
| 263 | Q¹ is 2-Cl-4-EtO—Ph, and R² is Cl. |
| 264 | Q¹ is 2-Cl-4-EtO—Ph, and R² is Br. |
| 265 | Q¹ is 2-Br-4-MeO—Ph, and R² is Me. |
| 266 | Q¹ is 2-Br-4-MeO—Ph, and R² is Cl. |
| 267 | Q¹ is 2-Br-4-MeO—Ph, and R² is Br. |
| 268 | Q¹ is 2-Br-4-EtO—Ph, and R² is Me. |
| 269 | Q¹ is 2-Br-4-EtO—Ph, and R² is Cl. |
| 270 | Q¹ is 2-Br-4-EtO—Ph, and R² is Br. |
| 271 | Q¹ is 2-F-4-CN—Ph, and R² is Me. |
| 272 | Q¹ is 2-F-4-CN—Ph, and R² is Cl. |
| 273 | Q¹ is 2-F-4-CN—Ph, and R² is Br. |
| 274 | Q¹ is 2-Cl-4-CN—Ph, and R² is Me. |
| 275 | Q¹ is 2-Cl-4-CN—Ph, and R² is Cl. |
| 276 | Q¹ is 2-Cl-4-CN—Ph, and R² is Br. |
| 277 | Q¹ is 2-Br-4-CN—Ph, and R² is Me. |
| 278 | Q¹ is 2-Br-4-CN—Ph, and R² is Cl. |
| 279 | Q¹ is 2-Br-4-CN—Ph, and R² is Br. |
| 280 | Q¹ is 2,5-di-Cl-3-Py, and R² is Me. |
| 281 | Q¹ is 2,5-di-Cl-3-Py, and R² is Cl. |
| 282 | Q¹ is 2,5-di-Cl-3-Py, and R² is Br. |
| 283 | Q¹ is 2-Cl-3-Th, and R² is Me. |
| 284 | Q¹ is 2-Cl-3-Th, and R² is Cl. |
| 285 | Q¹ is 2-Cl-3-Th, and R² is Br. |
| 286 | Q¹ is 2,5-di-Cl-3-Th, and R² is Me. |
| 287 | Q¹ is 2,5-di-Cl-3-Th, and R² is Cl. |
| 288 | Q¹ is 2,5-di-Cl-3-Th, and R² is Br. |

### Formulation/Utility

A compound of Formula 1 of this invention (including N-oxides and salts thereof) will generally be used as a fungicidal active ingredient in a composition, i.e. formulation, with at least one additional component selected from the group consisting of surfactants, solid diluents and liquid diluents, which serve as a carrier. The formulation or composition ingredients are selected to be consistent with the physical properties of the active ingredient, mode of application and environmental factors such as soil type, moisture and temperature.

Useful formulations include both liquid and solid compositions. Liquid compositions include solutions (including emulsifiable concentrates), suspensions, emulsions (including microemulsions and/or suspoemulsions) and the like, which optionally can be thickened into gels. The general types of aqueous liquid compositions are soluble concentrate, suspension concentrate, capsule suspension, concentrated emulsion, microemulsion and suspo-emulsion. The general types of nonaqueous liquid compositions are emulsifiable concentrate, microemulsifiable concentrate, dispersible concentrate and oil dispersion.

The general types of solid compositions are dusts, powders, granules, pellets, prills, pastilles, tablets, filled films (including seed coatings) and the like, which can be water-dispersible (“wettable”) or water-soluble. Films and coatings formed from film-forming solutions or flowable suspensions are particularly useful for seed treatment. Active ingredient can be (micro)encapsulated and further formed into a suspension or solid formulation; alternatively the entire formulation of active ingredient can be encapsulated (or “overcoated”). Encapsulation can control or delay release of the active ingredient. An emulsifiable granule combines the advantages of both an emulsifiable concentrate formulation and a dry granular formulation. High-strength compositions are primarily used as intermediates for further formulation.

Sprayable formulations are typically extended in a suitable medium before spraying. Such liquid and solid formulations are formulated to be readily diluted in the spray medium, usually water. Spray volumes can range from about one to several thousand liters per hectare, but more typically are in the range from about ten to several hundred liters per hectare. Sprayable formulations can be tank mixed with water or another suitable medium for foliar treatment by aerial or ground application, or for application to the growing medium of the plant. Liquid and dry formulations can be metered directly into drip irrigation systems or metered into the furrow during planting. Liquid and solid formulations can be applied onto seeds of crops and other desirable vegetation as seed treatments before planting to protect developing roots and other subterranean plant parts and/or foliage through systemic uptake.

The formulations will typically contain effective amounts of active ingredient, diluent and surfactant within the following approximate ranges which add up to 100 percent by weight.

| | Weight Percent | | |
|---|---|---|---|
| | Active | | |
| | Ingredient | Diluent | Surfactant |
| Water-Dispersible and Water- | 0.001-90 | 0-99.999 | 0-15 |
| soluble Granules, Tablets and | | | |
| Powders | | | |
| Oil Dispersions, Suspensions, | 1-50 | 40-99 | 0-50 |
| Emulsions, Solutions | | | |
| (including Emulsifiable | | | |
| Concentrates) | | | |
| Dusts | 1-25 | 70-99 | 0-5 |
| Granules and Pellets | 0.001-95 | 5-99.999 | 0-15 |
| High Strength Compositions | 90-99 | 0-10 | 0-2 |

Solid diluents include, for example, clays such as bentonite, montmorillonite, attapulgite and kaolin, gypsum, cellulose, titanium dioxide, zinc oxide, starch, dextrin, sugars (e.g., lactose, sucrose), silica, talc, mica, diatomaceous earth, urea, calcium carbonate, sodium carbonate and bicarbonate, and sodium sulfate. Typical solid diluents are described in Watkins et al., Handbook of Insecticide Dust Diluents and Carriers, 2nd Ed., Dorland Books, Caldwell, N.J.

Liquid diluents include, for example, water, N,N-dimethylalkanamides (e.g., N,N-dimethylformamide), limonene, dimethyl sulfoxide, N-alkylpyrrolidones (e.g., N-methylpyrrolidinone), ethylene glycol, triethylene glycol, propylene glycol, dipropylene glycol, polypropylene glycol, propylene carbonate, butylene carbonate, paraffins (e.g., white mineral oils, normal paraffins, isoparaffins), alkylbenzenes, alkylnaphthalenes, glycerine, glycerol triacetate, sorbitol, aromatic hydrocarbons, dearomatized aliphatics, alkylbenzenes, alkylnaphthalenes, ketones such as cyclohexanone, 2-heptanone, isophorone and 4-hydroxy-4-methyl-2-pentanone, acetates such as isoamyl acetate, hexyl acetate, heptyl acetate, octyl acetate, nonyl acetate, tridecyl acetate and isobornyl acetate, other esters such as alkylated lactate esters, dibasic esters and γ-butyrolactone, and alcohols, which can be linear, branched, saturated or unsaturated, such as methanol, ethanol, n-propanol, isopropyl alcohol, n-butanol, isobutyl alcohol, n-hexanol, 2-ethylhexanol, n-octanol, decanol, isodecyl alcohol, isooctadecanol, cetyl alcohol, lauryl alcohol, tridecyl alcohol, oleyl alcohol, cyclohexanol, tetrahydrofurfuryl alcohol, diacetone alcohol and benzyl alcohol. Liquid diluents also include glycerol esters of saturated and unsaturated fatty acids (typically C₆-C₂₂), such as plant seed and fruit oils (e.g., oils of olive, castor, linseed, sesame, corn (maize), peanut, sunflower, grapeseed, safflower, cottonseed, soybean, rapeseed, coconut and palm kernel), animal-sourced fats (e.g., beef tallow, pork tallow, lard, cod liver oil, fish oil), and mixtures thereof. Liquid diluents also include alkylated fatty acids (e.g., methylated, ethylated, butylated) wherein the fatty acids may be obtained by hydrolysis of glycerol esters from plant and animal sources, and can be purified by distillation. Typical liquid diluents are described in Marsden, Solvents Guide, 2nd Ed., Interscience, New York, 1950.

The solid and liquid compositions of the present invention often include one or more surfactants. When added to a liquid, surfactants (also known as “surface-active agents”) generally modify, most often reduce, the surface tension of the liquid. Depending on the nature of the hydrophilic and lipophilic groups in a surfactant molecule, surfactants can be useful as wetting agents, dispersants, emulsifiers or defoaming agents.

Surfactants can be classified as nonionic, anionic or cationic. Nonionic surfactants useful for the present compositions include, but are not limited to: alcohol alkoxylates such as alcohol alkoxylates based on natural and synthetic alcohols (which may be branched or linear) and prepared from the alcohols and ethylene oxide, propylene oxide, butylene oxide or mixtures thereof; amine ethoxylates, alkanolamides and ethoxylated alkanolamides; alkoxylated triglycerides such as ethoxylated soybean, castor and rapeseed oils; alkylphenol alkoxylates such as octylphenol ethoxylates, nonylphenol ethoxylates, dinonyl phenol ethoxylates and dodecyl phenol ethoxylates (prepared from the phenols and ethylene oxide, propylene oxide, butylene oxide or mixtures thereof); block polymers prepared from ethylene oxide or propylene oxide and reverse block polymers where the terminal blocks are prepared from propylene oxide; ethoxylated fatty acids; ethoxylated fatty esters and oils; ethoxylated methyl esters; ethoxylated tristyrylphenol (including those prepared from ethylene oxide, propylene oxide, butylene oxide or mixtures thereof); fatty acid esters, glycerol esters, lanolin-based derivatives, polyethoxylate esters such as polyethoxylated sorbitan fatty acid esters, polyethoxylated sorbitol fatty acid esters and polyethoxylated glycerol fatty acid esters; other sorbitan derivatives such as sorbitan esters; polymeric surfactants such as random copolymers, block copolymers, alkyd peg (polyethylene glycol) resins, graft or comb polymers and star polymers; polyethylene glycols (pegs); polyethylene glycol fatty acid esters; silicone-based surfactants; and sugar-derivatives such as sucrose esters, alkyl polyglycosides and alkyl polysaccharides.

Useful anionic surfactants include, but are not limited to: alkylaryl sulfonic acids and their salts; carboxylated alcohol or alkylphenol ethoxylates; diphenyl sulfonate derivatives; lignin and lignin derivatives such as lignosulfonates; maleic or succinic acids or their anhydrides; olefin sulfonates; phosphate esters such as phosphate esters of alcohol alkoxylates, phosphate esters of alkylphenol alkoxylates and phosphate esters of styryl phenol ethoxylates; protein-based surfactants; sarcosine derivatives; styryl phenol ether sulfate; sulfates and sulfonates of oils and fatty acids; sulfates and sulfonates of ethoxylated alkylphenols; sulfates of alcohols; sulfates of ethoxylated alcohols; sulfonates of amines and amides such as N,N-alkyltaurates; sulfonates of benzene, cumene, toluene, xylene, and dodecyl and tridecylbenzenes; sulfonates of condensed naphthalenes; sulfonates of naphthalene and alkyl naphthalene; sulfonates of fractionated petroleum; sulfosuccinamates; and sulfosuccinates and their derivatives such as dialkyl sulfosuccinate salts.

Useful cationic surfactants include, but are not limited to: amides and ethoxylated amides; amines such as N-alkyl propanediamines, tripropylenetriamines and dipropylenetetramines, and ethoxylated amines, ethoxylated diamines and propoxylated amines (prepared from the amines and ethylene oxide, propylene oxide, butylene oxide or mixtures thereof); amine salts such as amine acetates and diamine salts; quaternary ammonium salts such as quaternary salts, ethoxylated quaternary salts and diquaternary salts; and amine oxides such as alkyldimethylamine oxides and bis-(2-hydroxyethyl)-alkylamine oxides.

Also useful for the present compositions are mixtures of nonionic and anionic surfactants or mixtures of nonionic and cationic surfactants. Nonionic, anionic and cationic surfactants and their recommended uses are disclosed in a variety of published references including McCutcheon's Emulsifiers and Detergents, annual American and International Editions published by McCutcheon's Division, The Manufacturing Confectioner Publishing Co.; Sisely and Wood, Encyclopedia of Surface Active Agents, Chemical Publ. Co., Inc., New York, 1964; and A. S. Davidson and B. Milwidsky, Synthetic Detergents, Seventh Edition, John Wiley and Sons, New York, 1987.

Compositions of this invention may also contain formulation auxiliaries and additives, known to those skilled in the art as formulation aids (some of which may be considered to also function as solid diluents, liquid diluents or surfactants). Such formulation auxiliaries and additives may control: pH (buffers), foaming during processing (antifoams such polyorganosiloxanes), sedimentation of active ingredients (suspending agents), viscosity (thixotropic thickeners), in-container microbial growth (antimicrobials), product freezing (antifreezes), color (dyes/pigment dispersions), wash-off (film formers or stickers), evaporation (evaporation retardants), and other formulation attributes. Film formers include, for example, polyvinyl acetates, polyvinyl acetate copolymers, polyvinylpyrrolidone-vinyl acetate copolymer, polyvinyl alcohols, polyvinyl alcohol copolymers and waxes. Examples of formulation auxiliaries and additives include those listed in McCutcheon's Volume 2: Functional Materials, annual International and North American editions published by McCutcheon's Division, The Manufacturing Confectioner Publishing Co.; and PCT Publication WO 03/024222.

The compound of Formula 1 and any other active ingredients are typically incorporated into the present compositions by dissolving the active ingredient in a solvent or by grinding in a liquid or dry diluent. Solutions, including emulsifiable concentrates, can be prepared by simply mixing the ingredients. If the solvent of a liquid composition intended for use as an emulsifiable concentrate is water-immiscible, an emulsifier is typically added to emulsify the active-containing solvent upon dilution with water. Active ingredient slurries, with particle diameters of up to 2,000 μm can be wet milled using media mills to obtain particles with average diameters below 3 μm. Aqueous slurries can be made into finished suspension concentrates (see, for example, U.S. Pat. No. 3,060,084) or further processed by spray drying to form water-dispersible granules. Dry formulations usually require dry milling processes, which produce average particle diameters in the 2 to 10 μm range. Dusts and powders can be prepared by blending and usually grinding (such as with a hammer mill or fluid-energy mill). Granules and pellets can be prepared by spraying the active material upon preformed granular carriers or by agglomeration techniques. See Browning, “Agglomeration”, Chemical Engineering, Dec. 4, 1967, pp 147-48, Perry's Chemical Engineer's Handbook, 4th Ed., McGraw-Hill, New York, 1963, pages 8-57 and following, and WO 91/13546. Pellets can be prepared as described in U.S. Pat. No. 4,172,714. Water-dispersible and water-soluble granules can be prepared as taught in U.S. Pat. No. 4,144,050, U.S. Pat. No. 3,920,442 and DE 3,246,493. Tablets can be prepared as taught in U.S. Pat. No. 5,180,587, U.S. Pat. No. 5,232,701 and U.S. Pat. No. 5,208,030. Films can be prepared as taught in GB 2,095,558 and U.S. 3,299,566.

For further information regarding the art of formulation, see T. S. Woods, “The Formulator's Toolbox—Product Forms for Modern Agriculture” in Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp. 120-133. See also U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; Hance et al., Weed Control Handbook, 8th Ed., Blackwell Scientific Publications, Oxford, 1989; and Developments in formulation technology, PJB Publications, Richmond, UK, 2000.

In the following Examples, all percentages are by weight and all formulations are prepared in conventional ways. Compound numbers refer to compounds in Index Tables A-B. Without further elaboration, it is believed that one skilled in the art using the preceding description can utilize the present invention to its fullest extent. The following Examples are, therefore, to be constructed as merely illustrative, and not limiting of the disclosure in any way whatsoever. Percentages are by weight except where otherwise indicated.

### Example A

### High Strength Concentrate

| | |
|---|---|
| Compound 2 | 98.5% |
| silica aerogel | 0.5% |
| synthetic amorphous fine silica | 1.0% |

### Example B

### Wettable Powder

| | |
|---|---|
| Compound 3 | 65.0% |
| dodecylphenol polyethylene glycol ether | 2.0% |
| sodium ligninsulfonate | 4.0% |
| sodium silicoaluminate | 6.0% |
| montmorillonite (calcined) | 23.0% |

### Example C

### Granule

| | |
|---|---|
| Compound 4 | 10.0% |
| attapulgite granules (low volatile matter, 0.71/0.30 mm; | 90.0% |
| U.S.S. No. 25-50 sieves) | |

### Example D

### Extruded Pellet

| | |
|---|---|
| Compound 2 | 25.0% |
| anhydrous sodium sulfate | 10.0% |
| crude calcium ligninsulfonate | 5.0% |
| sodium alkylnaphthalenesulfonate | 1.0% |
| calcium/magnesium bentonite | 59.0% |

### Example E

### Emulsifiable Concentrate

| | |
|---|---|
| Compound 3 | 10.0% |
| polyoxyethylene sorbitol hexoleate | 20.0% |
| C₆-C₁₀ fatty acid methyl ester | 70.0% |

### Example F

### Microemulsion

| | |
|---|---|
| Compound 4 | 5.0% |
| polyvinylpyrrolidone-vinyl acetate copolymer | 30.0% |
| alkylpolyglycoside | 30.0% |
| glyceryl monooleate | 15.0% |
| water | 20.0% |

### Example G

### Seed Treatment

| | |
|---|---|
| Compound 3 | 20.00% |
| polyvinylpyrrolidone-vinyl acetate copolymer | 5.00% |
| montan acid wax | 5.00% |
| calcium ligninsulfonate | 1.00% |
| polyoxyethylene/polyoxypropylene block copolymers | 1.00% |
| stearyl alcohol (POE 20) | 2.00% |
| polyorganosilane | 0.20% |
| colorant red dye | 0.05% |
| water | 65.75% |

Water-soluble and water-dispersible formulations are typically diluted with water to form aqueous compositions before application. Aqueous compositions for direct applications to the plant or portion thereof (e.g., spray tank compositions) typically at least about 1 ppm or more (e.g., from 1 ppm to 100 ppm) of the compound(s) of this invention.

The compounds of this invention are useful as plant disease control agents. The present invention therefore further comprises a method for controlling plant diseases caused by fungal plant pathogens comprising applying to the plant or portion thereof to be protected, or to the plant seed to be protected, an effective amount of a compound of the invention or a fungicidal composition containing said compound. The compounds and/or compositions of this invention provide control of diseases caused by a broad spectrum of fungal plant pathogens in the Basidiomycete, Ascomycete, Oomycete and Deuteromycete classes. They are effective in controlling a broad spectrum of plant diseases, particularly foliar pathogens of ornamental, turf, vegetable, field, cereal, and fruit crops. These pathogens include: Oomycetes, including Phytophthora diseases such as Phytophthora infestans, Phytophthora megasperma, Phytophthora parasitica, Phytophthora cinnamomi and Phytophthora capsici, Pythium diseases such as Pythium aphanidermatum, and diseases in the Peronosporaceae family such as Plasmopara viticola, Peronospora spp. (including Peronospora tabacina and Peronospora parasitica), Pseudoperonospora spp. (including Pseudoperonospora cubensis) and Bremia lactucae; Ascomycetes, including Alternaria diseases such as Alternaria solani and Alternaria brassicae, Guignardia diseases such as Guignardia bidwell, Venturia diseases such as Venturia inaequalis, Septoria diseases such as Septoria nodorum and Septoria tritici, powdery mildew diseases such as Erysiphe spp. (including Erysiphe graminis and Erysiphe polygoni), Uncinula necatur, Sphaerotheca fuliginea, Podosphaera leucotricha and Pseudocercosporella herpotrichoides, Botrytis diseases such as Botrytis cinerea, Monilinia fructicola, Sclerotinia diseases such as Sclerotinia sclerotiorum, Sclerotinia minor, Magnaporthe grisea, and Phomopsis viticola, Helminthosporium diseases such as Helminthosporium tritici repentis and Pyrenophora teres, anthracnose diseases such as Glomerella or Colletotrichum spp. (such as Colletotrichum graminicola and Colletotrichum orbiculare), and Gaeumannomyces graminis; Basidiomycetes, including rust diseases caused by Puccinia spp. (such as Puccinia recondita, Puccinia striiformis, Puccinia hordei, Puccinia graminis and Puccinia arachidis), Hemileia vastatrix and Phakopsora pachyrhizi; other pathogens including Rutstroemia floccosum (also known as Sclerotinia homoeocarpa); Rhizoctonia spp. (such as Rhizoctonia solani); Fusarium diseases such as Fusarium roseum, Fusarium graminearum and Fusarium oxysporum Verticillium dahliae; Sclerotium rolfsii; Rynchosporium secalis; Cercosporidium personatum, Cercospora arachidicola and Cercospora beticola; Rhizopus spp. (such as Rhizopus stolonifer); Aspergillus spp. (such as Aspergillus flavus and Aspergillus parasiticus); and other genera and species closely related to these pathogens. In addition to their fungicidal activity, the compositions or combinations also have activity against bacteria such as Erwinia amylovora, Xanthomonas campestris, Pseudomonas syringae, and other related species.

Furthermore, the compounds of this invention are useful in treating postharvest diseases of fruits and vegetables caused by fungi and bacteria. These infections can occur before, during and after harvest. For example, infections can occur before harvest and then remain dormant until some point during ripening (e.g., host begins tissue changes in such a way that infection can progress); also infections can arise from surface wounds created by mechanical or insect injury. In this respect, the compounds of this invention can reduce losses (i.e. losses resulting from quantity and quality) due to postharvest diseases which may occur at any time from harvest to consumption. Treatment of postharvest diseases with compounds of the invention can increase the period of time during which perishable edible plant parts (e.g, fruits, seeds, foliage, stems, bulbs, tubers) can be stored refrigerated or un-refrigerated after harvest, and remain edible and free from noticeable or harmful degradation or contamination by fungi or other microorganisms. Treatment of edible plant parts before or after harvest with compounds of the invention can also decrease the formation of toxic metabolites of fungi or other microorganisms, for example, mycotoxins such as aflatoxins.

Plant disease control is ordinarily accomplished by applying an effective amount of a compound of this invention either pre- or post-infection, to the portion of the plant to be protected such as the roots, stems, foliage, fruits, seeds, tubers or bulbs, or to the media (soil or sand) in which the plants to be protected are growing. The compounds can also be applied to seeds to protect the seeds and seedlings developing from the seeds. The compounds can also be applied through irrigation water to treat plants. Control of postharvest pathogens which infect the produce before harvest is typically accomplished by field application of a compound of this invention, and in cases where infection occurs after harvest the compounds can be applied to the harvested crop as dips, sprays, fumigants, treated wraps and box liners.

Compounds of this invention are also useful in seed treatments for protecting seeds from plant diseases. In the context of the present disclosure and claims, treating a seed means contacting the seed with a biologically effective amount of a compound of this invention, which is typically formulated as a composition of the invention. This seed treatment protects the seed from plant diseases and generally can also protect roots and other plant parts in contact with the soil of the seedling developing from the germinating seed. The seed treatment may also provide protection of foliage by translocation of the compound of this invention or a second active ingredient within the developing plant. Seed treatments can be applied to all types of seeds, including those from which plants genetically transformed to express specialized traits will germinate. Representative examples include those expressing proteins toxic to invertebrate pests, such as Bacillus thuringiensis toxin or those expressing herbicide resistance such as glyphosate acetyltransferase, which provides resistance to glyphosate. Seed treatments with compounds of this invention can also increase vigor of plants growing from the seed.

One method of seed treatment is by spraying or dusting the seed with a compound of the invention (i.e. as a formulated composition) before sowing the seeds. Compositions formulated for seed treatment generally comprise a film former or adhesive agent. Therefore typically a seed coating composition of the present invention comprises a biologically effective amount of a compound of Formula 1 and a film former or adhesive agent. Seed can be coated by spraying a flowable suspension concentrate directly into a tumbling bed of seeds and then drying the seeds. Alternatively, other formulation types such as wetted powders, solutions, suspoemulsions, emulsifiable concentrates and emulsions in water can be sprayed on the seed. This process is particularly useful for applying film coatings on seeds. Various coating machines and processes are available to one skilled in the art. Suitable processes include those listed in P. Kosters et al., Seed Treatment: Progress and Prospects, 1994 BCPC Mongraph No. 57, and references listed therein.

Compounds of Formula 1 and their compositions, both alone and in combination with other insecticides, nematicides, and fungicides, are particularly useful in seed treatment for crops including, but not limited to, maize or corn, soybeans, cotton, cereal (e.g., wheat, oats, barley, rye and rice), potatoes, vegetables and oilseed rape.

Other insecticides or nematicides with which compounds of Formula 1 can be formulated to provide mixtures useful in seed treatment include but are not limited to abamectin, acetamiprid, acrinathrin, amitraz, avermectin, azadirachtin, bensultap, bifenthrin, buprofezin, cadusafos, carbaryl, carbofuran, cartap, chlorantraniliprole, chlorfenapyr, chlorpyrifos, clothianidin, cyantraniliprole, cyfluthrin, beta-cyfluthrin, cyhalothrin, gamma-cyhalothrin, lambda-cyhalothrin, cypermethrin, alpha-cypermethrin, zeta-cypermethrin, cyromazine, deltamethrin, dieldrin, dinotefuran, diofenolan, emamectin, endosulfan, esfenvalerate, ethiprole, etofenprox, etoxazole, fenothiocarb, fenoxycarb, fenvalerate, fipronil, flonicamid, flubendiamide, flufenoxuron, fluvalinate, formetanate, fosthiazate, hexaflumuron, hydramethylnon, imidacloprid, indoxacarb, lufenuron, metaflumizone, methiocarb, methomyl, methoprene, methoxyfenozide, nitenpyram, nithiazine, novaluron, oxamyl, pymetrozine, pyrethrin, pyridaben, pyridalyl, pyriproxyfen, ryanodine, spinetoram, spinosad, spirodiclofen, spiromesifen, spirotetramat, sulfoxaflor, tebufenozide, tetramethrin, thiacloprid, thiamethoxam, thiodicarb, thiosultap-sodium, tralomethrin, triazamate, triflumuron, Bacillus thuringiensis delta-endotoxins, all strains of Bacillus thuringiensis and all strains of Nucleo polyhydrosis viruses.

Fungicides with which compounds of Formula 1 can be formulated to provide mixtures useful in seed treatment include but are not limited to amisulbrom, azoxystrobin, boscalid, carbendazim, carboxin, cymoxanil, cyproconazole, difenoconazole, dimethomorph, fluazinam, fludioxonil, fluquinconazole, fluopicolide, fluoxastrobin, flutriafol, fluxapyroxad, ipconazole, iprodione, metalaxyl, mefenoxam, metconazole, myclobutanil, paclobutrazole, penflufen, picoxystrobin, prothioconazole, pyraclostrobin, sedaxane, silthiofam, tebuconazole, thiabendazole, thiophanate-methyl, thiram, trifloxystrobin and triticonazole.

Compositions comprising compounds of Formula 1 useful for seed treatment can further comprise bacteria and fungi that have the ability to provide protection from the harmful effects of plant pathogenic fungi or bacteria and/or soil born animals such as nematodes. Bacteria exhibiting nematicidal properties may include but are not limited to Bacillus firmus, Bacillus cereus, Bacillius subtiliis and Pasteuria penetrans. A suitable Bacillus firmus strain is strain CNCM 1-1582 (GB-126) which is commercially available as BioNem™. A suitable Bacillus cereus strain is strain NCMM 1-1592. Both Bacillus strains are disclosed in U.S. Pat. No. 6,406,690. Other suitable bacteria exhibiting nematicidal activity are B. amyloliquefaciens IN937a and B. subtilis strain GB03. Bacteria exhibiting fungicidal properties may include but are not limited to B. pumilus strain GB34. Fungal species exhibiting nematicidal properties may include but are not limited to Myrothecium verrucaria, Paecilomyces lilacinus and Purpureocillium lilacinum.

Seed treatments can also include one or more nematicidal agents of natural origin such as the elicitor protein called harpin which is isolated from certain bacterial plant pathogens such as Erwinia amylovora. An example is the Harpin-N-Tek seed treatment technology available as N-Hibit™ Gold CST.

Seed treatments can also include one or more species of legume-root nodulating bacteria such as the microsymbiotic nitrogen-fixing bacteria Bradyrhizobium japonicum. These inocculants can optionally include one or more lipo-chitooligosaccharides (LCOs), which are nodulation (Nod) factors produced by rhizobia bacteria during the initiation of nodule formation on the roots of legumes. For example, the Optimize® brand seed treatment technology incorporates LCO Promoter Technology™ in combination with an inocculant.

Seed treatments can also include one or more isoflavones which can increase the level of root colonization by mycorrhizal fungi. Mycorrhizal fungi improve plant growth by enhancing the root uptake of nutrients such as water, sulfates, nitrates, phosphates and metals. Examples of isoflavones include, but are not limited to, genistein, biochanin A, formononetin, daidzein, glycitein, hesperetin, naringenin and pratensein. Formononetin is available as an active ingredient in mycorrhizal inocculant products such as PHC Colonize®AG.

Seed treatments can also include one or more plant activators that induce systemic acquired resistance in plants following contact by a pathogen. An example of a plant activator which induces such protective mechanisms is acibenzolar-5-methyl.

Rates of application for these compounds (i.e. a fungicidally effective amount) can be influenced by factors such as the plant diseases to be controlled, the plant species to be protected, ambient moisture and temperature and should be determined under actual use conditions. One skilled in the art can easily determine through simple experimentation the fungicidally effective amount necessary for the desired level of plant disease control. Foliage can normally be protected when treated at a rate of from less than about 1 g/ha to about 5,000 g/ha of active ingredient. Seed and seedlings can normally be protected when seed is treated at a rate of from about 0.1 to about 10 g per kilogram of seed.

Compounds of this invention can also be mixed with one or more other biologically active compounds or agents including fungicides, insecticides, nematocides, bactericides, acaricides, herbicides, herbicide safeners, growth regulators such as insect molting inhibitors and rooting stimulants, chemosterilants, semiochemicals, repellents, attractants, pheromones, feeding stimulants, plant nutrients, other biologically active compounds or entomopathogenic bacteria, virus or fungi to form a multi-component pesticide giving an even broader spectrum of agricultural protection. Thus the present invention also pertains to a composition comprising a compound of Formula 1 (in a fungicidally effective amount) and at least one additional biologically active compound or agent (in a biologically effective amount) and can further comprise at least one of a surfactant, a solid diluent or a liquid diluent. The other biologically active compounds or agents can be formulated in compositions comprising at least one of a surfactant, solid or liquid diluent. For mixtures of the present invention, one or more other biologically active compounds or agents can be formulated together with a compound of Formula 1, to form a premix, or one or more other biologically active compounds or agents can be formulated separately from the compound of Formula 1, and the formulations combined together before application (e.g., in a spray tank) or, alternatively, applied in succession.

Of note is a composition which in addition to the compound of Formula 1 include at least one fungicidal compound selected from the group consisting of the classes (1) methyl benzimidazole carbamate (MBC) fungicides; (2) dicarboximide fungicides; (3) demethylation inhibitor (DMI) fungicides; (4) phenylamide fungicides; (5) amine/morpholine fungicides; (6) phospholipid biosynthesis inhibitor fungicides; (7) carboxamide fungicides; (8) hydroxy(2-amino-)pyrimidine fungicides; (9) anilinopyrimidine fungicides; (10) N-phenyl carbamate fungicides; (11) quinone outside inhibitor (QoI) fungicides; (12) phenylpyrrole fungicides; (13) quinoline fungicides; (14) lipid peroxidation inhibitor fungicides; (15) melanin biosynthesis inhibitors-reductase (MBI-R) fungicides; (16) melanin biosynthesis inhibitors-dehydratase (MBI-D) fungicides; (17) hydroxyanilide fungicides; (18) squalene-epoxidase inhibitor fungicides; (19) polyoxin fungicides; (20) phenylurea fungicides; (21) quinone inside inhibitor (QiI) fungicides; (22) benzamide fungicides; (23) enopyranuronic acid antibiotic fungicides; (24) hexopyranosyl antibiotic fungicides; (25) glucopyranosyl antibiotic: protein synthesis fungicides; (26) glucopyranosyl antibiotic: trehalase and inositol biosynthesis fungicides; (27) cyanoacetamideoxime fungicides; (28) carbamate fungicides; (29) oxidative phosphorylation uncoupling fungicides; (30) organo tin fungicides; (31) carboxylic acid fungicides; (32) heteroaromatic fungicides; (33) phosphonate fungicides; (34) phthalamic acid fungicides; (35) benzotriazine fungicides; (36) benzene-sulfonamide fungicides; (37) pyridazinone fungicides; (38) thiophene-carboxamide fungicides; (39) pyrimidinamide fungicides; (40) carboxylic acid amide (CAA) fungicides; (41) tetracycline antibiotic fungicides; (42) thiocarbamate fungicides; (43) benzamide fungicides; (44) host plant defense induction fungicides; (45) multi-site contact activity fungicides; (46) fungicides other than classes (1) through (45); and salts of compounds of classes (1) through (46).

Further descriptions of these classes of fungicidal compounds are provided below.

(1) “Methyl benzimidazole carbamate (MBC) fungicides” (Fungicide Resistance Action Committee (FRAC) code 1) inhibit mitosis by binding to β-tubulin during microtubule assembly. Inhibition of microtubule assembly can disrupt cell division, transport within the cell and cell structure. Methyl benzimidazole carbamate fungicides include benzimidazoles and thiophanates. The benzimidazoles include benomyl, carbendazim, fuberidazole and thiabendazole. The thiophanates include thiophanate and thiophanate-methyl.

(2) “Dicarboximide fungicides” (Fungicide Resistance Action Committee (FRAC) code 2) are proposed to inhibit a lipid peroxidation in fungi through interference with NADH cytochrome c reductase. Examples include chlozolinate, iprodione, procymidone and vinclozolin.

(3) “Demethylation inhibitor (DMI) fungicides” (Fungicide Resistance Action Committee (FRAC) code 3) inhibit C14-demethylase, which plays a role in sterol production. Sterols, such as ergosterol, are needed for membrane structure and function, making them essential for the development of functional cell walls. Therefore, exposure to these fungicides results in abnormal growth and eventually death of sensitive fungi. Demethylation fungicides include piperazines, pyridines, pyrimidines, imidazoles and triazoles. The piperazines include triforine. The pyridines include buthiobate and pyrifenox. The pyrimidines include fenarimol, nuarimol and triarimol. The imidazoles include clotrimazole, imazalil, oxpoconazole, prochloraz, pefurazoate and triflumizole. The triazoles include azaconazole, bitertanol, bromuconazole, cyproconazole, difenoconazole, diniconazole (including diniconazole-M), epoxiconazole, etaconazole, fenbuconazole, fluquinconazole, flusilazole, flutriafol, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, rel-1-[[(2R,3S)-3-(2-chlorophenyl)-2-(2,4-difluorophenyl)-2-oxiranyl]methyl]-1H-1,2,4-triazole, rel-2-[[(2R,3S)-3-(2-chlorophenyl)-2-(2,4-difluorophenyl)-2-oxiranyl]-methyl]-1,2-dihydro-3H-1,2,4-triazole-3-thione and rel-1-[[(2R,3S)-3-(2-chlorophenyl)-2-(2,4-difluorophenyl)-2-oxiranyl]methyl]-5-(2-propen-1-ylthio)-1H-1,2,4-triazole. The imidazoles include clotrimazole, imazalil, oxpoconazole, prochloraz, pefurazoate and triflumizole. Biochemical investigations have shown that all of the above mentioned fungicides are DMI fungicides as described by K. H. Kuck et al. in Modern Selective Fungicides—Properties, Applications and Mechanisms of Action, H. Lyr (Ed.), Gustav Fischer Verlag New York, 1995, 205-258.

(4) “Phenylamide fungicides” (Fungicide Resistance Action Committee (FRAC) code 4) are specific inhibitors of RNA polymerase in Oomycete fungi. Sensitive fungi exposed to these fungicides show a reduced capacity to incorporate uridine into rRNA. Growth and development in sensitive fungi is prevented by exposure to this class of fungicide. Phenylamide fungicides include acylalanines, oxazolidinones and butyrolactones. The acylalanines include benalaxyl, benalaxyl-M, furalaxyl, metalaxyl and metalaxyl-M/mefenoxam. The oxazolidinones include oxadixyl. The butyrolactones include ofurace.

(5) “Amine/morpholine fungicides” (Fungicide Resistance Action Committee (FRAC) code 5) inhibit two target sites within the sterol biosynthetic pathway, Δ⁸→Δ⁷ isomerase and Δ¹⁴ reductase. Sterols, such as ergosterol, are needed for membrane structure and function, making them essential for the development of functional cell walls. Therefore, exposure to these fungicides results in abnormal growth and eventually death of sensitive fungi. Amine/morpholine fungicides (also known as non-DMI sterol biosynthesis inhibitors) include morpholines, piperidines and spiroketal-amines. The morpholines include aldimorph, dodemorph, fenpropimorph, tridemorph and trimorphamide. The piperidines include fenpropidin and piperalin. The spiroketal-amines include spiroxamine.

(6) “Phospholipid biosynthesis inhibitor fungicides” (Fungicide Resistance Action Committee (FRAC) code 6) inhibit growth of fungi by affecting phospholipid biosynthesis. Phospholipid biosynthesis fungicides include phosphorothiolates and dithiolanes. The phosphorothiolates include edifenphos, iprobenfos and pyrazophos. The dithiolanes include isoprothiolane.

(7) “Carboxamide fungicides” (Fungicide Resistance Action Committee (FRAC) code 7) inhibit Complex II (succinate dehydrogenase) fungal respiration by disrupting a key enzyme in the Krebs Cycle (TCA cycle) named succinate dehydrogenase. Inhibiting respiration prevents the fungus from making ATP, and thus inhibits growth and reproduction. Carboxamide fungicides include phenyl benzamides, pyridinyl ethyl benzamides, furan carboxamides, oxathiin carboxamides, thiazole carboxamides, pyrazole carboxamides and pyridine carboxamides. The phenyl benzamides include benodanil, flutolanil and mepronil. The pyridinyl ethyl benzamides include fluopyram. The furan carboxamides include fenfuram. The oxathiin carboxamides include carboxin and oxycarboxin. The thiazole carboxamides include thifluzamide. The pyrazole carboxamides include furametpyr, penthiopyrad, bixafen, isopyrazam, benzovindiflupyr, N-[2-(1S,2R)-[1,1′-bicyclopropyl]-2-ylphenyl]-3-(difluoromethyl)-1-methyl-1H-pyrazole-4-carboxamide, penflufen, (N-[2-(1,3-dimethylbutyl)phenyl]-5-fluoro-1,3-dimethyl-1H-pyrazole-4-carboxamide), N-[2-(2,4-dichlorophenyl)-2-methoxy-1-methylethyl]-3-(difluoromethyl)-1-methyl-1H-pyrazole-4-carboxamide and N-cyclopropyl-3-(difluoromethyl)-5-fluoro-1-methyl-N-[[2-(1-methylethyl)phenyl]methyl]-1H-pyrazole-4-carboxamide. The pyridine carboxamides include boscalid.

(8) “Hydroxy(2-amino-)pyrimidine fungicides” (Fungicide Resistance Action Committee (FRAC) code 8) inhibit nucleic acid synthesis by interfering with adenosine deaminase. Examples include bupirimate, dimethirimol and ethirimol.

(9) “Anilinopyrimidine fungicides” (Fungicide Resistance Action Committee (FRAC) code 9) are proposed to inhibit biosynthesis of the amino acid methionine and to disrupt the secretion of hydrolytic enzymes that lyse plant cells during infection. Examples include cyprodinil, mepanipyrim and pyrimethanil.

(10) “N-Phenyl carbamate fungicides” (Fungicide Resistance Action Committee (FRAC) code 10) inhibit mitosis by binding to β-tubulin and disrupting microtubule assembly. Inhibition of microtubule assembly can disrupt cell division, transport within the cell and cell structure. Examples include diethofencarb.

(11) “Quinone outside inhibitor (QoI) fungicides” (Fungicide Resistance Action Committee (FRAC) code 11) inhibit Complex III mitochondrial respiration in fungi by affecting ubiquinol oxidase. Oxidation of ubiquinol is blocked at the “quinone outside” (Qₒ) site of the cytochrome bc₁ complex, which is located in the inner mitochondrial membrane of fungi. Inhibiting mitochondrial respiration prevents normal fungal growth and development. Quinone outside inhibitor fungicides (also known as strobilurin fungicides) include methoxyacrylates, methoxycarbamates, oximinoacetates, oximinoacetamides, oxazolidinediones, dihydrodioxazines, imidazolinones and benzylcarbamates. The methoxyacrylates include azoxystrobin, coumoxystrobin, enestroburin, flufenoxystrobin, picoxystrobin and pyraoxystrobin. The methoxycarbamates include pyraclostrobin, pyrametostrobin and triclopyricarb. The oximinoacetates include kresoxim-methyl and trifloxystrobin. The oximinoacetamides include dimoxystrobin, metominostrobin, orysastrobin, α-[methoxyimino]-N-methyl-2-[[[1-[3-(trifluoromethyl)phenyl]ethoxy]imino]-methyl]benzeneacetamide and 2-[[[3-(2,6-dichlorophenyl)-1-methyl-2-propen-1-ylidene]-amino]oxy]methyl]-α-(methoxyimino)-N-methylbenzeneacetamide. The oxazolidinediones include famoxadone. The dihydrodioxazines include fluoxastrobin. The imidazolinones include fenamidone. The benzylcarbamates include pyribencarb. Class (11) also includes 2-[(2,5-dimethylphenoxy)methyl]-α-methoxy-N-benzeneacetamide.

(12) “Phenylpyrrole fungicides” (Fungicide Resistance Action Committee (FRAC) code 12) inhibit a MAP protein kinase associated with osmotic signal transduction in fungi. Fenpiclonil and fludioxonil are examples of this fungicide class.

(13) “Azanaphthalene fungicides” (Fungicide Resistance Action Committee (FRAC) code 13) are proposed to inhibit signal transduction by affecting G-proteins in early cell signaling. They have been shown to interfere with germination and/or appressorium formation in fungi that cause powder mildew diseases. Azanaphthalene fungicides include aryloxyquinolines and quinazolinone. The aryloxyquinolines include quinoxyfen and tebufloquin. The quinazolinones include proquinazid.

(14) “Lipid peroxidation inhibitor fungicides” (Fungicide Resistance Action Committee (FRAC) code 14) are proposed to inhibit lipid peroxidation which affects membrane synthesis in fungi. Members of this class, such as etridiazole, may also affect other biological processes such as respiration and melanin biosynthesis. Lipid peroxidation fungicides include aromatic carbons and 1,2,4-thiadiazoles. The aromatic carbon fungicides include biphenyl, chloroneb, dicloran, quintozene, tecnazene and tolclofos-methyl. The 1,2,4-thiadiazole fungicides include etridiazole.

(15) “Melanin biosynthesis inhibitors-reductase (MBI-R) fungicides” (Fungicide Resistance Action Committee (FRAC) code 16.1) inhibit the naphthal reduction step in melanin biosynthesis. Melanin is required for host plant infection by some fungi. Melanin biosynthesis inhibitors-reductase fungicides include isobenzofuranones, pyrroloquinolinones and triazolobenzothiazoles. The isobenzofuranones include fthalide. The pyrroloquinolinones include pyroquilon. The triazolobenzothiazoles include tricyclazole.

(16) “Melanin biosynthesis inhibitors-dehydratase (MBI-D) fungicides” (Fungicide Resistance Action Committee (FRAC) code 16.2) inhibit scytalone dehydratase in melanin biosynthesis. Melanin in required for host plant infection by some fungi. Melanin biosynthesis inhibitors-dehydratase fungicides include cyclopropanecarboxamides, carboxamides and propionamides. The cyclopropanecarboxamides include carpropamid. The carboxamides include diclocymet. The propionamides include fenoxanil.

(17) “Hydroxyanilide fungicides (Fungicide Resistance Action Committee (FRAC) code 17) inhibit C4-demethylase which plays a role in sterol production. Examples include fenhexamid.

(18) “Squalene-epoxidase inhibitor fungicides” (Fungicide Resistance Action Committee (FRAC) code 18) inhibit squalene-epoxidase in ergosterol biosynthesis pathway. Sterols such as ergosterol are needed for membrane structure and function, making them essential for the development of functional cell walls. Therefore exposure to these fungicides results in abnormal growth and eventually death of sensitive fungi. Squalene-epoxidase inhibitor fungicides include thiocarbamates and allylaminess. The thiocarbamates include pyributicarb. The allylamines include naftifine and terbinafine.

(19) “Polyoxin fungicides” (Fungicide Resistance Action Committee (FRAC) code 19) inhibit chitin synthase. Examples include polyoxin.

(20) “Phenylurea fungicides” (Fungicide Resistance Action Committee (FRAC) code 20) are proposed to affect cell division. Examples include pencycuron.

(21) “Quinone inside inhibitor (QiI) fungicides” (Fungicide Resistance Action Committee (FRAC) code 21) inhibit Complex III mitochondrial respiration in fungi by affecting ubiquinol reductase. Reduction of ubiquinol is blocked at the “quinone inside” (Qᵢ) site of the cytochrome bc₁ complex, which is located in the inner mitochondrial membrane of fungi. Inhibiting mitochondrial respiration prevents normal fungal growth and development. Quinone inside inhibitor fungicides include cyanoimidazoles and sulfamoyltriazoles. The cyanoimidazoles include cyazofamid. The sulfamoyltriazoles include amisulbrom.

(22) “Benzamide fungicides” (Fungicide Resistance Action Committee (FRAC) code 22) inhibit mitosis by binding to β-tubulin and disrupting microtubule assembly Inhibition of microtubule assembly can disrupt cell division, transport within the cell and cell structure. Examples include zoxamide.

(23) “Enopyranuronic acid antibiotic fungicides” (Fungicide Resistance Action Committee (FRAC) code 23) inhibit growth of fungi by affecting protein biosynthesis. Examples include blasticidin-S.

(24) “Hexopyranosyl antibiotic fungicides” (Fungicide Resistance Action Committee (FRAC) code 24) inhibit growth of fungi by affecting protein biosynthesis. Examples include kasugamycin.

(25) “Glucopyranosyl antibiotic: protein synthesis fungicides” (Fungicide Resistance Action Committee (FRAC) code 25) inhibit growth of fungi by affecting protein biosynthesis. Examples include streptomycin.

(26) “Glucopyranosyl antibiotic: trehalase and inositol biosynthesis fungicides” (Fungicide Resistance Action Committee (FRAC) code 26) inhibit trehalase in inositol biosynthesis pathway. Examples include validamycin.

(27) “Cyanoacetamideoxime fungicides (Fungicide Resistance Action Committee (FRAC) code 27) include cymoxanil.

(28) “Carbamate fungicides” (Fungicide Resistance Action Committee (FRAC) code 28) are considered multi-site inhibitors of fungal growth. They are proposed to interfere with the synthesis of fatty acids in cell membranes, which then disrupts cell membrane permeability. Propamacarb, propamacarb-hydrochloride, iodocarb, and prothiocarb are examples of this fungicide class.

(29) “Oxidative phosphorylation uncoupling fungicides” (Fungicide Resistance Action Committee (FRAC) code 29) inhibit fungal respiration by uncoupling oxidative phosphorylation. Inhibiting respiration prevents normal fungal growth and development. This class includes 2,6-dinitroanilines such as fluazinam, pyrimidonehydrazones such as ferimzone and dinitrophenyl crotonates such as dinocap, meptyldinocap and binapacryl.

(30) “Organo tin fungicides” (Fungicide Resistance Action Committee (FRAC) code 30) inhibit adenosine triphosphate (ATP) synthase in oxidative phosphorylation pathway. Examples include fentin acetate, fentin chloride and fentin hydroxide.

(31) “Carboxylic acid fungicides” (Fungicide Resistance Action Committee (FRAC) code 31) inhibit growth of fungi by affecting deoxyribonucleic acid (DNA) topoisomerase type II (gyrase). Examples include oxolinic acid.

(32) “Heteroaromatic fungicides” (Fungicide Resistance Action Committee (FRAC) code 32) are proposed to affect DNA/ribonucleic acid (RNA) synthesis. Heteroaromatic fungicides include isoxazoles and isothiazolones. The isoxazoles include hymexazole and the isothiazolones include octhilinone.

(33) “Phosphonate fungicides” (Fungicide Resistance Action Committee (FRAC) code 33) include phosphorous acid and its various salts, including fosetyl-aluminum.

(34) “Phthalamic acid fungicides” (Fungicide Resistance Action Committee (FRAC) code 34) include teclofthalam.

(35) “Benzotriazine fungicides” (Fungicide Resistance Action Committee (FRAC) code 35) include triazoxide.

(36) “Benzene-sulfonamide fungicides” (Fungicide Resistance Action Committee (FRAC) code 36) include flusulfamide.

(37) “Pyridazinone fungicides” (Fungicide Resistance Action Committee (FRAC) code 37) include diclomezine.

(38) “Thiophene-carboxamide fungicides” (Fungicide Resistance Action Committee (FRAC) code 38) are proposed to affect ATP production. Examples include silthiofam.

(39) “Pyrimidinamide fungicides” (Fungicide Resistance Action Committee (FRAC) code 39) inhibit growth of fungi by affecting phospholipid biosynthesis and include diflumetorim.

(40) “Carboxylic acid amide (CAA) fungicides” (Fungicide Resistance Action Committee (FRAC) code 40) are proposed to inhibit phospholipid biosynthesis and cell wall deposition. Inhibition of these processes prevents growth and leads to death of the target fungus. Carboxylic acid amide fungicides include cinnamic acid amides, valinamide carbamates, carbamates and mandelic acid amides. The cinnamic acid amides include dimethomorph and flumorph. The valinamide carbamates include benthiavalicarb, benthiavalicarb-isopropyl, iprovalicarb, valifenalate and valiphenal. The carbamates include tolprocarb. The mandelic acid amides include mandipropamid, N-[2-[4-[[3-(4-chlorophenyl)-2-propyn-1-yl]oxy]-3-methoxyphenyl]ethyl]-3-methyl-2-[(methylsulfonyl)-amino]butanamide and N-[2-[4-[[3-(4-chlorophenyl)-2-propyn-1-yl]oxy]-3-methoxyphenyl]-ethyl]-3-methyl-2-[(ethylsulfonyl)amino]butanamide.

(41) “Tetracycline antibiotic fungicides” (Fungicide Resistance Action Committee (FRAC) code 41) inhibit growth of fungi by affecting complex 1 nicotinamide adenine dinucleotide (NADH) oxidoreductase. Examples include oxytetracycline.

(42) “Thiocarbamate fungicides” (Fungicide Resistance Action Committee (FRAC) code 42) include methasulfocarb.

(43) “Benzamide fungicides” (Fungicide Resistance Action Committee (FRAC) code 43) inhibit growth of fungi by delocalization of spectrin-like proteins. Examples include acylpicolide fungicides such as fluopicolide.

(44) “Host plant defense induction fungicides” (Fungicide Resistance Action Committee (FRAC) code P) induce host plant defense mechanisms. Host plant defense induction fungicides include benzothiadiazoles, benzisothiazoles and thiadiazolecarboxamides. The benzothiadiazoles include acibenzolar-5-methyl. The benzisothiazoles include probenazole. The thiadiazolecarboxamides include tiadinil and isotianil.

(45) “Multi-site contact fungicides” inhibit fungal growth through multiple sites of action and have contact/preventive activity. This class of fungicides includes: (45.1) “copper fungicides” (Fungicide Resistance Action Committee (FRAC) code M1)”, (45.2) “sulfur fungicides” (Fungicide Resistance Action Committee (FRAC) code M2), (45.3) “dithiocarbamate fungicides” (Fungicide Resistance Action Committee (FRAC) code M3), (45.4) “phthalimide fungicides” (Fungicide Resistance Action Committee (FRAC) code M4), (45.5) “chloronitrile fungicides” (Fungicide Resistance Action Committee (FRAC) code M5), (45.6) “sulfamide fungicides” (Fungicide Resistance Action Committee (FRAC) code M6), (45.7) “guanidine fungicides” (Fungicide Resistance Action Committee (FRAC) code M7), (45.8) “triazine fungicides” (Fungicide Resistance Action Committee (FRAC) code M8) and (45.9) “quinone fungicides” (Fungicide Resistance Action Committee (FRAC) code M9). “Copper fungicides” are inorganic compounds containing copper, typically in the copper(II) oxidation state; examples include copper oxychloride, copper sulfate and copper hydroxide, including compositions such as Bordeaux mixture (tribasic copper sulfate). “Sulfur fungicides” are inorganic chemicals containing rings or chains of sulfur atoms; examples include elemental sulfur. “Dithiocarbamate fungicides” contain a dithiocarbamate molecular moiety; examples include mancozeb, metiram, propineb, ferbam, maneb, thiram, zineb and ziram. “Phthalimide fungicides” contain a phthalimide molecular moiety; examples include folpet, captan and captafol. “Chloronitrile fungicides” contain an aromatic ring substituted with chloro and cyano; examples include chlorothalonil. “Sulfamide fungicides” include dichlofluanid and tolyfluanid. “Guanidine fungicides” include dodine, guazatine, iminoctadine albesilate and iminoctadine triacetate. “Triazine fungicides” include anilazine. “Quinone fungicides” include dithianon.

(46) “Fungicides other than fungicides of classes (1) through (45)” include certain fungicides whose mode of action may be unknown. These include: (46.1) “thiazole carboxamide fungicides” (Fungicide Resistance Action Committee (FRAC) code U5), (46.2) “phenylacetamide fungicides” (Fungicide Resistance Action Committee (FRAC) code U6), (46.3) “arylphenylketone fungicides” (Fungicide Resistance Action Committee (FRAC) code U8) and (46.4) “triazolopyrimidine fungicides”. The thiazole carboxamides include ethaboxam. The phenylacetamides include cyflufenamid and N-[[(cyclopropylmethoxy)-amino][6-(difluoromethoxy)-2,3-difluorophenyl]-methylene]benzeneacetamide. The arylphenylketones include benzophenones such as metrafenone and benzoylpyridines such as pyriofenone. The triazolopyrimidines include ametoctradin. Class (46) (i.e. “Fungicides other than classes (1) through (45)”) also includes bethoxazin, fluxapyroxad, neo-asozin (ferric methanearsonate), pyrrolnitrin, quinomethionate, tebufloquin, isofetamid, N-[2-[4-[[3-(4-chlorophenyl)-2-propyn-1-yl]oxy]-3-methoxyphenyl]ethyl]-3-methyl-2-[(methylsulfonyl)amino]butanamide, N-[2-[4-[[3-(4-chlorophenyl)-2-propyn-1-yl]oxy]-3-methoxyphenyl]ethyl]-3-methyl-2-[(ethylsulfonyl)amino]butanamide, 2-[[2-fluoro-5-(trifluoromethyl)phenyl]thio]-2-[3-(2-methoxyphenyl)-2-thiazolidinylidene]acetonitrile, 3-[5-(4-chlorophenyl)-2,3-dimethyl-3-isoxazolidinyl]pyridine, 4-fluorophenyl N-[1-[[[1-(4-cyanophenyl)ethyl]sulfonyl]methyl]propyl]carbamate, 5-chloro-6-(2,4,6-trifluorophenyl)-7-(4-methylpiperidin-1-yl) [1,2,4]triazolo[1,5-c]pyrimidine, N-(4-chloro-2-nitrophenyl)-N-ethyl-4-methylbenzenesulfonamide, N-[[(cyclopropylmethoxy)amino][6-(difluoromethoxy)-2,3-difluorophenyl]methylene]benzeneacetamide, N-[4-[4-chloro-3-(trifluoromethyl)-phenoxy]-2,5-dimethylphenyl]-N-ethyl-N-methylmethanimidamide, 1-[(2-propenylthio)carbonyl]-2-(1-methylethyl)-4-(2-methylphenyl)-5-amino-1H-pyrazol-3-one, N-[4-[[3-[(4-chlorophenyl)methyl]-1,2,4-thiadiazol-5-yl]oxy]-2,5-dimethylphenyl]-N-ethyl-N-methylmethanimidamide, 1,1-dimethylethyl N-[6-[[[[(1-methyl-1H-tetrazol-5-yl)phenylmethylene]amino]oxy]methyl]-2-pyridinyl]carbamate, 3-butyn-1-yl N-[6-[[[[(1-methyl-1H-tetrazol-5-yl)phenylmethylene]amino]oxy]methyl]-2-pyridinyl]carbamate, 2,6-dimethyl-1H,5H-[1,4]dithiino[2,3-c:5,6-c′]dipyrrole-1,3,5,7(2H,6H)-tetrone, 5-fluoro-2-[(4-methylphenyl)methoxy]-4-pyrimidinamine and 5-fluoro-2-[(4-fluorophenyl)methoxy]-4-pyrimidinamine.

Therefore of note is a mixture (i.e. composition) comprising a compound of Formula 1 and at least one fungicidal compound selected from the group consisting of the aforedescribed classes (1) through (46). Also of note is a composition comprising said mixture (in fungicidally effective amount) and further comprising at least one additional component selected from the group consisting of surfactants, solid diluents and liquid diluents. Of particular note is a mixture (i.e. composition) comprising a compound of Formula 1 and at least one fungicidal compound selected from the group of specific compounds listed above in connection with classes (1) through (46). Also of particular note is a composition comprising said mixture (in fungicidally effective amount) and further comprising at least one additional surfactant selected from the group consisting of surfactants, solid diluents and liquid diluents.

Examples of other biologically active compounds or agents with which compounds of this invention can be formulated are: insecticides such as abamectin, acephate, acetamiprid, acrinathrin, amidoflumet (S-1955), avermectin, azadirachtin, azinphos-methyl, bifenthrin, bifenazate, buprofezin, carbofuran, cartap, chlorantraniliprole, chlorfenapyr, chlorfluazuron, chlorpyrifos, chlorpyrifos-methyl, chromafenozide, clothianidin, cyantraniliprole (3-bromo-1-(3-chloro-2-pyridinyl)-N-[4-cyano-2-methyl-6-[(methylamino)carbonyl]phenyl]-1H-pyrazole-5-carboxamide), cyflumetofen, cyfluthrin, beta-cyfluthrin, cyhalothrin, lambda-cyhalothrin, cypermethrin, cyromazine, deltamethrin, diafenthiuron, diazinon, dieldrin, diflubenzuron, dimefluthrin, dimethoate, dinotefuran, diofenolan, emamectin, endosulfan, esfenvalerate, ethiprole, fenothiocarb, fenoxycarb, fenpropathrin, fenvalerate, fipronil, flonicamid, flubendiamide, flucythrinate, tau-fluvalinate, flufenerim (UR-50701), flufenoxuron, fonophos, halofenozide, hexaflumuron, hydramethylnon, imidacloprid, indoxacarb, isofenphos, lufenuron, malathion, meperfluthrin, metaflumizone, metaldehyde, methamidophos, methidathion, methomyl, methoprene, methoxychlor, methoxyfenozide, metofluthrin, milbemycin oxime, monocrotophos, nicotine, nitenpyram, nithiazine, novaluron, noviflumuron (XDE-007), oxamyl, parathion, parathion-methyl, permethrin, phorate, phosalone, phosmet, phosphamidon, pirimicarb, profenofos, profluthrin, pymetrozine, pyrafluprole, pyrethrin, pyridalyl, pyrifluquinazon, pyriprole, pyriproxyfen, rotenone, ryanodine, spinetoram, spinosad, spirodiclofen, spiromesifen (BSN 2060), spirotetramat, sulfoxaflor, sulprofos, tebufenozide, teflubenzuron, tefluthrin, terbufos, tetrachlorvinphos, tetramethylfluthrin, thiacloprid, thiamethoxam, thiodicarb, thiosultap-sodium, tolfenpyrad, tralomethrin, triazamate, trichlorfon and triflumuron; and biological agents including entomopathogenic bacteria, such as Bacillus thuringiensis subsp. aizawai, Bacillus thuringiensis subsp. kurstaki, and the encapsulated delta-endotoxins of Bacillus thuringiensis (e.g., Cellcap, MPV, MPVII); entomopathogenic fungi, such as green muscardine fungus; and entomopathogenic virus including baculovirus, nucleopolyhedro virus (NPV) such as HzNPV, AfNPV; and granulosis virus (GV) such as CpGV.

Compounds of this invention and compositions thereof can be applied to plants genetically transformed to express proteins toxic to invertebrate pests (such as Bacillus thuringiensis delta-endotoxins). The effect of the exogenously applied fungicidal compounds of this invention may be synergistic with the expressed toxin proteins.

General references for agricultural protectants (i.e. insecticides, fungicides, nematocides, acaricides, herbicides and biological agents) include The Pesticide Manual, 13th Edition, C. D. S. Tomlin, Ed., British Crop Protection Council, Farnham, Surrey, U.K., 2003 and The BioPesticide Manual, 2nd Edition, L. G. Copping, Ed., British Crop Protection Council, Farnham, Surrey, U.K., 2001.

For embodiments where one or more of these various mixing partners are used, the weight ratio of these various mixing partners (in total) to the compound of Formula 1 is typically between about 1:3000 and about 3000:1. Of note are weight ratios between about 1:300 and about 300:1 (for example ratios between about 1:30 and about 30:1). One skilled in the art can easily determine through simple experimentation the biologically effective amounts of active ingredients necessary for the desired spectrum of biological activity. It will be evident that including these additional components may expand the spectrum of diseases controlled beyond the spectrum controlled by the compound of Formula 1 alone.

In certain instances, combinations of a compound of this invention with other biologically active (particularly fungicidal) compounds or agents (i.e. active ingredients) can result in a greater-than-additive (i.e. synergistic) effect. Reducing the quantity of active ingredients released in the environment while ensuring effective pest control is always desirable. When synergism of fungicidal active ingredients occurs at application rates giving agronomically satisfactory levels of fungal control, such combinations can be advantageous for reducing crop production cost and decreasing environmental load.

Of note is a combination of a compound of Formula 1 with at least one other fungicidal active ingredient. Of particular note is such a combination where the other fungicidal active ingredient has different site of action from the compound of Formula 1. In certain instances, a combination with at least one other fungicidal active ingredient having a similar spectrum of control but a different site of action will be particularly advantageous for resistance management. Thus, a composition of the present invention can further comprise a biologically effective amount of at least one additional fungicidal active ingredient having a similar spectrum of control but a different site of action.

Of particular note are compositions which in addition to compound of Formula 1 include at least one compound selected from the group consisting of (1) alkylenebis(dithiocarbamate) fungicides; (2) cymoxanil; (3) phenylamide fungicides; (4) proquinazid (6-iodo-3-propyl-2-propyloxy-4(3H)-quinazolinone); (5) chlorothalonil; (6) carboxamides acting at complex II of the fungal mitochondrial respiratory electron transfer site; (7) quinoxyfen; (8) metrafenone; (9) cyflufenamid; (10) cyprodinil; (11) copper compounds; (12) phthalimide fungicides; (13) fosetyl-aluminum; (14) benzimidazole fungicides; (15) cyazofamid; (16) fluazinam; (17) iprovalicarb; (18) propamocarb; (19) validomycin; (20) dichlorophenyl dicarboximide fungicides; (21) zoxamide; (22) fluopicolide; (23) mandipropamid; (24) carboxylic acid amides acting on phospholipid biosynthesis and cell wall deposition; (25) dimethomorph; (26) non-DMI sterol biosynthesis inhibitors; (27) inhibitors of demethylase in sterol biosynthesis; (28) bc₁ complex fungicides; and salts of compounds of (1) through (28).

Further descriptions of classes of fungicidal compounds are provided below.

Sterol biosynthesis inhibitors (group (27)) control fungi by inhibiting enzymes in the sterol biosynthesis pathway. Demethylase-inhibiting fungicides have a common site of action within the fungal sterol biosynthesis pathway, involving inhibition of demethylation at position 14 of lanosterol or 24-methylene dihydrolanosterol, which are precursors to sterols in fungi. Compounds acting at this site are often referred to as demethylase inhibitors, DMI fungicides, or DMIs. The demethylase enzyme is sometimes referred to by other names in the biochemical literature, including cytochrome P-450 (14DM). The demethylase enzyme is described in, for example, J. Biol. Chem. 1992, 267, 13175-79 and references cited therein. DMI fungicides are divided between several chemical classes: azoles (including triazoles and imidazoles), pyrimidines, piperazines and pyridines. The triazoles include azaconazole, bromuconazole, cyproconazole, difenoconazole, diniconazole (including diniconazole-M), epoxiconazole, etaconazole, fenbuconazole, fluquinconazole, flusilazole, flutriafol, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole and uniconazole. The imidazoles include clotrimazole, econazole, imazalil, isoconazole, miconazole, oxpoconazole, prochloraz and triflumizole. The pyrimidines include fenarimol, nuarimol and triarimol. The piperazines include triforine. The pyridines include buthiobate and pyrifenox. Biochemical investigations have shown that all of the above mentioned fungicides are DMI fungicides as described by K. H. Kuck et al. in Modern Selective Fungicides—Properties, Applications and Mechanisms of Action, H. Lyr (Ed.), Gustav Fischer Verlag: New York, 1995, 205-258.

bc₁ Complex Fungicides (group 28) have a fungicidal mode of action which inhibits the bc₁ complex in the mitochondrial respiration chain. The bc₁ complex is sometimes referred to by other names in the biochemical literature, including complex III of the electron transfer chain, and ubihydroquinone:cytochrome c oxidoreductase. This complex is uniquely identified by Enzyme Commission number EC1.10.2.2. The bc₁ complex is described in, for example, J. Biol. Chem. 1989, 264, 14543-48; Methods Enzymol. 1986, 126, 253-71; and references cited therein. Strobilurin fungicides such as azoxystrobin, dimoxystrobin, enestroburin (SYP-Z071), fluoxastrobin, kresoxim-methyl, metominostrobin, orysastrobin, picoxystrobin, pyraclostrobin, pyrametostrobin, pyraoxystrobin and trifloxystrobin are known to have this mode of action (H. Sauter et al., Angew. Chem. Int. Ed. 1999, 38, 1328-1349). Other fungicidal compounds that inhibit the bc₁ complex in the mitochondrial respiration chain include famoxadone and fenamidone.

Alkylenebis(dithiocarbamate)s (group (1)) include compounds such as mancozeb, maneb, propineb and zineb. Phenylamides (group (3)) include compounds such as metalaxyl, benalaxyl, furalaxyl and oxadixyl. Carboxamides (group (6)) include compounds such as boscalid, carboxin, fenfuram, flutolanil, furametpyr, mepronil, oxycarboxin, thifluzamide, penthiopyrad and N-[2-(1,3-dimethylbutyl)phenyl]-5-fluoro-1,3-dimethyl-1H-pyrazole-4-carboxamide (PCT Patent Publication WO 2003/010149), and are known to inhibit mitochondrial function by disrupting complex II (succinate dehydrogenase) in the respiratory electron transport chain. Copper compounds (group (11)) include compounds such as copper oxychloride, copper sulfate and copper hydroxide, including compositions such as Bordeaux mixture (tribasic copper sulfate). Phthalimides (group (12)) include compounds such as folpet and captan. Benzimidazole fungicides (group (14)) include benomyl and carbendazim. Dichlorophenyl dicarboximide fungicides (group (20)) include chlozolinate, dichlozoline, iprodione, isovaledione, myclozolin, procymidone and vinclozolin.

Non-DMI sterol biosynthesis inhibitors (group (26)) include morpholine and piperidine fungicides. The morpholines and piperidines are sterol biosynthesis inhibitors that have been shown to inhibit steps in the sterol biosynthesis pathway at a point later than the inhibitions achieved by the DMI sterol biosynthesis (group (27)). The morpholines include aldimorph, dodemorph, fenpropimorph, tridemorph and trimorphamide. The piperidines include fenpropidin.

Of further note are combinations of compounds of Formula 1 with azoxystrobin, kresoxim-methyl, trifloxystrobin, pyraclostrobin, picoxystrobin, dimoxystrobin, metominostrobin/fenominostrobin, carbendazim, chlorothalonil, quinoxyfen, metrafenone, cyflufenamid, fenpropidine, fenpropimorph, bromuconazole, cyproconazole, difenoconazole, epoxiconazole, fenbuconazole, flusilazole, hexaconazole, ipconazole, metconazole, penconazole, propiconazole, proquinazid, prothioconazole, tebuconazole, triticonazole, famoxadone, prochloraz, penthiopyrad and boscalid (nicobifen).

The following Tests demonstrate the control efficacy of compounds of this invention on specific pathogens. The pathogen control protection afforded by the compounds is not limited, however, to these species. See Index Table A for compound descriptions.

INDEX TABLE A

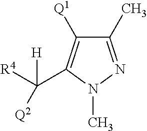

| Cmpd. | R⁴ | Q¹ | Q² | AP+ (M + 1) |
|---|---|---|---|---|
| 1 | NHCHO | 2-Cl, 4-F phenyl | 2,4-di-F phenyl | 394 |
| 2 | NHCH₃ | 2,6-di-F phenyl | 2,4-di-F phenyl | 364 |
| 3 | NH₂ | 2,6-di-F phenyl | 2,4-di-F phenyl | 350 |
| 4 | SCH₃ | 2,6-di-F phenyl | 2,4-di-F phenyl | 381 |

### Biological Examples of the Invention

General protocol for preparing test suspensions for Tests A-D: the test compounds were first dissolved in acetone in an amount equal to 3% of the final volume and then suspended at the desired concentration (in ppm) in acetone and purified water (50/50 mix by volume) containing 250 ppm of the surfactant Trem® 014 (polyhydric alcohol esters). The resulting test suspensions were then used in Tests A-G. Each test was conducted in triplicate, and the results were averaged. Spraying a 200 ppm test suspension to the point of run-off on the test plants was the equivalent of a rate of 800 g/ha. Unless otherwise indicated, the rating values indicate a 200 ppm test suspension was used. (An asterisk “*” next to the rating value indicates a 40 ppm test suspension was used.)

### Test A

The test suspension was sprayed to the point of run-off on tomato seedlings. The following day the seedlings were inoculated with a spore suspension of Botrytis cinerea (the causal agent of tomato Botrytis) and incubated in saturated atmosphere at 20° C. for 48 h, and then moved to a growth chamber at 24° C. for 3 additional days, after which time visual disease ratings were made.

### Test B

The test suspension was sprayed to the point of run-off on tomato seedlings. The following day the seedlings were inoculated with a spore suspension of Alternaria solani (the causal agent of tomato early blight) and incubated in a saturated atmosphere at 27° C. for 48 h, and then moved to a growth chamber at 20° C. for 5 days, after which time visual disease ratings were made.

### Test C

The test suspension was sprayed to the point of run-off on wheat seedlings. The following day the seedlings were inoculated with a spore suspension of Septoria nodorum (the causal agent of Septoria glume blotch) and incubated in a saturated atmosphere at 24° C. for 48 h, and then moved to a growth chamber at 20° C. for 9 days, after which time visual disease ratings were made.

### Test D

The test suspension was sprayed to the point of run-off on wheat seedlings. The following day the seedlings were inoculated with a spore suspension of Septoria tritici (the causal agent of wheat leaf blotch) and incubated in saturated atmosphere at 24° C. for 48 h. and then the seedlings were moved to a growth chamber at 20° C. for 19 additional days, after which time visual disease ratings were made.

### Test E

Wheat seedlings were inoculated with a spore suspension of Puccinia recondita f. sp. tritici (the causal agent of wheat leaf rust) and incubated in a saturated atmosphere at 20° C. for 24 h, and then moved to a growth chamber at 20° C. for 2 days. After 2 days, the test suspension was sprayed to the point of run-off on the wheat seedlings, and then the seedlings were moved back to the growth chamber at 20° C. for 4 days. Upon removal, visual disease ratings were made.

### Test F

The test suspension was sprayed to the point of run-off on wheat seedlings. The following day the seedlings were inoculated with a spore suspension of Puccinia recondita f. sp. tritici (the causal agent of wheat leaf rust) and incubated in a saturated atmosphere at 20° C. for 24 h, and then moved to a growth chamber at 20° C. for 6 days, after which time visual disease ratings were made.

### Test G

The test suspension was sprayed to the point of run-off on wheat seedlings. The following day the seedlings were inoculated with a spore dust of Blumeria graminis f. sp. tritici (also known as Erysiphe graminis f. sp. tritici, the causal agent of wheat powdery mildew) and incubated in a growth chamber at 20° C. for 8 days, after which time visual disease ratings were made.

Results for Tests A-G are given in Table A. In the Table, a rating of 100 indicates 100% disease control and a rating of 0 indicates no disease control (relative to the controls). A hyphen (-) indicates no test results.

TABLE A

| Cmpd | | | | | | | Test |
|---|---|---|---|---|---|---|---|
| No. | Test A | Test B | Test C | Test D | Test E | Test F | G |
| 1 | 30 | 0 | 0 | 0 | 0 | 18 | 0 |
| 2 | — | 0 | 0 | 99 | 0 | 0 | 82 |
| 3 | 98 | — | — | 100 | — | 99 | 98 |
| 4 | 31 | 0 | 0 | 99 | 9 | 85 | 82 |

What is claimed is:

1. A compound selected from Formula 1, N-oxides and salts thereof, 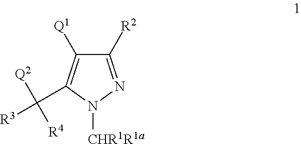
wherein
Q¹ is C₃-C₆ cycloalkyl or C₃-C₆ cycloalkenyl, wherein up to 3 carbon atoms are independently selected from C(═O), each optionally substituted with up to 2 substituents independently selected from halogen, cyano, nitro, hydroxy, C₁-C₃ alkyl, C₁-C₃ haloalkyl, C₁-C₃ alkoxy and C₁-C₃ haloalkoxy; or a phenyl ring or a naphthalenyl ring system, each ring or ring system optionally substituted with up to 5 substituents independently selected from R⁵; or a 4- to 7-membered heterocyclic ring or an 8- to 10-membered heteroaromatic bicyclic ring system, each ring or ring system containing ring members selected from carbon atoms and 1 to 4 heteroatoms independently selected from up to 2 O, up to 2 S and up to 4 N atoms, wherein up to 3 carbon ring members are independently selected from C(═O) and C(═S), and the sulfur atom ring members are independently selected from S(═O)ᵤ(═NR¹⁶)ᵥ, each ring or ring system optionally substituted with up to 5 substituents independently selected from R⁵ on carbon atom ring members and selected from cyano, C₁-C₃ alkyl, C₂-C₃ alkenyl, C₂-C₃ alkynyl, C₃ cycloalkyl, C₂-C₃ alkoxyalkyl, C₁-C₃ alkoxy, C₂-C₃ alkylcarbonyl, C₂-C₃ alkoxycarbonyl, C₂-C₃ alkylaminoalkyl and C₃ dialkylaminoalkyl on nitrogen atom ring members;
Q² is C₃-C₆ cycloalkyl or C₃-C₆ cycloalkenyl, wherein up to 3 carbon atoms are independently selected from C(═O), each optionally substituted with up to 2 substituents independently selected from halogen, cyano, nitro, hydroxy, C₁-C₃ alkyl, C₁-C₃ haloalkyl, C₁-C₃ alkoxy and C₁-C₃ haloalkoxy; or a phenyl ring or a naphthalenyl ring system, each ring or ring system optionally substituted with up to 5 substituents independently selected from R⁵; or a 4- to 7-membered heterocyclic ring or an 8- to 10-membered heteroaromatic bicyclic ring system, each ring or ring system containing ring members selected from carbon atoms and 1 to 4 heteroatoms independently selected from up to 2 O, up to 2 S and up to 4 N atoms, wherein up to 3 carbon ring members are independently selected from C(═O) and C(═S), and the sulfur atom ring members are independently selected from S(═O)ᵤ(═NR¹⁶)ᵥ, each ring or ring system optionally substituted with up to 5 substituents independently selected from R⁵ on carbon atom ring members and selected from cyano, C₁-C₃ alkyl, C₂-C₃ alkenyl, C₂-C₃ alkynyl, C₃ cycloalkyl, C₂-C₃ alkoxyalkyl, C₁-C₃ alkoxy, C₂-C₃ alkylcarbonyl, C₂-C₃ alkoxycarbonyl, C₂-C₃ alkylaminoalkyl and C₃ dialkylaminoalkyl on nitrogen atom ring members;
R¹ is H, cyano, halogen, C₁-C₃ alkyl, C₁-C₃ haloalkyl, C₂-C₃ alkenyl, C₂-C₃ alkynyl or cycloalkyl;
R^{1a} is H; or
R^{1a} and R¹ are taken together with the carbon atom to which they are attached to form a cyclopropyl ring optionally substituted with up to 2 substituents independently selected from halogen and methyl;
R² is H, cyano, halogen, C₁-C₃ alkyl, C₂-C₃ alkenyl, C₂-C₃ alkynyl, C₁-C₃ haloalkyl, C₂-C₃ haloalkenyl, C₁-C₃ cyanoalkyl, C₁-C₃ hydroxyalkyl, C₁-C₃ alkoxy or C₁-C₃ alkylthio; or cyclopropyl optionally substituted with up to 2 substituents independently selected from halogen and methyl;
R³ is H or C₁-C₆ alkyl;
R⁴ is —NR^{6a}R^{6b} or —S(═O)ₙR⁷;
each R⁵ is independently amino, cyano, halogen, hydroxy, nitro, C₁-C₆ alkyl, C₂-C₆ alkenyl, C₂-C₆ alkynyl, C₁-C₆ haloalkyl, C₂-C₆ haloalkenyl, C₂-C₆ haloalkynyl, C₃-C₆ cycloalkyl, C₃-C₆ halocycloalkyl, C₄-C₆ cycloalkylalkyl, C₄-C₆ alkylcycloalkyl, C₅-C₈ cycloalkylalkenyl, C₅-C₈ cycloalkylalkynyl, C₁-C₆ nitroalkyl, C₁-C₆ nitroalkenyl, C₁-C₆ alkylthio, C₁-C₆ haloalkylthio, C₁-C₆ alkylsulfinyl, C₁-C₆ haloalkylsulfinyl, C₁-C₆ alkylsulfonyl, C₁-C₆ haloalkylsulfonyl, C₁-C₆ alkoxy, C₁-C₆ haloalkoxy, C₂-C₆ alkenyloxy, C₂-C₆ haloalkenyloxy, C₃-C₆ alkynyloxy, C₃-C₆ haloalkynyloxy, C₂-C₆ alkylcarbonyloxy, C₃-C₆ cycloalkoxy, C₄-C₈ cycloalkylalkoxy, C₁-C₆ alkylsulfonyloxy, C₁-C₆ haloalkylsulfonyloxy, C₄-C₉ trialkylsilylalkoxy, C₂-C₆ alkylcarbonyl, C₁-C₆ alkylamino, C₁₋₂—C₁₋₆ dialkylamino, C₂-C₆ alkylcarbonylamino, C₃-C₉ trialkylsilyl, C₄-C₉ trialkylsilylalkyl, C(═S)NR^{8a}R^{8b}, —NH₂CH(═O), CR^{9a}═NOR^{9b}, CR^{9c}═NNR^{8a}R^{8b}, NR^{8a}N═CR^{10a}R^{10b}, —ON═CR^{10a}R^{10b}, —CH(═O), SF₅, SC≡N or —U—V-T;
R^{6a} and R^{6b} are each independently H, —CH(═O), C₁-C₄ alkyl, C₂-C₄ alkenyl, C₂-C₄ alkynyl, C₁-C₄ haloalkyl, C₂-C₄ haloalkenyl, C₂-C₄ haloalkynyl, C₂-C₄ alkoxyalkyl, C₂-C₄ alkylthioalkyl, C₂-C₄ alkylsulfinylalkyl, C₂-C₄ alkylsulfonylalkyl, C₂-C₄ alkylcarbonyl, C₂-C₄ haloalkylcarbonyl, C₂-C₅ alkoxycarbonyl, C₃-C₅ alkoxycarbonylalkyl, C₂-C₅ alkylaminocarbonyl, C₃-C₅ dialkylaminocarbonyl, C₁-C₄ alkylsulfonyl or C₁-C₄ haloalkylsulfonyl;
R⁷ is H, C₁-C₃ alkyl, C₁-C₃ haloalkyl, C₂-C₃ alkenyl or C₂-C₃ alkynyl;
each R^{8a} and R^{8b} is independently H or methyl;
each R^{9a} is independently H, C₁-C₃ alkyl or C₁-C₃ haloalkyl;
each R^{9b} and R^{9c} is independently H, C₁-C₃ alkyl, C₂-C₄ alkenyl, C₂-C₄ alkynyl, C₁-C₃ haloalkyl, C₂-C₄ haloalkenyl, C₃-C₄ cycloalkyl or C₃-C₄ halocycloalkyl;
each R^{10a} and R^{10b} is independently H, C₁-C₃ alkyl or C₁-C₃ haloalkyl;
each U is independently O, S(═O)ₙ, NR¹¹ or a direct bond;
each V is independently C₁-C₆ alkylene, C₂-C₆ alkenylene, C₃-C₆ alkynylene, C₃-C₆ cycloalkylene or C₃-C₆ cycloalkenylene, wherein up to 3 carbon atoms are C(═O), each optionally substituted with up to 5 substituents independently selected from halogen, cyano, nitro, hydroxy, C₁-C₆ alkyl, C₁-C₆ haloalkyl, C₁-C₆ alkoxy and C₁-C₆ haloalkoxy;
each T is independently cyano, NR^{12a}R^{12b}, OR¹³ or S(═O)ₙR¹⁴;
each R¹¹ is independently H, C₁-C₆ alkyl, C₁-C₆ haloalkyl, C₂-C₆ alkylcarbonyl, C₂-C₆ alkoxycarbonyl, C₂-C₆ (alkylthio)carbonyl, C₂-C₆ alkoxy(thiocarbonyl), C₄-C₈ cycloalkylcarbonyl, C₄-C₈ cycloalkoxycarbonyl, C₄-C₈ (cycloalkylthio)carbonyl or C₄-C₈ cycloalkoxy(thiocarbonyl);
each R^{12a} and R^{12b} is independently H, C₁-C₆ alkyl, C₁-C₆ haloalkyl, C₂-C₆ alkenyl, C₃-C₆ alkynyl, C₃-C₆ cycloalkyl, C₃-C₆ halocycloalkyl, C₂-C₆ alkylcarbonyl, C₂-C₆ alkoxycarbonyl, C₂-C₆ (alkylthio)carbonyl, C₂-C₆ alkoxy(thiocarbonyl), C₄-C₈ cycloalkylcarbonyl, C₄-C₈ cycloalkoxycarbonyl, C₄-C₈ (cycloalkylthio)carbonyl or C₄-C₈ cycloalkoxy(thiocarbonyl); or
a pair of R^{12a} and R^{12b} attached to the same nitrogen atom are taken together with the nitrogen atom to form a 3- to 6-membered heterocyclic ring, the ring optionally substituted with up to 5 substituents independently selected from R¹⁵;
each R¹³ and R¹⁴ is independently H, C₁-C₆ alkyl, C₁-C₆ haloalkyl, C₂-C₆ alkenyl, C₃-C₆ alkynyl, C₃-C₆ cycloalkyl, C₃-C₆ halocycloalkyl, C₂-C₆ alkylcarbonyl, C₂-C₆ alkoxycarbonyl, C₂-C₆ (alkylthio)carbonyl, C₄-C₈ cycloalkylcarbonyl, C₄-C₈ cycloalkoxycarbonyl, C₄-C₈ (cycloalkylthio)carbonyl, C₂-C₆ alkoxy(thiocarbonyl) or C₄-C₈ cycloalkoxy(thiocarbonyl);
each R¹⁵ is independently halogen, C₁-C₆ alkyl, C₁-C₆ haloalkyl or C₁-C₆ alkoxy;
each R¹⁶ is independently H, cyano, C₁-C₃ alkyl or C₁-C₃ haloalkyl;
each n is independently 0, 1 or 2; and
each u and v are independently 0, 1 or 2 in each instance of S(═O)ᵤ(═NR¹⁶)ᵥ;
provided that:
(a) the sum of u and v is 0, 1 or 2;
(b) when Q¹ and Q² are each an optionally substituted phenyl ring, then at least one of Q¹ or Q² is substituted with at least one R⁵ substituent; and
(c) at least one of Q¹ or Q² is an aromatic ring.

2. A compound of claim 1 wherein:
Q¹ is a phenyl ring optionally substituted with up to 3 substituents independently selected from R⁵;
Q² is a phenyl ring optionally substituted with up to 3 substituents independently selected from R⁵;
R¹ is H, halogen or methyl;
R^{1a} is H;
R² is Br, Cl, I or C₁-C₂ alkyl;
R³ is H or C₁-C₃ alkyl;
R⁴ is —NR^{6a}R^{6b};
each R⁵ is independently cyano, halogen, methyl, halomethyl, cyclopropyl, methylthio, methoxy, C₂-C₄ alkenyloxy, C₂-C₄ haloalkenyloxy, methylcarbonyloxy, methylsulfonyloxy, methylcarbonyl, C₄-C₈ cycloalkylalkoxy, C₃-C₄ alkylsulfonyloxy, C₃-C₄ haloalkylsulfonyloxy, C₄-C₉ trialkylsilylalkoxy, C(═S)NR^{8a}R^{8b}, CR^{9a}═NOR^{9b}, CR^{9c}═NNR^{8a}R^{8b}, NR^{8a}N═CR^{10a}R^{10b}, —ON═CR^{10a}R^{10b} or —U—V-T;
R^{6a} and R^{6b} are each independently H, methyl, halomethyl or C₂-C₄ alkoxyalkyl; and
R^{9b} and R^{9c} is independently H, C₁-C₃ alkyl, C₁-C₃ haloalkyl, C₃-C₄ cycloalkyl or C₃-C₄ halocycloalkyl.

3. A compound of claim 2 wherein:
Q¹ is a phenyl ring substituted with 1 to 3 substituents independently selected from R⁵;
Q² is a phenyl ring substituted with 1 to 3 substituents independently selected from R⁵;
R¹ is H;
R² is Br, Cl or methyl;
R³ is H or methyl;
each R⁵ is independently cyano, halogen, methyl, halomethyl, cyclopropyl, methylthio, methoxy, C₂-C₄ alkenyloxy, C₂-C₄ haloalkenyloxy, methylcarbonyloxy, methylsulfonyloxy, methylcarbonyl, C₄-C₈ cycloalkylalkoxy, C₃-C₄ alkylsulfonyloxy, C₃-C₄ haloalkylsulfonyloxy, C₄-C₉ trialkylsilylalkoxy, C(═S)NR^{8a}R^{8b}, CR^{9a}═NOR^{9b}, CR^{9c}═NNR^{8a}R^{8b}, NR^{8a}N═CR^{10a}R^{10b} or —ON═CR^{10a}R^{10b};
each R^{9a} is independently H, methyl or halomethyl; and
R^{9b} and R^{9c} is independently H, methyl, halomethyl or cyclopropyl.

4. A compound of claim 3 wherein:
R³ is H;
each R⁵ is independently Br, Cl, F, cyano or methoxy; and
R^{6a} and R^{6b} are each independently H or methyl.

5. A compound of claim 4 wherein:
at least one of Q¹ and Q² is substituted with at least one R⁵ substituent attached at an ortho position;
each R⁵ is independently Br, Cl or F; and
R^{6a} and R^{6b} are each H.

6. The compound of claim 1 which is selected from the group:
α-(2,4-difluorophenyl)-4-(2,6-difluorophenyl)-1,3-dimethyl-1H-pyrazol-5-methanamine;
α-(2,4-difluorophenyl)-4-(2,6-difluorophenyl)-N,1,3-trimethyl-1H-pyrazol-5-methanamine; and
4-(2,6-difluorophenyl)-5-[(2,4-difluorophenyl)(methylthio)methyl]-1,3-dimethyl-1H-pyrazole.

7. A fungicidal composition comprising (a) a compound of claim 1; and (b) at least one other fungicide.

8. A fungicidal composition comprising (a) a compound of claim 1; and (b) at least one additional component selected from the group consisting of surfactants, solid diluents and liquid diluents.

9. A method for controlling plant diseases caused by fungal plant pathogens comprising applying to the plant or portion thereof, or to the plant seed, a fungicidally effective amount of a compound of claim 1.
